(19) United States
(12) Patent Application Publication
(10) Pub. No.: US 2025/0080322 A1
(43) Pub. Date: Mar. 6, 2025

(54) KEY SHARING SYSTEM, METHOD, PROGRAM, SERVER DEVICE, AND TERMINAL DEVICE

(71) Applicant: Toru KAMBAYASHI, Kanagawa (JP)

(72) Inventor: Toru KAMBAYASHI, Kanagawa (JP)

(21) Appl. No.: 18/724,321

(22) PCT Filed: Dec. 28, 2022
(86) PCT No.: PCT/JP2022/048657

§ 371 Date: Jun. 26, 2024

(30) Foreign Application Priority Data
Dec. 28, 2021 (JP) 2021-214327
Apr. 15, 2022 (JP) 2022-067609

(51) Int. Cl. H04L 9/06; H04L 9/32

(52) U.S. Cl. CPC H04L 9/0618; H04L 9/3213

(57) ABSTRACT

To share encrypted data more securely. After a pair of an identification token 131 and key disclosure permission information 134 transmitted from a first client terminal 102 is verified by a verification unit 106, a key registration unit 107 registers a record 122 including the key 133 and the key disclosure permission information 134 in a database 121 of a key sharing server 101 and transmits key identification information 135 for identifying the record to the first client terminal 102. The first client terminal 102 transmits data 139 including encrypted data 138 obtained by encrypting transmission data by using a cipher key 136 for data encryption after first processing output by a cipher key first processing unit 109, a cipher key 137 for data decryption after first processing output by the cipher key first processing unit 109, and the key identification information 135 obtained from the key registration unit 107, to a second client terminal 103. The second client terminal 103 makes an inquiry to a key disclosure unit 110 by using the key identification information 135 acquired from the received data 139 and an identification token 132 of the terminal itself. The key disclosure unit 110 acquires the pair of key 133 and key disclosure permission information 134 corresponding to the key identification information 135, from the database 121, and notifies, when the identification token 132 is included in a key disclosure permissible range indicated by the key disclosure permission information 134, the second client terminal of the key 133. The second client terminal 103 uses the notified key 133 to generate a cipher key 140 for data decryption after second processing on the basis of the cipher key 137 for data decryption after first processing acquired from the data 139 and uses the cipher key 140 for data decryption after second processing to execute decryption on the encrypted data 138 in the data 139.

### TECHNICAL FIELD

The present invention relates to a key sharing technique and specifically relates to a key sharing system, method, and program, a server device, and a terminal device.

The technique disclosed herein relates, for example, to a mechanism for key sharing in which a transmitter and a receiver of an e-mail share encrypted data of an attached file and a mechanism for key sharing for sharing encrypted data on the basis of a relationship with another user.

### BACKGROUND ART

Pretty Good Privacy (PGP) is one of mechanisms for transmitting/receiving encrypted contents. In PGP cryptography, a receiver generates its own key pair (pair of a private key and a public key) and deposits the public key to a server on the Internet to make the public key pubic. A transmitter establishes a connection to the server of the receiver and searches for the public key of the receiver to obtain the public key.

The transmitter generates a symmetric key (also referred to as a common key or a private key) and encrypts a transmission text with the symmetric key. The transmitter then uses the public key of the receiver obtained previously, to encrypt the symmetric key. The transmitter transmits the encrypted transmission text and the symmetric key encrypted with the public key to the receiver.

The receiver uses the private key of the key pair to decrypt the symmetric key encrypted with the public key. From the nature of the key pair, only the receiver having the private key can execute the decryption successfully. The receiver uses the symmetric key acquired through the decryption to decrypt the transmission text received from the transmitter.

As described above, in PGP cryptography, a server on the Internet distributes a public key. The server receives an e-mail address of a receiver and the public key from the receiver and make the e-mail address of the receiver and the public key public on the Internet. The server then provides, in response to a request from a transmitter, the e-mail address of the receiver and the public key to the transmitter.

An example of related techniques is Facebook (registered trademark). This is one of typical social networking services (SNSs) and provides a mechanism for sharing information (including data) on the basis of a relationship between users. Examples of the relationship between users include “family”, “good friend”, “friend”, and “others”.

Besides the above, other examples of the related techniques related to the mechanism for sharing information (including data) are Patent Literatures 1, 2, and 3.

Patent Literature 1 discloses a technique that enables entity verification and asset authentication at transmission/reception of digital data (for example, refer to paragraph [0005]). Patent Literature 1 also discloses an e-mail address and a proof (for example, refer to paragraphs [0051], [0170], [0044], and [0054]).

A detailed description is now given of this Patent Literature 1, and Patent Literature 1 includes the following description in paragraph [0044], for example.

“Provide an asset registry service for registering digital or physical asset data and relate to a method for creating a related digital seal or stamp by a verifiable/provable entity that can be verified by any concerned or permitted party in order to confirm that the asset data is not manipulated for certain and an asset is issued by the entity for certain.”

Here, the asset (possessions) includes an e-mail address (refer to paragraph [0051]).

Moreover, for example, paragraph [0170] includes the following description.

“Another example is that RegSeal is used to certify an e-mail address and a corresponding private key is used to attach a signature to an e-mail. This confirms that the e-mail has actually been transmitted by the owner of the RegSeal. Consequently, phishing e-mails and spam e-mails can be filtered out highly reliably.”

Here, the RegSeal denotes a certified seal (stamp/sealing) (refer to [0050]).

Patent Literature 2 discloses a system for security-protected content sharing. Patent Literature 2 also discloses an e-mail address and a data token (for example, refer to paragraphs [0001], [0012], and [0025]).

Further, Patent Literature 3 discloses a technique for transmitting and receiving a message (e-mail) for completely preventing exposure of a private key from information held by a server and also discloses PGP (for example, refer to Abstract and paragraphs [0001] to [0003] and [0006]).

In addition, Patent Literature 4 discloses an e-mail server that sets a password of an encrypted attachment file to be public/non-public in response to a request from a corresponding transmission source.

### CITATION LIST

### Patent Literature

Patent Literature 1: JP 2021-524216 T
Patent Literature 2: JP 2018-534818 T
Patent Literature 3: JP 2011-097453 A
Patent Literature 4: JP 2020-198616 A

### SUMMARY OF INVENTION

### Technical Problem

Meanwhile, an information sharing means such as Facebook is widely used as a medium for disclosing information according to mutual relationship such as family, friend, or acquaintance, and reporting statuses. However, for example, Facebook collects public and private records of a significantly large number of people to be used for opinion exchange, and this has led to extremely harmful effects as those below:

1. The situation is that one company manages personal information of billions of people, which leads to a great concern about the use of the personal information and maintenance of security.
(A) Whether personal information is not used without permission, whether personal information is not used without authorization, whether personal information is not used with disadvantage of the person corresponding to the personal information, or the like.
2. Huge cost is needed for construction, maintenance, and management of storages and services.
(A) The cost is basically covered by advertisement, which leads to an increase in advertising expenses and extreme display of advertisement. The advertising expenses are passed onto the prices of products and services. Hence, irrespective of whether each consumer uses Facebook, consumers share the cost.
(B) Extreme advertisement generally gives unpleasant feeling and damages user experience.
3. Information made public on Facebook may be inspected in the judgment of the one company, which may harm freedom of speech and expression.
(A) Speech and expression may be deleted, prohibited from being made public, or prohibited from being posted in the judgment of the one private company.

A person who desires to receive encrypted data by using PGP needs to notify a transmitter of encrypted data of a public key of the person in advance. For this reason, the person needs to transmit the public key of the person in advance to people, such as friends and business acquaintances, who have possibilities of transmitting encrypted data to the person. When the person updates a key pair of the person for a security reason, the person needs to transmit an updated public key to each transmitter of encrypted data. In contrast, the transmitter needs to hold a number of different public keys for respective receivers and manage the public keys up to date.

The transmitter needs to encrypt transmission data or a private key (symmetric key) for encrypting the transmission data, with the different public key for each receiver. Since the encrypted transmission data or the encrypted private key (symmetric key) is different for each receiver, the transmitter needs to transmit a number of e-mails individually even when the transmitter transmits the same data to a number of receivers or needs to broadcast an e-mail with a number of cipher keys being attached. For transmission/reception of encrypted data using PGP, load to be imposed on both a transmitter and a receiver is large.

As described above, while encryption using a public key encryption (asymmetric key encryption) technique such as PGP is highly secure, this requires significant time and effort of a transmitter/receiver. To avoid such time and effort, a password encrypted zip file is used as a method for simple file encryption. However, this method is likely to cause a problem in security. This is because people concerned are to share the same password. In addition, this password is likely not to be changed for a long time. This is because it is difficult to inform all the people concerned of the change. To avoid such a situation, a password is generated randomly for each file to transmit the password to a transmission destination, but apparently, this method also has a problem in security. Specifically, the password needs to be transmitted in a separate e-mail, and if an attacker acquires a log in a transmission path of the e-mail, the attacker can easily read the password surreptitiously.

An object of the present invention is to, by using an identification token, key disclosure permission information, key identification information, and a plurality of kinds of keys in combination, provide a key sharing processing technique for more securely sharing encrypted data obtained by encrypting encryption target data.

### Solution to Problem

To solve the above problem, a first aspect of the present invention is a key sharing system 100 including one or more key sharing servers 101, one or more first client terminals 102 each having key registration and data output functions, and one or more second client terminals 103 each having a function of reading data 139 output by the first client terminals 102, the one or more key sharing servers 101, the one or more first client terminals 102, and the one or more second client terminals 103 being mutually connected via the Internet, a local area network, a virtual private network (VNP), or the like, for example.

FIG. 1A is a block diagram illustrating a functional configuration of the key sharing system 100 according to the first aspect of the present invention, and FIG. 1B is a sequence diagram illustrating an operation sequence of the functional configuration. The first aspect of the present invention will be described below with reference to FIG. 1A and FIG. 1B.

An identification token issue unit 104 in FIG. 1A issues identification tokens 131 and 132 each indicating “authenticated” respectively for the first client terminal 102 and the second client terminal 103 (steps S1 and S2 in FIG. 1B).

A verification unit 106 in FIG. 1A verifies the identification token 131 transmitted from the first client terminal 102 as will be described below (step S3→step S4 in FIG. 1B).

Only when it is confirmed in the verification unit 106 that the identification token 131 is correct (is the identification token 131 issued for the first client terminal 102 already authenticated) (step S5 in FIG. 1B), a key registration unit 107 in FIG. 1A causes a cipher key generation unit 108 and a cipher key first processing unit 109 to operate (step S8→step S9 in FIG. 1B).

As a result of this, the cipher key generation unit 108 generates a pair of a cipher key for data encryption and a cipher key for data decryption (step S8 in FIG. 1B).

The cipher key first processing unit 109 performs or does not perform certain processing on each of the cipher key for data encryption and the cipher key for data decryption generated by the cipher key generation unit 108 to thereby generate a cipher key 136 for data encryption after first processing and a cipher key 137 for data decryption after first processing, respectively (step S9 in FIG. 1B).

Specifically, the cipher key first processing unit 109 may generate the cipher key 136 for data encryption after first processing and the cipher key 137 for data decryption after first processing by respectively using the cipher key for data encryption and the cipher key for data decryption generated by the cipher key generation unit 108 without change, for example. In this case, in a data encryption unit 114 in the first client terminal 102 in FIG. 1A, for the cipher key 136 for data encryption after first processing used in encryption of encryption target data, the cipher key for data encryption as is generated by the cipher key generation unit 108 is used without being protected by a password. Similarly, for the cipher key 137 for data decryption after first processing handed over to the second client terminal 103 side via a record 122 in a database 121, the cipher key for data decryption as is generated by the cipher key generation unit 108 is used without being protected by a password.

More concretely, the cipher key first processing unit 109 may perform first processing on at least one of the cipher key for data decryption and the cipher key for data encryption generated by the cipher key generation unit 108, on the basis of a password 133 received from a password provision unit 105 provided in the first client terminal 102 (step S10 in FIG. 1B). Consequently, the cipher key first processing unit 109 generates the cipher key 137 for data decryption after first processing and the cipher key 136 for data encryption after first processing by respectively using the cipher key for data decryption and the cipher key for data encryption subjected to or not subjected to the first processing.

Details of this first processing will be described below by using FIG. 1C.

Return to the description of the cipher key registration unit 107 in FIG. 1A. After causing the cipher key generation unit 108 and the cipher key first processing unit 109 to operate, the cipher key registration unit 107 stores key disclosure permission information 134 below (step S7 in FIG. 1B) and the cipher key 137 for data decryption after first processing (step S11 in FIG. 1B) in one record 122 in the database 121 included in the key sharing server 101 (step S12 in FIG. 1B). Here, the key disclosure permission information 134 is information for designating a disclosure permissible range for a key (cipher key 137 for data decryption after first processing) transmitted from a first information transmission and/or reception unit 111 of the first client terminal 102, the information being input for designation by a user of the first client terminal 102. The cipher key 137 for data decryption after first processing is generated by the cipher key first processing unit 109.

The cipher key registration unit 107 transmits key identification information 135 for identifying the record 122 subjected to registration and returned from the database 121 (step S13 in FIG. 1B) and the cipher key 137 for data encryption after first processing generated by the cipher key first processing unit 109, respectively to the first information transmission and/or reception unit 111 and a data encryption unit 114 to be described below of the first client terminal 102 (step S14 and step S15→step S16 in FIG. 1B).

A key disclosure unit 110 in FIG. 1A acquires the key identification information 135 and the identification token 132 included in key inquiry information from the second client terminal 103 (step S19→step S20 and step S21→step S22 in FIG. 1B) and acquires the cipher key 137 for data decryption after first processing and the key disclosure permission information 134 from the record 122 in the database 121 included in the key sharing server 101 corresponding to the acquired key identification information 135 (step S23→step S24 in FIG. 1B). The key disclosure unit 110 then acquires information of a user corresponding to the acquired identification token 132. Only when it is confirmed that the user corresponding to the acquired user information is included in the disclosure permissible range indicated by the acquired key disclosure permission information 134, the key disclosure unit 110 transmits the acquired cipher key 137 for data decryption after first processing to a second information transmission and/or reception unit 118 of the second client terminal 103 (step S25 in FIG. 1B).

In FIG. 1A, the identification token issue unit 104, the verification unit 106, the key registration unit 107, the cipher key generation unit 108, the cipher key first processing unit 109, and the key disclosure unit 110 are illustrated as being included in the key sharing server 101. However, these functional units do not necessarily be included in the key sharing server 101 including the database 121 and may be implemented as being included in an external dedicated server. The cipher key generation unit 108 and the cipher key processing unit 109 may be included in the first client terminal 102.

The first client terminal 102 in FIG. 1A includes the following functional configuration and operation sequence.

A first identification token storage unit 111 stores the identification token 131 issued by the identification token issue unit 104 (step S1 in FIG. 1B).

A key disclosure permission information input unit 112 in FIG. 1A inputs the key disclosure permission information 134 indicating the disclosure permissible range of the key (cipher key 137 for data decryption after first processing) through an operation by the user of the first client terminal 102 (step S7 in FIG. 1B).

The password provision unit 105 provides a password to the cipher key first processing unit 109 by means of automatic generation or user input. Note that, when the cipher key first processing unit 109 does not perform the certain processing on the cipher key for data encryption or the cipher key for data decryption and outputs the cipher key 136 for data encryption after first processing or the cipher key 137 for data decryption after first processing by using the cipher key for data encryption or the cipher key for data decryption without change, the password provision unit 105 does not need to be provided.

The first information transmission and/or reception unit 113 in FIG. 1A transmits the identification token 131 stored by the first identification token storage unit 111 and the key disclosure permission information 134 input to the key disclosure permission information input unit 112 respectively, for example, to the verification unit 106 and the key registration unit 107 provided in the key sharing server 101 (step S3→step S4 and S6→step S7 in FIG. 1B) and receives, in response to the transmission, the key identification information 135 replied from the key registration unit 107 (step S14 in FIG. 1B).

Upon input of encryption target data, the data encryption unit 114 in FIG. 1A uses the cipher key 136 for data encryption after first processing output by the cipher key first processing unit 109 according to an indication from the key registration unit 107 (step S15→step S16 in FIG. 1B) to encrypt the encryption target data and output the encrypted data 138 obtained as a result of the encryption to a data creation unit 115 (step S18 in FIG. 1B).

The data creation unit 115 in FIG. 1A outputs the data 139 including the key identification information 135 received by the first information transmission and/or reception unit 113 (step S17 in FIG. 1B) and the encrypted data 138 output by the data encryption unit 114 (step S18 in FIG. 1B) and transmits the data 139 to the second client terminal 103 (step S19 in FIG. 1B).

The second client terminal 103 in FIG. 1A includes the following functional configuration and operation sequence.

A second identification token storage unit 116 in FIG. 1A stores the identification token 132 issued by the identification token issue unit 104 (step S2 in FIG. 1B).

An encrypted data acquisition unit 117 in FIG. 1A acquires the key identification information 135 and the encrypted data 138 from the read data 139 (step S19 in FIG. 1B).

The second information transmission and/or reception unit 118 in FIG. 1A transmits the key identification information 135 acquired by the encrypted data acquisition unit 117 and the identification token 132 stored by the second identification token storage unit 116 as key inquiry information to the key disclosure unit 110 (steps S20 and S21 in FIG. 1B) and receives, in response to the transmission, the cipher key 137 for data decryption after first processing replied from the key disclosure unit 110 (step S25 in FIG. 1B).

A password input unit 141 asks a user of the second client terminal 103 to input a password. Note that, when a cipher key second processing unit 119 does not perform the certain processing on the cipher key 137 for data decryption after first processing and outputs a cipher key 140 for data decryption after second processing by using the cipher key 137 for data decryption without change, the password input unit 141 does not need to be provided.

The cipher key second processing unit 119 in FIG. 1A performs or does not perform second processing on the cipher key 137 for data decryption after first processing received by the second information transmission and/or reception unit 118, based on the password input by the password input unit 141, to thereby generate the cipher key 140 for data decryption after second processing (steps S26 and S27 in FIG. 1B).

A data decryption unit 120 in FIG. 1A uses the cipher key 140 for data decryption after second processing generated by the cipher key second processing unit 119, to execute decryption processing on the encrypted data 138 acquired by the encrypted data acquisition unit 117 (steps S28 and S29 in FIG. 1B).

Here, the cipher key first processing unit 109 can execute, as the certain processing, at least one type of processing of wrapping (encryption) of a cipher key for data decryption and transformation of a cipher key for data encryption. Note that both types of processing may be executed. Alternatively, neither of these types of processing may be executed.

FIG. 1C is an explanatory diagram illustrating the certain processing (wrapping or transformation) executed by the cipher key first processing unit 109.

First, a description will be given of an operation of a case where the certain processing in the cipher key first processing unit 109 is wrapping (encryption) of a cipher key for data decryption, with reference to FIG. 1A, FIG. 1B, and FIG. 1C(a).

When the certain processing is wrapping (encryption), the cipher key first processing unit 109 generates a password key (KP in FIG. 1C(a)) on the basis of the password 133 provided by the password provision unit 105 and executes wrapping by using the password key to encrypt the cipher key for data decryption (KD in FIG. 1C) generated by the cipher key generation unit 108. Consequently, the cipher key first processing unit 109 generates the cipher key 137 for data decryption after first processing ([KD_KP] in FIG. 1C(a)) and outputs the cipher key 137 for data decryption after first processing to the cipher key registration unit 107 (FIG. 1A) (1 in FIG. 1C(a) and step S11 in FIG. 1B).

The cipher key registration unit 107 registers the cipher key 137 for data decryption after first processing ([KD]_KP in FIG. 1C(a)) received from the cipher key first processing unit 109 together with the key disclosure permission information 134 designated by the first client terminal 102, in one record 122 in the database 121. In this way, the cipher key 137 for data decryption after first processing ([KD]_KP in FIG. 1C(a)) in a state of being wrapped (encrypted) can be accessed by the second client terminal via the record 122 in the database 121 (2 in FIG. 1C(a) and step S12 in FIG. 1B).

Meanwhile, the cipher key first processing unit 109 outputs the cipher key 136 for data encryption after first processing by using the cipher key for data encryption (KE in FIG. 1C(a)) generated by the cipher key generation unit 108 without change, to the data encryption unit 114 in the first client terminal 102 (step S16 in FIG. 1B).

The data encryption unit 114 in the first client terminal 102 uses the cipher key 136 for data encryption after first processing (KE in FIG. 1C(a)) received from the cipher key first processing unit 109, to encrypt encryption target data (3 in FIG. 1C(a)). The encrypted data 138 obtained as a result of the encryption is transmitted from the first client terminal 102 to the second client terminal 103 as a part of the data 139 (4 in FIG. 1C(a) and step S16→step S18→step S19 in FIG. 1B).

The encrypted data 138 ([D]_KE in FIG. 1C(a)) obtained by the data encryption unit 114 is transmitted to the data creation unit 115 and then transferred to the second client terminal 103 as a part of the data 139 (step S16→step S18→step S19 in FIG. 1B) (4 in FIG. 1C(a)).

In the second client terminal 103, for the data decryption unit 120 to decrypt the encrypted data 138 acquired from the transmitted data 139 by the encrypted data acquisition unit 117, the second information transmission and/or reception unit 118 requests the cipher key 137 for data decryption after first processing corresponding to the encrypted data 138, of the key disclosure unit 110 in the key sharing server 101.

Concretely, the second information transmission and/or reception unit 118 transmits a key disclosure request including the key identification information 135 acquired from the data 139 transmitted from the encrypted data acquisition unit 117 and the identification token 132 stored in the second identification token storage unit 116 (step S20 and step S21→step S22 in FIG. 1B).

The key disclosure unit 110 accesses the corresponding record 122 in the database 121 on the basis of the key identification information 135 included in the key disclosure request (step S23 in FIG. 1B).

Consequently, the key disclosure unit 110 acquires the cipher key 137 for data decryption after first processing stored in the record 122 from the database 121 (step S24 in FIG. 1B) and replies with the cipher key 137 for data decryption after first processing to the second information transmission and/or reception unit 118 of the second client terminal 103 (step S25 in FIG. 1B).

The second information transmission and/or reception unit 118 hands over the cipher key 137 for data decryption after first processing received from the key sharing server 101, to the cipher key second processing unit 119 (step S26 in FIG. 1B).

The cipher key 137 for data decryption after first processing acquired by the cipher key second processing unit 119 is in a state of being wrapped ([KD]_KP in FIG. 1C(a)). The cipher key second processing unit 119 hence executes, as the second processing, unwrapping (decryption) based on the password 133, for this cipher key 137 for data decryption after first processing.

Concretely, the cipher key second processing unit 119 generates a password key (KP in FIG. 1C(a)) on the basis of the password 133 input by the password input unit 141 by the user of the second client terminal 103 (step S27 in FIG. 1B).

The cipher key second processing unit 119 then executes unwrapping for the cipher key 137 for data decryption after first processing ([KD]_KP in 2 in FIG. 1C(a)) received via the second information transmission and/or reception unit 118 (step S26 in FIG. 1B), on the basis of the above password key. This unwrapping is inverse processing of the wrapping of the cipher key 137 for data decryption after first processing at the cipher key first processing unit 109. Through this processing, the cipher key second processing unit 119 performs decryption to obtain the original cipher key for data decryption generated by the cipher key generation unit 108, as the cipher key 140 for data decryption after second processing (KD in 5 in FIG. 1C(a)). The cipher key second processing unit 119 outputs this cipher key 140 for data decryption after second processing to the data decryption unit 120 (step S28 in FIG. 1B).

The data decryption unit 120 uses the cipher key 140 for data decryption after second processing, which is the original cipher key for data decryption (KD in FIG. 1C(a)), to decrypt the encrypted data 130 ([D]_KE in FIG. 1C(b)) received via the encrypted data acquisition unit 117 from the first client terminal 102 (step S29 in FIG. 1B) and thereby obtaining the original encryption target data (D in 6 in FIG. 1C(a)).

By employing wrapping as that described above, even if the cipher key 137 for data decryption after first processing happens to be leaked from the database 121, the cipher key 137 for data decryption after first processing cannot be unwrapped without the password 133, and this prevents the encrypted data 138 from being decrypted, which hence ensures high security.

Next, a description will be given of an operation of a case where the certain processing in the cipher key first processing unit 109 is transformation, with reference to FIG. 1A, FIG. 1B, and FIG. 1C(b).

When the certain processing is transformation, the cipher key first processing unit 109 executes transformation for transforming the cipher key for data encryption (KE in FIG. 1C(b)) generated by the cipher key generation unit 108, on the basis of the password 133 (P in FIG. 1C(b)) provided by the password provision unit 105, to thereby generate the cipher key 136 for data encryption after first processing and output the cipher key 136 for data encryption after first processing to the first client terminal 102 (KE˜P in 7 in FIG. 1C(b)).

The cipher key 136 for data encryption after first processing subjected to the transformation is transmitted to the data encryption unit 114 of the first client terminal 102 and used for encryption of encryption target data (D in FIG. 1C) (step S16 in FIG. 1B and KE˜P in 9 in FIG. 1C(b)).

The encrypted data 138 obtained by the data encryption unit 114 is transmitted to the data creation unit 115 and then transferred to the second client terminal 103 as a part of the data 139 (step S16→step S18→step S19 in FIG. 1B) ([D]_KE˜P in 10 in FIG. 1C(b)).

Meanwhile, the cipher key first processing unit 109 outputs the cipher key 137 for data decryption after first processing by using the cipher key for data decryption (KD in FIG. 1C(b)) generated by the cipher key generation unit 108 without change, to the cipher key registration unit 107.

The cipher key registration unit 107 registers the cipher key 137 for data decryption after first processing as is received from the cipher key first processing unit 109 without change, together with the key disclosure permission information 134 designated by the first client terminal 102, in one record 122 in the database 121. In this way, the cipher key 137 for data decryption after first processing without change (without being encrypted) can be accessed by the second client terminal via the record 122 in the database 121 (KD in 8 in FIG. 1C(b) and step S12 in FIG. 1B).

In the second client terminal 103, as in the case of wrapping, the second information transmission and/or reception unit 118 requests the cipher key 137 for data decryption after first processing, of the key disclosure unit 110, and hands over the cipher key 137 for data decryption after first processing received from the key disclosure unit 110 to the cipher key second processing unit 119 (step S26 in FIG. 1B).

The cipher key 137 for data decryption after first processing thus acquired is in an original state, i.e., being not wrapped (KD in FIG. 1C(b)). Meanwhile, the encrypted data 138 acquired from the data 139 by the encrypted data acquisition unit 117 of the second client terminal 103 is an encrypted state with the transformed cipher key 136 for data encryption after first processing ([D]_KE˜P in FIG. 1C(b)). The cipher key second processing unit 119 hence executes, as the second processing, transformation based on the password 133 input by the user via the password input unit 141, for this cipher key 137 for data decryption after first processing.

Concretely, the cipher key second processing unit 119 acquires the above-described password 133 received by the second information transmission and/or reception unit 118 from the key disclosure unit 110 (step S26 in FIG. 1B and P in FIG. 1C(b)).

The cipher key second processing unit 119 then executes transformation on the basis of the password 133 for the cipher key 137 for data decryption after first processing (step S19→step S29 in FIG. 1B and KD in 8 in FIG. 1C(b)) received from the first client terminal 102 via the encrypted data acquisition unit 117, to thereby obtain the cipher key 140 for data decryption after second processing (KD˜P in 11 in FIG. 1C(b)). The cipher key second processing unit 119 outputs the cipher key 140 for data decryption after second processing subjected to the transformation, to the data decryption unit 120 (step S28 in FIG. 1B).

The data decryption unit 120 uses the cipher key 140 for data decryption after second processing (KD˜P in FIG. 1C(b)) obtained by transforming the original cipher key for data decryption (KD in FIG. 1C(b)), to decrypt the encrypted data 130 ([D]_KE˜P in FIG. 1C(b)) received via the encrypted data acquisition unit 117 from the first client terminal 102 (step S29 in FIG. 1B) and thereby obtain the original encryption target data (D in 12 in FIG. 1C(b)).

By employing transformation as that described above, even if the cipher key 137 for data decryption after first processing happens to be leaked from the database 121, the cipher key 137 for data decryption after first processing not subjected to transformation with the password 133 cannot be used to decrypt the encrypted data 138 encrypted with the transformed cipher key 136 for data encryption after first processing, which hence ensures high security as in the case of wrapping.

As described above, the certain processing of at least one of the cipher key for data decryption and the cipher key for data encryption based on the password 133 by the cipher key first processing unit 109 can increase security for the encrypted data 138 transferred from the first client terminal 102 to the second client terminal 103.

In the first aspect of the present invention described above, the verification unit 106 may be included in a server other than the key sharing server 101.

In the first aspect of the present invention described above, the key registration unit 107 may be included in a server other than the key sharing server 101 or in the first client terminal 102.

In the first aspect of the present invention described above, the key disclosure permission information 134 may include at least one of a relationship between users, designation of a user group, and a list of e-mail addresses.

In the first aspect of the present invention described above,
the key registration unit 107 may be configured to
   receive a key disclosure period together with the identification token 131 from the first client terminal 102, and
   store the key disclosure period in the record 122 in the database 121, and
the key disclosure unit 110 may be configured to
   acquire the key disclosure period together with the password 133, from the record 122 in the database 121, the record 122 corresponding to the key identification information 135 received from the second client terminal 103, and
   transmit, only when a current time is within the key disclosure period, the password 133 acquired, to the second client terminal 103.

In the first aspect of the present invention described above,
the first client terminal 102 may further include a key disclosure period input unit configured to receive an input of a key disclosure start time or a key disclosure end time as the key disclosure period, from a user of the first client terminal 102, and
the first information transmission and/or reception unit 113 may be configured to transmit the key disclosure period input to the key disclosure period input unit, to the key registration unit 107.

In the first aspect of the present invention described above,
the key registration unit 107 may be configured to transmit a key owner identifier or a uniform resource locator (URL) for key acquisition to the first client terminal 102.

In the first aspect of the present invention described above,
the key disclosure unit 110 may be configured to
receive a first key owner identifier together with the identification token 132 and the key identification information 135 from the second client terminal 103,
acquire a second key owner identifier together with the password 133, from the record 122 in the database 121, the record 122 corresponding to the key identification information 135 acquired, and
transmit, only when the first key owner identifier and the second key owner identifier match, the cipher key 137 for data decryption after first processing acquired, to the second client terminal 103.

In the first aspect of the present invention described above,
the data creation unit 115 may be configured to output the data 139 including at least one of an encryption parameter, a password key derivation parameter, a key transformation parameter, a key owner ID, a URL for key acquisition, a key disclosure period, and a data creation time and date.

In the first aspect of the present invention described above,
the encrypted data acquisition unit 117 may be configured to acquire, when the data read includes a key owner identifier, the key owner identifier from the data 139 read, and
the second information transmission and/or reception unit 118 may be configured to transmit the key owner identifier acquired by the encrypted data acquisition unit 117, as the first key owner identifier to the key disclosure unit 110.

In the first aspect of the present invention described above,
the encrypted data acquisition unit 117 may be configured to acquire, when the data 139 read includes the URL for key acquisition, the URL for key acquisition from the data 139 read, and
the second information transmission and/or reception unit 118 may be configured to access the URL for key acquisition acquired by the encrypted data acquisition unit 117, to communicate with the key disclosure unit 110.

In the first aspect of the present invention described above,
the encrypted data acquisition unit 117 may be configured to acquire, when the data read includes the key disclosure period and the data creation time and date, the key disclosure period or the data creation time and date from the data 139 read, and perform processing to display the key disclosure period or the data creation time and date to the user of the second client terminal 103.

In the first aspect of the present invention described above,
the identification token 131 and the key identification information 135 may be received from the first client terminal 102,
a user identifier corresponding to the identification token 131 received may be acquired,
a key owner identifier of the cipher key 137 for data decryption after first processing may be acquired from the record 122 in the database 121, the record 122 corresponding to the key identification information 135 received, and
only when the user identifier and the key owner identifier match, the record 122 in the database 121 corresponding to the key identification information 135 received or the cipher key 137 for data decryption after first processing in the record 122 may be deleted.

In the first aspect of the present invention described above,
the identification token 131, the key identification information 135, and the key disclosure period may be received from the first client terminal 102,
a user identifier corresponding to the identification token 131 received may be acquired,
a key owner identifier of the cipher key 137 for data decryption after first processing may be acquired from the record 122 in the database 121, the record 122 corresponding to the key identification information 135 received, and
only when the user identifier and the key owner identifier match, the key disclosure period received may be used to change the key disclosure period registered in the record 122 in the database 121 corresponding to the key identification information 135 received.

A second aspect of the present invention is a server device including the database 121 in the first aspect of the present invention described above and also including any of the identification token issue unit 104, the verification unit 106, the key registration unit 107, the cipher key generation unit 108, the cipher key first processing unit 109, and the key disclosure unit 110.

A third aspect of the present invention is a terminal device including functions of the first client terminal 102 in the first aspect of the present invention described above.

A fourth aspect of the present invention is a terminal device including functions of the second client terminal 103 in the first aspect of the present invention described above.

In the first to fourth aspects of the present invention described above, the first client terminal 102 and the second client terminal 103 may be hardware components of the same type, and the first client terminal 102 may be equipped with the functions of the second client terminal 103 or conversely the second client terminal 103 may be equipped with the function of the first client terminal 102. This similarly applies to examples below.

Note that the key registration unit 107 may receive the key identification information 135 and the key disclosure permission information 134 indicating the disclosure permissible range of the key corresponding to the key identification information 135 (cipher key 137 for data decryption after first processing) in two separate times from the first client terminal 102. For example, when the password 133 is generated in the first client terminal 102 as will be described below, the key registration unit 107 receives the password 133 in the first time and transmits the key identification information 135 to the first client terminal 102. Then, in the second time, the key registration unit 107 transmits to the first client terminal 102 the key identification information 135 received in the first transmission/reception in addition to the identification token 131 and the key disclosure permission information 134. The key registration unit 107 identifies the key 133 registered in the first time, by using the key identification information 135 and stores the key disclosure permission information 134 in association with the key 133.

To register a plurality of pieces of data in the database 121 of the key sharing server 101, it is common that the plurality of pieces of data are registered in a plurality of separate times via information indicating association (the key identification information 135 in this case) as described above. This corresponds, for example, to a case of, to register credit card information and a nickname of a user in a server, registering the nickname first and thereafter the credit card information.

When the password provision unit 105 provides the password 133, the password provision unit 105 may generate the password 133 on the basis of some kind of computer algorithm, but may generate the password 133 on the basis of a random number generated by hardware or may generate the password 133 on the basis of data acquired through observation of a natural phenomenon. When a user can be involved, the password 133 may be a password input by the user. Note that a method for the password provision unit 105 to provide the password 133 is not limited to these.

Similarly, the password 133 input to the password input unit may be the password 133 created by a user or may be the password 133 automatically generated by some kind of algorithm, but the password 133 may be generated on the basis of a random number generated by hardware or may be generated on the basis of data acquired through observation of a natural phenomenon. Note that a method of generating the password 133 to be input to the password input unit is not limited to theses.

The cipher key generation unit 108 generates the cipher key 136 for data encryption and the cipher key 137 for data decryption. When an encryption scheme is a symmetric-key scheme, the cipher keys are identical. In contrast, when an encryption scheme is an asymmetric-key scheme, the cipher keys are different from each other. In an asymmetric-key scheme, the cipher key generation unit 108 generates two keys, i.e., a public key and a private key.

The cipher key first processing unit 109 generates a password key on the basis of the password 133. Here, the password key is used to wrap (encrypt) another key. The password key generation unit uses a function called key-derivation function, for example, to generate the password key from the password 133. As an example of the key-derivation function, password-based key-derivation function 2 (PBKDF2) is well known. Note that the cipher key first processing unit 109 uses some parameters in addition to the password 133 in password key derivation in some cases. In a case of PBKDF2, the parameters may be a random number called salt, the number of repetition times of an internal algorithm, a hash function to be used, and the like. Here, such a parameter is referred to as a password key derivation parameter.

Here, a generation source of a key will be described. A symmetric-key cipher key is generated by using a random number in general. For example, a 32-byte (=256-bit) random number can be used directly as an AES key. Alternatively, by generating a sufficiently large (for example, 1 kilobyte) random number and applying a one-way function such as Secure Hash Algorithm 256 (SHA-256) to this random number to obtain a 32-byte bit string, the bit string may be used as an AES key. This similarly applies to a case of an asymmetric-key encryption (public key encryption) key. For example, in elliptic curve cryptography, a large random number is generated and used as a private key. Then, a public key corresponding to this private key is computed in a predetermined method. Data being a source for generation of a cipher key is referred to as a generation source of the cipher key.

In the key sharing system 100, the cipher key 136 for data encryption and the generation source of the cipher key 136 for data encryption are considered the same. Similarly, the cipher key 137 for data decryption and the generation source of the cipher key 137 for data decryption are considered the same. Each cipher key transmitted/received between the key sharing server 101 and the corresponding client terminal may be the cipher key itself or may be the generation source of the cipher key (cipher key generation source information). When the key sharing server receives the generation source of the cipher key instead of the cipher key 137 for data decryption after first processing, from the client terminal, what is stored as the cipher key 137 for data decryption after first processing in the database 121 by the key sharing server may be the generation source or may be the cipher key generated on the basis of the generation source. The client terminal generates the cipher keys on the basis of the generation source and uses the cipher keys for encryption/decryption of data.

Further, transformation of the cipher keys by using the password 133 will be described here. A description will be given of a case of the AES, which is a symmetric-key encryption scheme for simplicity. However, similar transformation of cipher keys (private key and public key) by using the password 133 is also possible in asymmetric-key encryption. In a case of a symmetric-key encryption scheme, a cipher key and a decryption key are identical and are hence referred to simply as cipher keys. Assume that data K of 256 bits is a cipher key in the AES. Assume that a current password PWD is data of 64 bits. Data of 320 (=256+64) bits obtained by adding PWD after K is denoted by K+PWD. Note that the “+” sign in “K+PWD” is desirable to be a sign obtained by circling the “+” sign, but the “+” sign is used in this Description for simplicity. Data of 256 bits obtained by applying SHA256, which is a hash function, to this K+PWD is denoted by SHA256(K+PWD). This data SHA256(K+PWD) can be assumed to be a new cipher key. This is an example of transformation of a cipher key by using the password 133. Instead of K+PWD, K|PWD may be used as an input to the hash function, for example. Note that K|PWD denotes a value obtained by XORing K and PWD with their beginnings being aligned. Options and parameters of a key transformation algorithm such as a hash function to be used (SHA256 in this case) and whether K+PWD or K|PWD is used as an input are herein referred to as key transformation parameters.

Assume that the generation source of the cipher key K is GK. (Refer to the above description for a generation source of a cipher key.) In this case, for example, K=SHA256(GK), but SHA256(GK+PWD) is also usable as a cipher key. This is also an example of a method of transforming a cipher key by using the password 133.

As described above, in the first aspect of the present invention,
at least one of the cipher key 136 for data encryption after first processing and the cipher key 137 for data decryption after first processing may be substitutable with cipher key generation source information corresponding to data serving as a source for generating a cipher key.

In the first aspect of the present invention described above,
the encrypted data acquisition unit 117 may be configured to acquire, when the first client terminal 102 outputs the data 139 including an encryption parameter, a password key derivation parameter, or a key transformation parameter, the encryption parameter, the password key derivation parameter, or the key transformation parameter from the data read,
the data decryption unit 120 may be configured to use the encryption parameter acquired by the encrypted data acquisition unit 117 to execute decryption processing on the encrypted data 138, and
the cipher key second processing unit 119 may be configured to use the password key derivation parameter acquired by the encrypted data acquisition unit 117 to generate the password key, based on the password 133 input by the password input unit 141, and perform restoration processing on the cipher key 137 for data decryption after first processing from the key disclosure unit 110 to restore the cipher key 140 for data decryption after second processing, by using the password key.

In the first aspect of the present invention described above,
the encrypted data acquisition unit 117 may be configured to acquire, when the first client terminal 102 outputs the data 139 including an encryption parameter, a password key derivation parameter, or a key transformation parameter, the encryption parameter, the password key derivation parameter, or the key transformation parameter from the data 139 read,
the data decryption unit 120 may be configured to use the encryption parameter acquired by the encrypted data acquisition unit 117 to decrypt the encrypted data 138, and
the cipher key second processing unit 119 may be configured to use the key transformation parameter acquired by the encrypted data acquisition unit 117, to perform transformation processing on the cipher key 137 for data decryption after first processing received from the key disclosure unit 110, to obtain the cipher key 140 for data decryption after second processing.

In the key sharing system 100 in the first aspect of the present invention, regarding in which one of the first client terminal 102, the key sharing server 101, and a server other than the key sharing server 101 the cipher key generation unit 108 and the cipher key first processing unit 109 are implemented, several combinations are present. This is illustrated in FIG. 31. A way of viewing FIG. 31 is as follows.

In the assignment of roles in combination 1 in FIG. 31, the first client terminal 102 performs all of generation of a cipher key for data encryption and a cipher key for data decryption by the cipher key generation unit 108, provision of the password 133 by the password provision unit 105 (automatic generation or user input), and output of the cipher key 137 for data decryption after first processing and the cipher key 136 for data encryption after first processing obtained by performing or not performing the certain processing (wrapping or transformation) on the cipher key for data decryption and the cipher key for data encryption by the cipher key first processing unit 109 by using the password 133. The first client terminal 102 transmits the cipher key 137 for data decryption after first processing output by the cipher key first processing unit 109 to the key sharing server 101 or a different server including the key registration unit 107, for sharing. The first client terminal 102 uses the cipher key 136 for data encryption after first processing output by the cipher key first processing unit 109, for encryption processing in the data encryption unit 114 in the first client terminal 102 itself. The combination of the key sharing server 101 and the first client terminal described above corresponds to the assignment of roles in combination 1.

In the assignment of roles in combination 2 in FIG. 31, in the first aspect of the present invention described above, the password provision unit 105 configured to provide the password 133 to the cipher key first processing unit 109 is included in a server (key sharing server 101 or another server),
the cipher key generation unit 108 and the cipher key first processing unit 109 are included in the first client terminal 102,
the server including the password provision unit 105 transmits the password 133 provided by the password provision unit 105, to the first client terminal 102 including the cipher key first processing unit 109, and
the first client terminal 102 including the cipher key first processing unit 109 transmits the cipher key 137 for data decryption after first processing generated by the cipher key first processing unit 109, to a server including the key registration unit 107. The first client terminal 102 uses the cipher key 136 for data encryption after first processing output by the cipher key first processing unit 109, for encryption processing in the data encryption unit 114 in the first client terminal 102 itself.

In combination 1 described above and combinations 3, 5, and 6 to be described below, assignment of roles is performed not to notify the key sharing server 101 of any cipher key. When both the cipher key generation unit 108 and the password provision unit 105 are included in the key sharing server 101, the key sharing server 101 results in knowing both the password 133 and the cipher key. In terms of security, it is not preferable that the key sharing server 101 be provided with all secrets. Hence, combination 1 is an appropriate combination.

As illustrated in FIG. 31, there are eight examples of assignment of roles indicating which one of servers and client terminals implements each of the functions of the key sharing system 100 in FIG. 1A, the examples including combinations 1 and 2 above. As examples of a method for the cipher key first processing unit 109 to process the cipher key for data decryption as described above, there are three kinds including a case of processing neither the cipher key for data encryption nor the cipher key for data decryption, a case of wrapping (encrypting) the cipher key for data decryption, and a case of transforming the cipher key for data encryption. Hence, the total number of combinations is 8*3=24 kinds.

In the following, further six kinds including combinations 3 to 8, other than the combinations 1 and 2 above, will be described.

In combination 3 in FIG. 31,
the password provision unit 105 and the cipher key generation unit 108 are included in the first client terminal 102,
the cipher key first processing unit 109 is included in a server (either the key sharing server 101 or another server),

With this configuration, the first client terminal 102 transmits the password 133 provided by the password provision unit 105, to the server (such as the key sharing server 101) including the cipher key first processing unit 109, and transmits the cipher key for data decryption or the cipher key for data encryption generated by the cipher key generation unit 108, to the server including the cipher key first processing unit 109, and
the server including the cipher key first processing unit 109 transmits the cipher key 137 for data decryption after first processing or the cipher key 136 for data encryption after first processing generated by the cipher key first processing unit 109, to a corresponding one of a server including the key registration unit 107 and the first client terminal 101.

In combination 4 in FIG. 31,
the password provision unit 105 configured to provide the password 133 to the cipher key first processing unit 109 is included in a server (key sharing server 101 or another server),
the cipher key generation unit 108 is included in the first client terminal 102,
the cipher key first processing unit 109 is included together in the server or in a server different from the server in a distributed manner,
the first client terminal 102 transmits the cipher key for data decryption or the cipher key for data encryption generated by the cipher key generation unit 108, to the server including the cipher key first processing unit 109,
the server including the password provision unit 105 transmits the password 133 provided by the password provision unit 105, to the server including the cipher key first processing unit 109, and
the server including the cipher key first processing unit 109 transmits the cipher key 137 for data decryption after first processing or the cipher key 136 for data encryption after first processing generated by the cipher key first processing unit 109, to a corresponding one of a server including the key registration unit 107 and the first client terminal 102.

In combination 5 in FIG. 31,
the password provision unit 105 is included in the first client terminal 102,
the cipher key generation unit 108 and the cipher key first processing unit 109 are included together in one server (either the key sharing server 101 or another server) or in one or more servers (key sharing server 101 or another server) in a distributed manner.

With this configuration, the first client terminal 102 transmits the password 133 provided by the password provision unit 105, to the server (for example, the key sharing server 101) including the key registration unit 107 and a server including the cipher key first processing unit 109,
the server including the cipher key generation unit 108 transmits the cipher key for data decryption or the cipher key for data encryption generated by the cipher key generation unit 108, to the server including the cipher key first processing unit 109, and
the server including the cipher key first processing unit 109 transmits the cipher key 137 for data decryption after first processing or the cipher key 136 for data encryption after first processing generated by the cipher key first processing unit 109, to a corresponding one of a server including the cipher key registration unit 107 and the first client terminal 102.

In combination 6 in FIG. 31,
the password provision unit 105 and the cipher key first processing unit 109 are included in the first client terminal 102, and
the cipher key generation unit 108 is included in a server (either the key sharing server 101 or another server).

With this configuration, the first client terminal 102 transmits the password 133 provided by the password provision unit 105, to a server (for example, the key sharing server 101) including the key registration unit 107, and
the server including the cipher key generation unit 108 transmits the cipher key for data encryption or the cipher key for data decryption generated by the cipher key generation unit 108, to the first client terminal 102.

The first client terminal 102 including the cipher key first processing unit 109 transmits the cipher key 137 for data decryption after first processing generated by the cipher key first processing unit 109, to the server including the cipher key registration unit 107. The first client terminal 102 uses the cipher key 136 for data encryption after first processing output by the cipher key first processing unit 109, for encryption processing in the data encryption unit 114 in the first client terminal 102 itself.

In combination 7 in FIG. 31,
the password provision unit 105 configured to provide the password 133 to the cipher key first processing unit 109 is included in a server (key sharing server 101 or another server),
the cipher key generation unit 108 is included together in the server (key sharing server 101) or in a server different from the server in a distributed manner,
the cipher key first processing unit 109 is included in the first client terminal 102,
the server including the password provision unit 105 transmits the password 133 provided by the password provision unit 105, to the first client terminal 102 including the cipher key first processing unit 109,
the server including the cipher key generation unit 108 transmits the cipher key for data encryption or the cipher key for data decryption generated by the cipher key generation unit 108, to the first client terminal 102 including the cipher key first processing unit 109, and
the first client terminal 102 including the cipher key first processing unit 109 transmits the cipher key 137 for data decryption after first processing generated by the cipher key first processing unit 109, to a server (key sharing server 101 or another server) including the key registration unit 107. The first client terminal 102 uses the cipher key 136 for data encryption after first processing output by the cipher key first processing unit 109, for encryption processing in the data encryption unit 114 in the first client terminal 102 itself.

In combination 8 in FIG. 31,
the password provision unit 105 configured to provide the password 133 to the cipher key first processing unit 109 is included in a server (key sharing server 101 or another server),
the cipher key generation unit 108 and the cipher key first processing unit 109 are included together in the server or in one or more servers different from the server together or in a distributed manner,
the server including the password provision unit 105 transmits the password 133 provided by the password provision unit 105, to the server including the cipher key first processing unit 109,
the server including the cipher key generation unit 108 transmits the cipher key for data encryption or the cipher key for data decryption generated by the cipher key generation unit 108, to the server including the cipher key first processing unit 109, and
the server including the cipher key first processing unit 109 transmits the cipher key 137 for data decryption after first processing or the cipher key 136 for data encryption after first processing generated by the cipher key first processing unit 109, respectively to a server (key sharing server 101 or another server) including the key registration unit 107 or the first client terminal 102.

Here, the verification unit 106, the key registration unit 107, and the key disclosure unit 110 may be included together in the key sharing server 101 or may be included together in one server other than the key sharing server 101 or in one or more servers in a distributed manner.

The above-described key sharing system may be implemented as a method or a program. A server device (key sharing server 101) including the database 121 and including any of the identification token issue unit 104, the password provision unit 105, verification unit 106, the key registration unit 107, the cipher key generation unit 108, the cipher key first processing unit 109, and the key disclosure unit 110, a terminal device having the functions of the first client terminal 102, or a terminal device having the functions of the second client terminal 103 is also within the scope of the present invention.

### Advantageous Effects of Invention

According to a disclosed technique, by using the identification token, the key disclosure permission information 134, the key identification information 135, the password 133, and the plurality of kinds of keys 136, 137, and 138 in combination, a sharing processing technique for more securely sharing the encrypted data 139 obtained by encrypting the encryption target data can be provided.

In the present invention, since an administrator of the key sharing server 101 and a holder/manager of the encrypted data 139 can be separated, the following can be realized.

The administrator of the key sharing server 101 and the holder/manager of the encrypted data 139 are different from each other in general and cannot know contents of data of a user independently.

Neither the administrator of the key sharing server 101 nor the holder/manager of the encrypted data 139 can use data and personal information of a user without permission. Use of the personal information without permission, without authorization, or with a disadvantage of the user is not possible in the first place.

Since a storage is separated from a service providing a key, the cost of the storage is reduced.

A general-purpose storage, a blog, or the like on the Internet can be used as a storage for the encrypted data 139. Since no storage needs to be constructed, maintained, and managed only for a specific SNS service, the cost of the storage is reduced.

Since neither the administrator of the key sharing server 101 nor the holder/manager of the encrypted data 139 can know contents of the encrypted data 139 of the user independently, any action similar to inspection is not possible in the first place.

Note that, to delete illegal contents or the like, it is sufficient to delete either the password or the encrypted data 139.

The present invention does not require any time and effort for a receiver to provide a receiver the latest public key for encrypting data destined to the receiver self.

Time and effort for the transmitter to find the latest public key for each receiver is not required.

Further, by identifying the receiver by using an authenticated e-mail address, highly secure data sharing is enabled. Security is not dependent on a password shared between parties concerned.

Further, the present invention has the following effects. By employing an option of verifying the identifier (ID) of a transmitter (key owner ID), the transmitter can be identified.

The transmitter can limit a disclosure period of a corresponding key.

Other issues, features, and advantages will be apparent by reading Description of Embodiments to be described below when being addressed together with the drawings and Claims.

### BRIEF DESCRIPTION OF DRAWINGS

FIG. 1A is a block diagram illustrating a functional configuration of a key sharing system according to a first aspect.

FIG. 1B is a sequence diagram illustrating an operation sequence of the functional configuration of the key sharing system according to the first aspect.

FIG. 1C is a block diagram illustrating a network configuration of the key sharing system according to one embodiment.

FIG. 1D is a block diagram illustrating a network configuration of the password sharing system according to the one embodiment.

FIG. 2 is a block diagram illustrating a configuration of a key sharing server in the one embodiment.

FIG. 3 is a block diagram illustrating a configuration of a client terminal in the one embodiment.

FIG. 4 is a block diagram illustrating a configuration of a first key sharing server in the one embodiment.

FIG. 5 is a block diagram illustrating a detailed configuration of the first key sharing system in the one embodiment.

FIG. 6 is a block diagram illustrating a detailed configuration of the first key sharing server in the one embodiment.

FIG. 7 is a block diagram illustrating a detailed configuration of the first key sharing server in the one embodiment.

FIG. 8 is a diagram for describing the first key sharing system in the one embodiment.

FIG. 9 is a diagram for describing the first key sharing server in the one embodiment.

FIG. 10 is a diagram for describing the first key sharing server in the one embodiment.

FIG. 11A is a block diagram illustrating a detailed configuration of the first key sharing server in the one embodiment.

FIG. 11B is a diagram for describing processing in the first key sharing server in the one embodiment.

FIG. 12A is a block diagram illustrating a detailed configuration of the first key sharing server in the one embodiment.

FIG. 12B is a diagram for describing processing in the first key sharing server in the one embodiment.

FIG. 12C is a diagram for describing the processing in the first key sharing server in the one embodiment.

FIG. 13 is a block diagram illustrating a detailed configuration of the first key sharing server in the one embodiment.

FIG. 14 is a block diagram illustrating a detailed configuration of the first key sharing server in the one embodiment.

FIG. 15 is a block diagram illustrating a configuration of a second key sharing server in the one embodiment.

FIG. 16A is a block diagram illustrating a detailed configuration of the second key sharing server in the one embodiment.

FIG. 16B is a diagram for describing processing in the second key sharing server in the one embodiment.

FIG. 17 is a block diagram illustrating a configuration of a third key sharing server in the one embodiment.

FIG. 18A is a block diagram illustrating a detailed configuration of the third key sharing server in the one embodiment.

FIG. 18B is a block diagram illustrating processing in the third key sharing server in the one embodiment.

FIG. 19 is a block diagram illustrating a configuration of a key registration client terminal in the one embodiment.

FIG. 20 is a block diagram illustrating a detailed configuration of a first key registration client terminal in the one embodiment.

FIG. 21 is a block diagram illustrating a detailed configuration of the first key registration client terminal in the one embodiment.

FIG. 22A is a block diagram illustrating a detailed configuration of the first key registration client terminal in the one embodiment.

FIG. 22B is a diagram for describing processing in the first key registration client terminal in the one embodiment.

FIG. 23 is a diagram for describing processing in the first key registration client terminal in the one embodiment.

FIG. 24A is a block diagram illustrating a detailed configuration of a second key registration client terminal in the one embodiment.

FIG. 24B is a diagram for describing processing in the second key registration client terminal in the one embodiment.

FIG. 25A is a block diagram illustrating a detailed configuration of a third key registration client terminal in the one embodiment.

FIG. 25B is a diagram for describing processing in the third key registration client terminal in the one embodiment.

FIG. 26A is a block diagram illustrating a detailed configuration of a fourth key registration client terminal in the one embodiment.

FIG. 26B is a diagram for describing processing in the fourth key registration client terminal in the one embodiment.

FIG. 27 is a block diagram illustrating a configuration of a key acquisition client terminal in the one embodiment.

FIG. 28A is a block diagram illustrating a detailed configuration of a first key acquisition client terminal in the one embodiment.

FIG. 28B is a diagram for describing processing in the first key acquisition client terminal in the one embodiment.

FIG. 29A is a block diagram illustrating a detailed configuration of the first key acquisition client terminal in the one embodiment.

FIG. 29B is a diagram for describing processing in the first key acquisition client terminal in the one embodiment.

FIG. 30A is a block diagram illustrating a detailed configuration of a second key acquisition client terminal in the one embodiment.

FIG. 30B is a diagram for describing processing in the second key acquisition client terminal in the one embodiment.

FIG. 31 is a diagram for describing assignment of functional roles between a server and a client terminal functioning as a key sharing system.

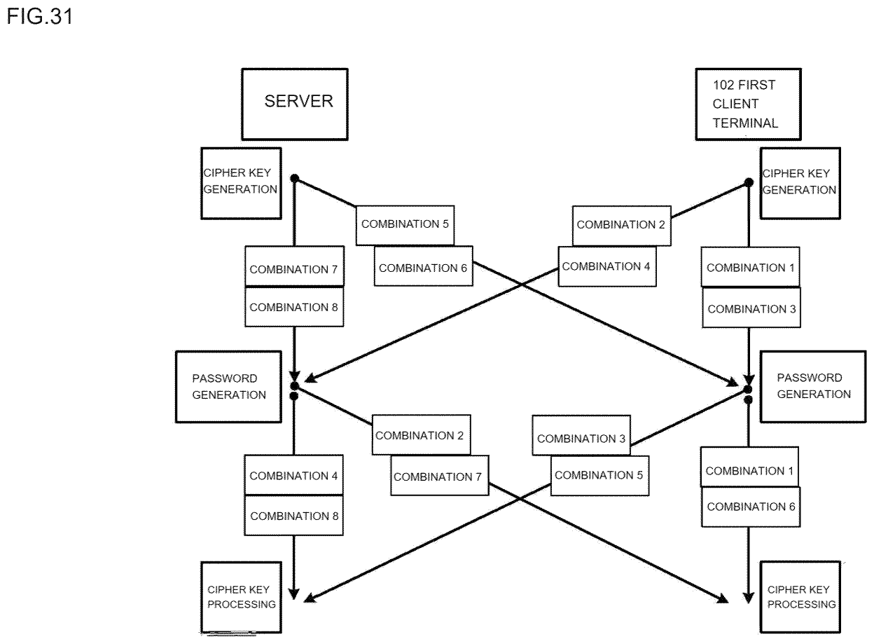

### DESCRIPTION OF EMBODIMENTS

A description will be given in further detail below with reference to the accompanying drawings. Preferable embodiments are illustrated in the drawings. However, many different embodiments are possible, and the embodiments described in this Description are not restrictive.

### {Key Sharing System}

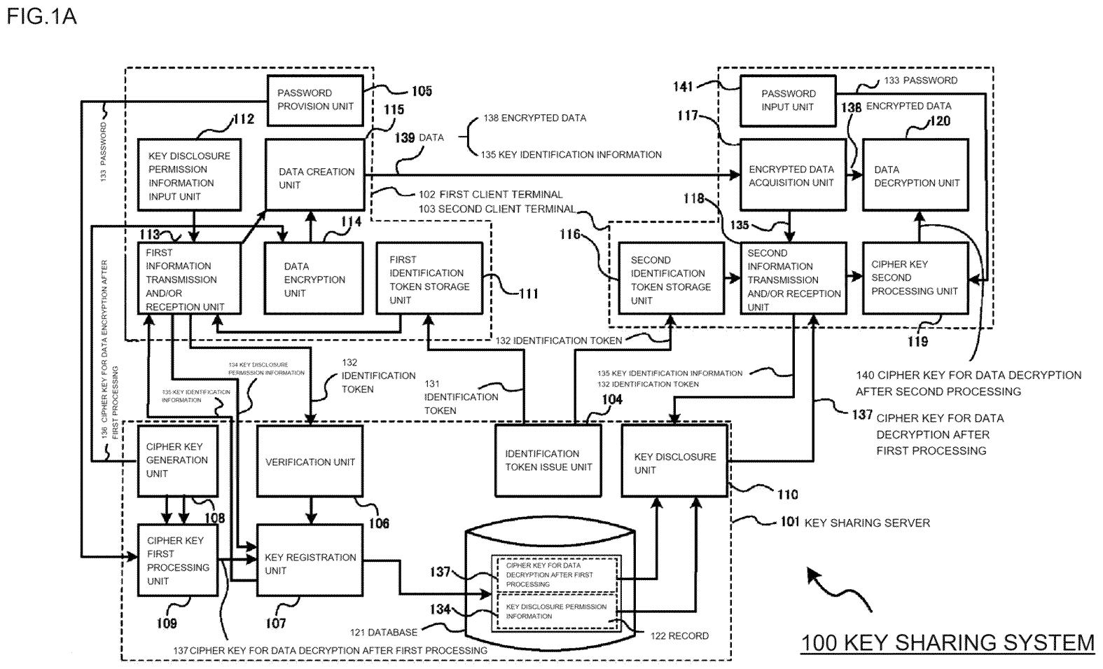

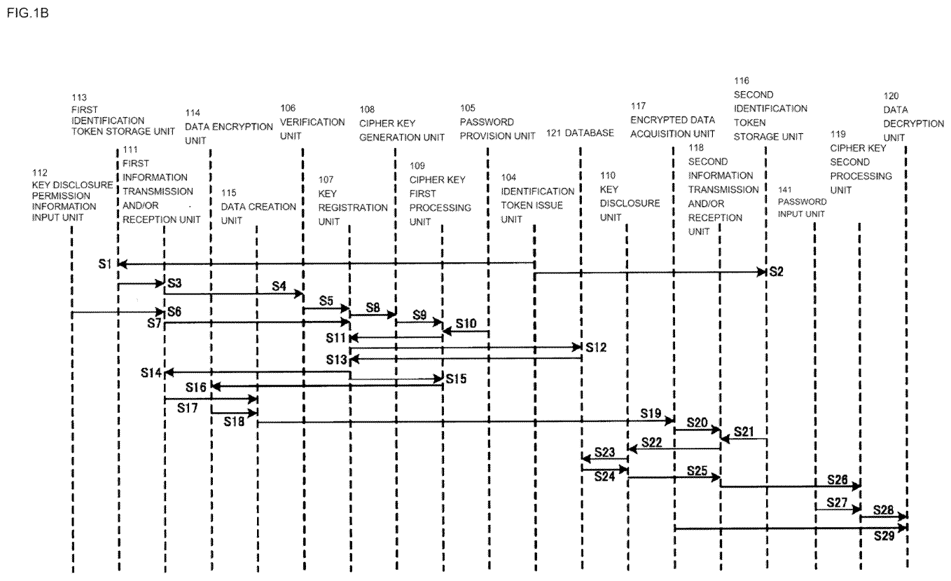

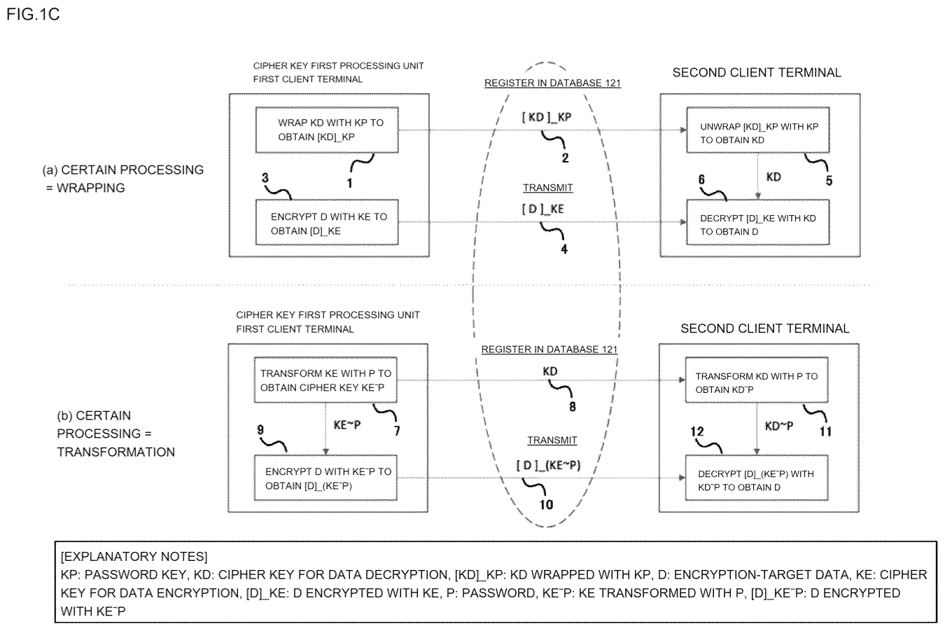

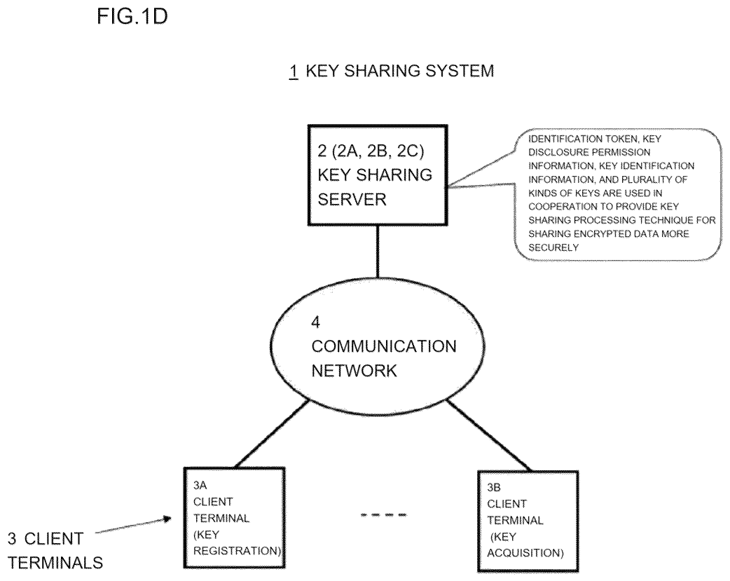

With reference to FIG. 1C illustrating a system configuration in one embodiment, a key sharing system 1 includes a key sharing server 2, a plurality of client terminals (also referred to as user terminals) 3, and a communication network 4. According to this key sharing system 1, by using an identification token, key disclosure permission information, key identification information, and a plurality of kinds of keys in combination, a key sharing processing technique for more securely sharing encrypted data obtained by encrypting encryption target data is provided. The key sharing system 1 corresponds to the key sharing system 100 in FIG. 1A. The key sharing server 2 corresponds to the key sharing server 101 in FIG. 1A. Each client terminal 3 correspond to the first client terminal 102 or the second client terminal 103 in FIG. 1A.

The communication network 4 enables wireless or wired data communication and is configured by an Internet protocol (IP) network such as the Internet, a local area network, or a virtual private network (VPN), to include the key sharing server 2 and the plurality of client terminals 3 (3A and 3B). Note that, in the following description, intervention of the communication network 4 is omitted unless otherwise causing ambiguity.

In this key sharing system 1, the key sharing server 2 is a server on the Internet, the server being operated and managed by a key sharing service provider and is operated by using facilities of a virtual server provider or a cloud operator. The key sharing server 2 executes key sharing processing to be described below in detail. The key sharing server 2 is implemented as a first key sharing server 2A, a second key sharing server 2B, or a third key sharing server 2C.

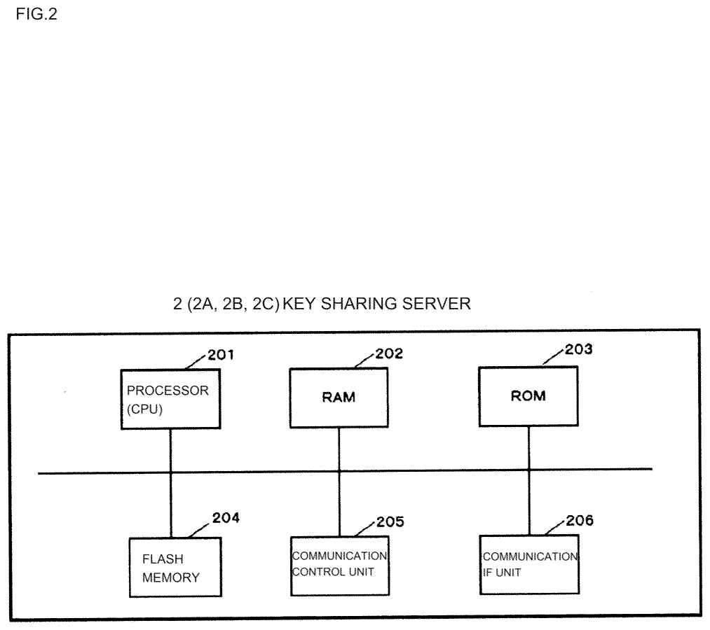

To be more specific, this key sharing server 2 has the function of data communication with the plurality of client terminals 3 and includes hardware components as illustrated in FIG. 2. Specifically, the key sharing server 2 includes a central processing unit (CPU) 201 as a processor, a random access memory (RAM) 202 as a memory for operation, and a read only memory (ROM) 203 storing therein a boot program for boot-up.

The key sharing server 2 further includes a nonvolatile flash memory 204 storing therein an operating system (OS), an application program, and various kinds of information (including data) in a rewritable manner, a communication control unit 205, a communication interface (IF) unit 206 such as a network interface card (NIC), and the like.

The key sharing server 2 includes the user registration processing unit (first processing unit) 21, the login processing unit 22, a user relationship holding processing unit 23, the key registration processing unit (second processing unit) 24, the key disclosure processing unit (third processing unit) 25, the key deletion processing unit 26, the key disclosure period change processing unit 27, and the like as functional components to be described below in detail.

As an example, to logically implement these functional components in the key sharing server 2, a key sharing processing program is installed in advance in the flash memory 204 as an application program. Then, in the key sharing server 2, upon indication or power-on by an operator (manager), the processor (CPU) 201 continuously develops this processing program in the RAM 202 for execution. The key sharing processing program executes the key sharing processing in cooperation with the above-described hardware components.

In this key sharing system 1, each client terminal 3 is a single unit or a combined unit of user terminals each having a wireless or wired data communication function such as a mobile phone terminal including a smartphone and a computer terminal including a personal computer and a tablet terminal, and is assigned with a telephone number, an e-mail address, and/or an IP address.

Each client terminal 3 is implemented as the client terminal having a key registration function (corresponding to the first client terminal 102 in FIG. 1A) 3A or the client terminal having a key acquisition function (corresponding to the second client terminal in FIG. 1A) 3B. One client terminal 3 may be configured to have the key registration function and the key acquisition function.

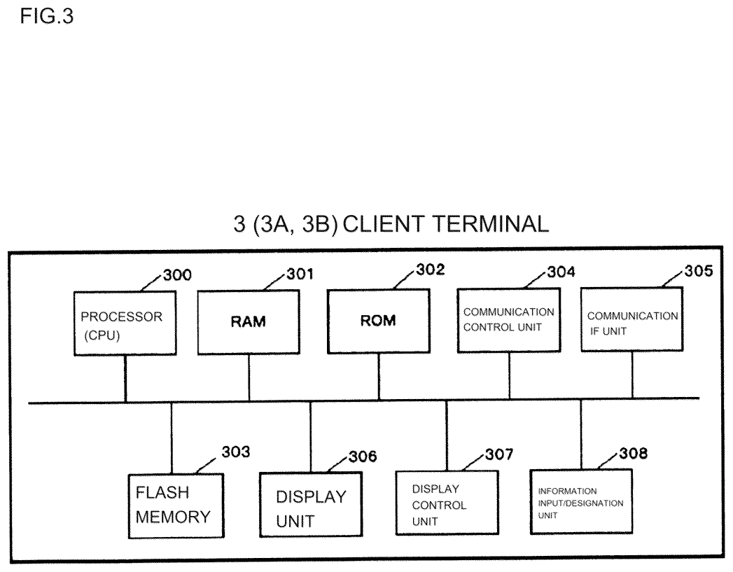

To be more specific, each of the plurality of client terminals 3 (3A and 3B) in the key sharing system 1 includes hardware components as illustrated in FIG. 3. Specifically, the client terminal 3 includes a CPU 300 as a processor, a RAM 301 as a memory for operation, and a ROM 302 storing therein a boot program for boot-up.

The client terminal 3 further includes a nonvolatile flash memory 303 storing therein an OS, an application program, and various kinds of information (including data) in a rewritable manner, a communication control unit 304 having a wireless and wired data communication function, and a communication interface (IF) unit 305 such as an NIC.

The client terminal 3 further includes a display unit 306 including a display (liquid crystal display (LCD)), a display control unit 307, and an information input/designation unit 308 including ten keys, various kinds of function buttons (keys), a pointing unit, a cursor moving unit, and the like.

Each client terminal 3 selectively includes a user registration processing unit 31, a login processing unit 32, a key registration processing unit 33, a data creation processing unit 34, a key acquisition processing unit 35, a data decryption processing unit 36, and the like, as functional components to be described below in detail, according to each embodiment (example).

As an example, to logically implement these functional components in each client terminal 3, a terminal control program for key sharing processing is installed in advance in the flash memory 303 as an application program. Then, in the client terminal 3, upon indication or power-on by a user, the processor (CPU) 300 continuously develops this terminal control program in the RAM 301 for execution. The terminal control program executes the key sharing processing in cooperation with the above-described hardware components.

### {Details of First Key Sharing Server}

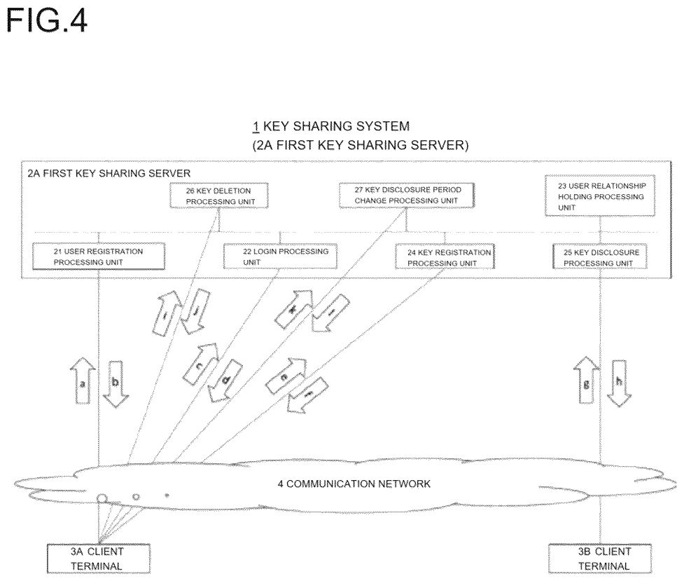

Details of the first key sharing server 2A in the key sharing system 1 will be described with reference to FIG. 1C and FIG. 4, and related drawings together.

With reference to FIG. 4, the first key sharing server 2A includes the user registration processing unit 21, the login processing unit 22, the user relationship holding processing unit 23, the key registration processing unit 24, the key disclosure processing unit 25, the key deletion processing unit 26, and the key disclosure period change processing unit 27 as functional components.

Here, the basic feature elements of the first key sharing server 2A are the user registration processing unit (corresponding to the identification token issue unit 104 in FIG. 1A) 21, the key registration processing unit (corresponding to the key registration unit 107 in FIG. 1A) 24, and the key disclosure processing unit (corresponding to the key disclosure unit 110 in FIG. 1A) 25.

In other words, the first key sharing server 2A is a key sharing server (corresponding to the key sharing server 101 in FIG. 1A) applicable to the key sharing system 1 including the key registration client terminal (corresponding to the first client terminal 102 in FIG. 1A) 3A used by a first user and the key acquisition client terminal (corresponding to the second client terminal 103 in FIG. 1A) 3B used by a second user and includes the user registration processing unit 21 configured to issue an identification token (proof) indicating that a corresponding user is an authenticated user.

The first key sharing server 2A includes the key registration processing unit 24 configured to receive an identification token issued by the user registration processing unit 21 and corresponding to the first user (corresponding to the identification token 131 in FIG. 1A), an encryption password for data decryption (corresponding to the password 133 in FIG. 1A), and key disclosure permission information (corresponding to the key disclosure permission information 134 in FIG. 1A) indicating the disclosure permissible range for a cipher key for data decryption (corresponding to the cipher key 137 for data decryption after first processing in FIG. 1A), from the first client terminal 3A, store the cipher key for data decryption and the key disclosure permission information in a database, and transmit, only when the identification token is confirmed to be a correct identification token through verification, key identification information (key ID) (corresponding to the key identification information 135 in FIG. 1A) for identifying the stored cipher key for data decryption and key disclosure permission information in a database (corresponding to the database 121 in FIG. 1A), to the first client terminal 3A.

Note that the password may be created by the first user or may be automatically generated by a program, and a method of generating the password is not limited to these. In this embodiment, a function corresponding to the password provision unit 105 in FIG. 1A is included in the first client terminal 3A (corresponding to the first client terminal 102 in FIG. 1A).

A cookie may be used for transmission of an identification token from a client to a server. In this case, it is assumed that the server has transmitted the identification token as a cookie to the client terminal in advance.

Further, the first key sharing server 2A includes a key disclosure processing unit 25 (corresponding to the key disclosure unit 110 in FIG. 1A) configured to receive an identification token issued by the user registration processing unit 21 and corresponding to a second user (corresponding to the identification token 132 in FIG. 1A) and the key ID acquired by reading the data output by the first client terminal 3A (corresponding to the data 139 in FIG. 1A) and transmitted from the key registration processing unit 24, from the second client terminal 3B, acquire information of the second user identified by the identification token corresponding to the second user, acquire the cipher key for data decryption (corresponding to the cipher key 137 for data decryption after first processing stored in the record 122 in the database 121 in FIG. 1A) identified by the key ID received from the second client terminal 3B and the key disclosure permission information (corresponding to the key disclosure permission information 134 similarly stored in the record 122 in FIG. 1A), from the database (corresponding to the database 121 in FIG. 1A), and transmit, only when it is confirmed that the second user is included in the key disclosure permissible range designated by the key disclosure permission information acquired from the database, the cipher key for data decryption identified by the key ID (corresponding to the cipher key 137 for data decryption after first processing in FIG. 1A) to the second client terminal 3B.

The first key sharing server 2A can adopt any of the following aspects. Note that [Aspect 1] to [Aspect 4] are also applicable to the second key sharing server 2B and the third key sharing server 2C.

[Aspect 1] In the first key sharing server 2A, the key disclosure permission information includes at least one of a relationship between users registered to the first key sharing server 2A in advance, designation of a user group registered to the first key sharing server 2A in advance, and a list of e-mail addresses. Regarding the list of e-mail addresses, the client terminal 3A may transmit the list of e-mail addresses as the key disclosure permission information.

[Aspect 2] In the first key sharing server 2A, the key registration processing unit 24 receives a key disclosure period together with the identification token from the first client terminal 3A.

The key disclosure processing unit 25 acquires the key disclosure period together with the cipher key for data decryption identified by the received key ID, from the database, and transmits, when a current time is within the key disclosure period, the cipher key for data decryption identified by the key ID, to the second client terminal 3B.

[Aspect 3] In the first key sharing server 2A, the key registration processing unit 24 transmits a key owner ID (key owner identification information) or a URL for key acquisition to the first client terminal 3A.

[Aspect 4] In the first key sharing server 2A, the key disclosure processing unit 25 receives a first key owner ID together with the identification token and the key ID from the second client terminal 3B, acquires a second key owner ID together with the cipher key for data decryption identified by the key ID from the database, and transmits, when the first key owner ID and the second key owner ID match, the cipher key for data decryption identified by the key ID, to the second client terminal 3B.

Next, further details of the first key sharing server 2A in the key sharing system 1 will be described with reference to FIG. 1, FIG. 4, and related drawings together.

With reference to FIG. 4, the user registration processing unit 21, the login processing unit 22, the user relationship holding processing unit 23, the key registration processing unit 24, the key disclosure processing unit 25, the key deletion processing unit 26, and the key disclosure period change processing unit 27 configuring the first key sharing server 2A share part of detailed components as will be described below.

As illustrated in FIG. 4, the first key sharing server 2A transmits/receives the following various data a to 1 to/from the key registration client terminal 3A and the key acquisition client terminal 3B. Note that data with a “*” mark described below is optional data and is not used in some examples.
[Data a] at temporary registration: e-mail address, password; at formal registration: token for registration, e-mail address, password
[Data b] at temporary registration: token for registration, URL for registration; at formal registration: identification token
[Data c]e-mail address, password
[Data d] identification token
[Data e] identification token, cipher key, key disclosure permission information, *key disclosure period
[Data f] key ID, *key owner ID, *URL for key acquisition
[Data g] identification token, key ID, *key owner ID
[Data h] cipher key
[Data i] identification token, key ID
[Data j]*result: success or failure
[Data k] identification token, key ID, key disclosure period
[Data l]*result: success or failure

Here, a user to encrypt data (encryption target data) and register a cipher key uses the key registration processing unit 24, and a user to request disclosure of the cipher key to decrypt the data (encrypted data) uses the key disclosure processing unit 25. These users may be the same user but are separate in general, and hence the key registration client terminal 3A and the key acquisition client terminal 3B are illustrated.

An “e-mail address” in this Description indicates an ID (identification information) for identifying a reception user in communication in general. For example, a phone number may be used instead of an e-mail address. Any ID usable as an ID for identifying a reception user in communication, such as an ID of an SNS (for example, a LINE ID, “LINE” is a registered trademark of LINE Corporation) and a handle name may be used.

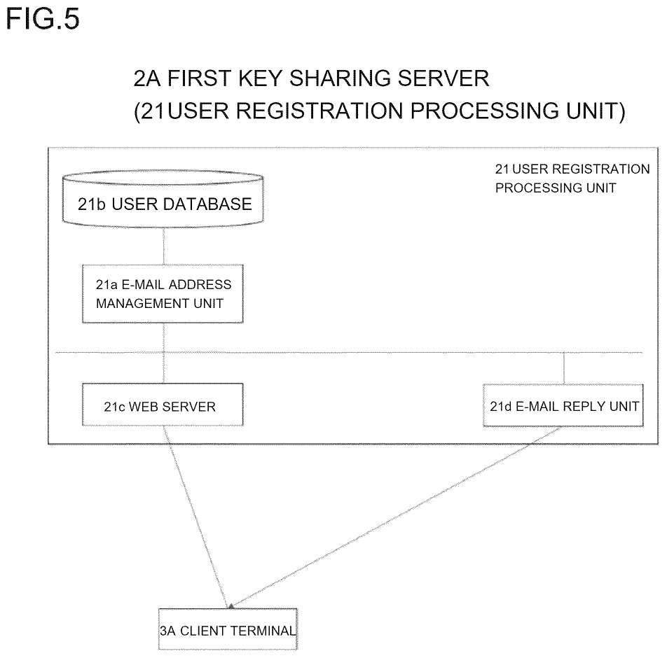

With reference to FIG. 5, the user registration processing unit 21 in the first key sharing server 2A is configurable to include an e-mail address management unit 21a, a user database 21b, a web server (here, a web server function unit) 21c, and an e-mail reply unit 21d, as detailed components.

The processing in this user registration processing unit 21 is considered to be similar to what is performed in general in various Internet services such as Facebook and can be easily understood by those skilled in the art. Hence, only main points will be described here.

In the user registration processing unit 21, the e-mail address management unit 21a, the user database 21b, the web server 21c, and the e-mail reply unit 21d cooperate to temporarily register an e-mail address and a password used by a user and confirm that the user is the owner of the e-mail address for formal registration. The user cannot use the service of the first key sharing server 2A until the formal registration is completed. As will be described below, to use the various services of this server, an identification token generated by the user registration processing unit 21 is needed.

In the user registration processing unit 21, to confirm that the e-mail address temporarily registered by the user is the e-mail address of the user, the e-mail reply unit 21d transmits a token for registration in an e-mail to a registered e-mail address. The token for registration is transmitted as a readable character string. The token for registration is given as a query parameter of a uniform resource locator (URL) for registration. When the user who has received the e-mail clicks the URL for registration, the web server 21c can acquire the token for registration as the query parameter. The URL for registration is a URL for the user to access the web server 21c from the key registration client terminal 3A.

The token for registration includes information specific to the temporarily registered user generated by the e-mail address management unit 21a. The information is the ID or the like of the user temporarily registered in the user database 21b. The e-mail address management unit 21a searches the user database 21b by using the token for registration to thereby be able to acquire the e-mail address and the password of the temporarily registered user.

The web server 21c asks the temporarily registered user who has received the e-mail and accessed the first key sharing server 2A, to input the e-mail address and the password. Consequently, the e-mail address management unit 21a confirms that the e-mail receiver is the user who has made temporary registration. Upon confirmation that the e-mail address and the password input by the user match the e-mail address and the password of the temporarily registered user, the e-mail address management unit 21a formally registers the user in the user database 21b.

After the formal registration, the e-mail address management unit 21a generates an identification token for the registered user, and the web server 21c transmits the identification token to the key registration client terminal 3A. The identification token is different from the token for user registration. The identification token includes information specific to the user, for example, the ID of the user in the user database 21b, and the user can be identified by the identification token.

Note that the web server 21c may transmit the identification token as a cookie to the client terminal 3A.

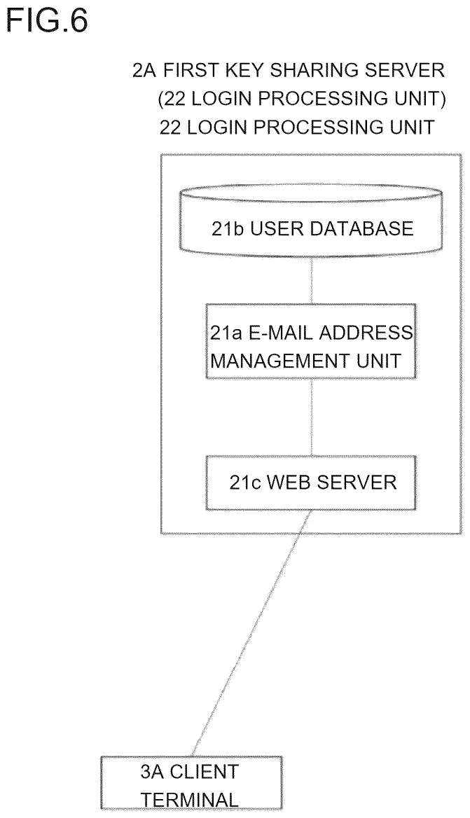

With reference to FIG. 6, the login processing unit 22 in the first key sharing server 2A is configurable to include the e-mail address management unit 21a, the user database 21b, and the web server 21c, as detailed components. These components are shared with the user registration processing unit 21.

The processing in this login processing unit 22 is considered to be similar to what is performed in general in various Internet services such as Facebook and can be easily understood by those skilled in the art. Hence, only main points will be described here.

In the login processing unit 22, the e-mail address management unit 21a, the user database 21b, and the web server 21c cooperate to reissue an identification token to the formally registered user. This is a necessary procedure for such an identification token set with a term of validity. In other words, the login processing unit 22 has a function of issuing an identification token to the formally registered user and issuing, when the identification token expires, a new identification token to the user. When the user uses the first key sharing server 2A from a plurality of key registration client terminals 3A, the user storing an identification token in each key registration client terminal 3A to use can increase convenience.

The identification token is evidence (proof) that the e-mail address is authenticated. The authentication of the e-mail address indicates that a system (server) successfully confirms that the user who has temporarily registered the e-mail address has received an e-mail destined to the e-mail address. In general, a function of providing authentication of an e-mail address to another system is present. For example, a mechanism called OAuth provides the function. The first key sharing server 2A may use this OAuth mechanism to thereby issue an identification token based on the authentication of the e-mail address.

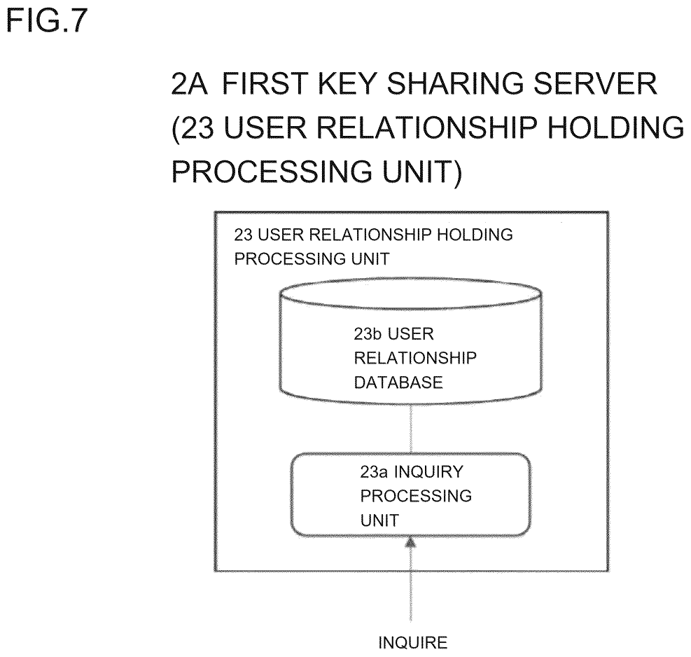

With reference to FIG. 7, the user relationship holding processing unit 23 in the first key sharing server 2A is configurable to include an inquiry processing unit 23a and a user relationship database 23b, as detailed components.

In the processing in this user relationship holding processing unit 23, the user registering a cipher key to the first key sharing server 2A registers a relationship between the user and another user in the user relationship database 23b from the key registration client terminal 3A in advance. In response to an inquiry/question [U, R, u] about a user U, a user u, and a relationship R between users from the key disclosure processing unit 25, the inquiry processing unit 23a returns an answer [yes (positive judgment)] or [no (negative judgment)].

The user subjected to the processing in the user relationship holding processing unit 23 is expressed by the e-mail address used by the user as an example. The relationship R between users is any of “family”, “good friend”, “friend”, “friend of friend”, and “others”, for example.

This relationship R between users may be designation of the group to which the user U and the user u belong. In this case, the user relationship holding processing unit 23 answers [yes] when the user U and the user u belong to a group of the relationship R between users, and answers [no] otherwise. As the relationship R between users, a plurality of groups may be designated. In this case, the user relationship holding processing unit 23 answers [yes] when the user U and the user u both belong to any of the groups included in the relationship R between users, and answers [no] otherwise. Further, as designation of a relationship between users, “following/followed” used by Twitter (registered trademark of US “Twitter, Inc.”) and the like can be used.

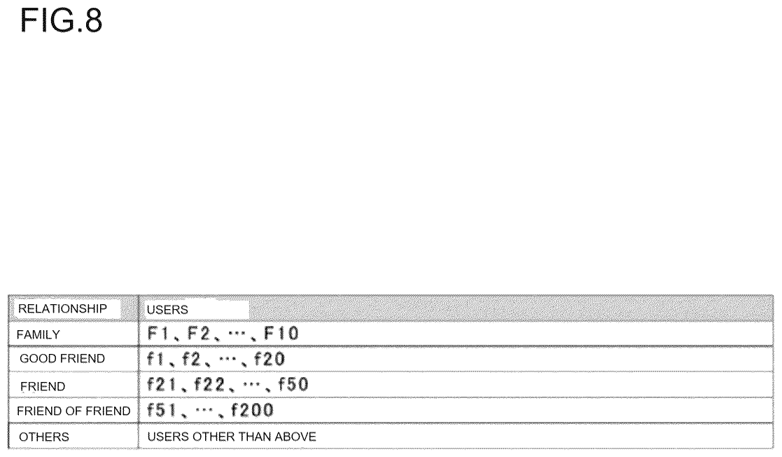

The user relationship database 23b in the user relationship holding processing unit 23 stores therein a list illustrated in FIG. 8 for the user U. This list is a user relationship table for the user U. The user relationship table for the user U is registered in advance in the user relationship database 23b in the user relationship holding processing unit 23 by the user U. Note that the relationship R between users is assumed to have an order relation of “family”>“good friend”>“friend”>“friend of friend”>“others”.

Upon receipt of an inquiry [U, friend, f20], the inquiry processing unit 23a interprets this inquiry as “whether U and f20 are friends?” According to the user relationship table, U and f20 are of good friend, and good friend has an order relation higher than that of friend. Hence, the answer from the inquiry processing unit 23a to this inquiring is [yes].

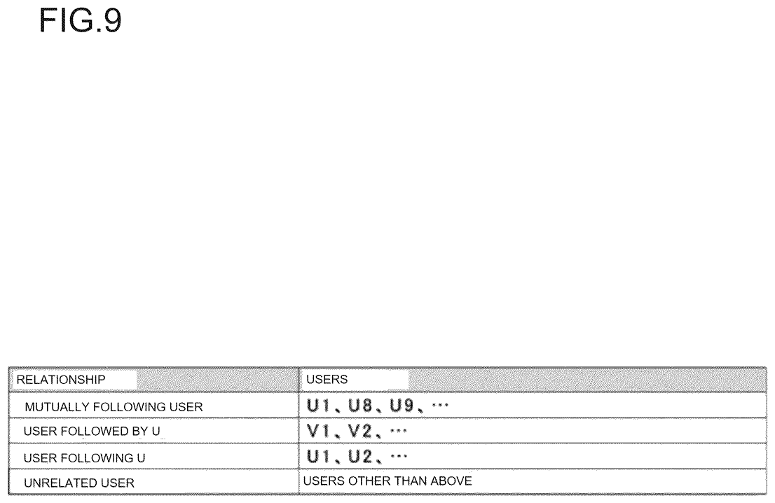

As the relationship R between users, when “following/followed” described above is used, the user relationship holding processing unit 23 stores the user relationship table illustrated in FIG. 9 for each user U. In this user relationship table, “mutually following user” is a product set of a set of “users followed by U” and a set of “users following U”. It is assumed that the product set (set of mutually following users) is excluded from both the set of “users followed by U” and the set of “users following U”. It is assumed that the relationship R between users has an order relation of “mutually following user”>“user followed by U”>“users following U”>“unrelated user”.

In the case of this example, in the user relationship holding processing unit 23, the inquiry processing unit 23a receives an inquiry [U, mutual follow, U2]. The inquiry processing unit 23a interprets this inquiry as “whether U2 is a user having a relationship of mutual follow with U?” According to the user relationship table illustrated in FIG. 9, U2 follows U but is not followed by U. Mutual follow has an order relation higher than that of a case of being simply followed. In other words, a user simply following U does not have a relationship of mutual follow. Hence, the answer from the inquiry processing unit 23a to this inquiry is [no].

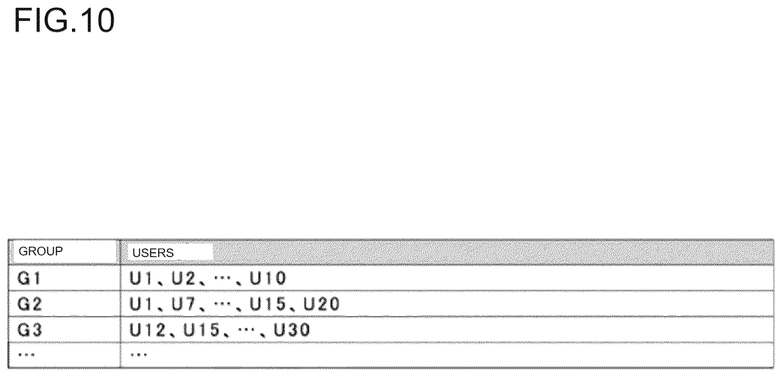

The user relationship database 23b in the user relationship holding processing unit 23 may store therein a list of groups illustrated in FIG. 10 for the user U. The user registers this list in the user relationship database 23b from the key registration client terminal 3A in advance, for example.

In the case of this example, in the user relationship holding processing unit 23, the inquiry processing unit 23a receives an inquiry [u, {G1, G2, . . . , GN}, f]. The inquiry processing unit 23a interprets this inquiry as “whether a group including f is included in groups G1 to GN for u?” The inquiry processing unit 23a checks whether the members of the groups G1 to GN for the user u includes a user f, on the basis of the list of groups illustrated in FIG. 10 in the user relationship database 23b. Then, the inquiry processing unit 23a answers [yes] when the user f is included and answers [no] otherwise.

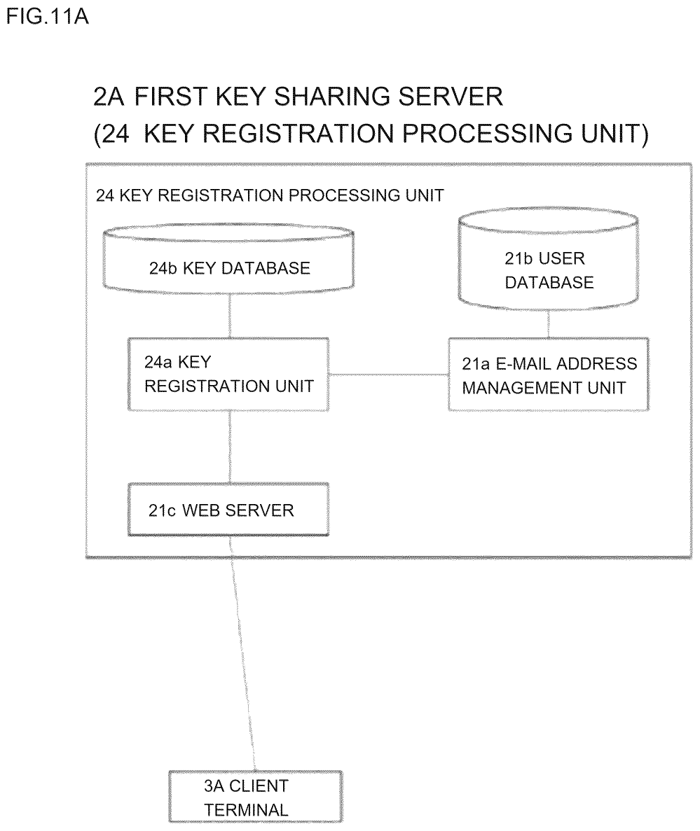

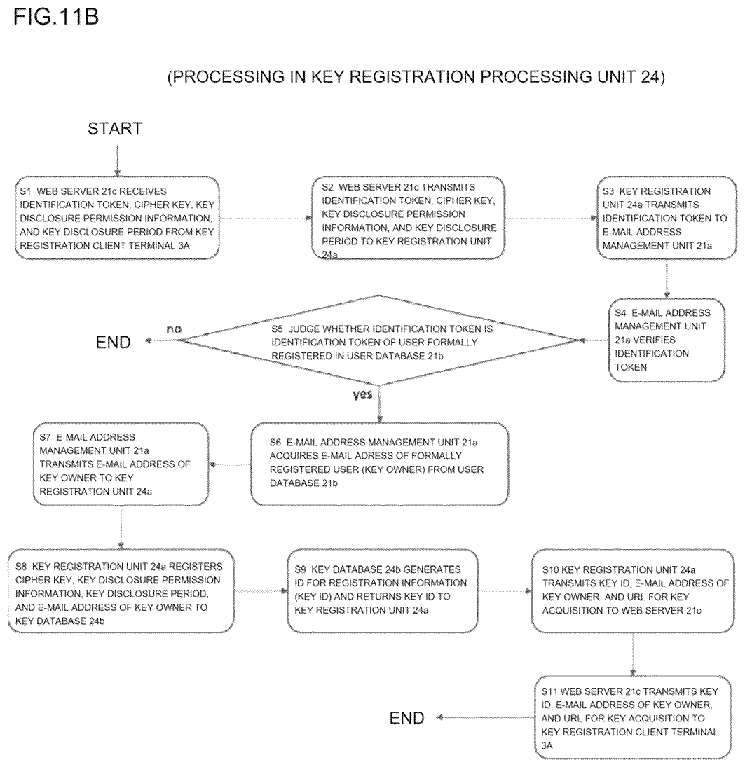

With reference to FIG. 11A, the key registration processing unit 24 in the first key sharing server 2A is configurable to include the e-mail address management unit 21a, the user database 21b, the web server 21c, a key registration unit 24a, and a key database 24b, as detailed components. The e-mail address management unit 21a, the user database 21b, and the web server 21c of the components are shared with other processing units.

In the processing in this key registration processing unit 24, the key registration unit 24a receives an identification token, a cipher key, and key disclosure permission information from the key registration client terminal 3A via the web server 21c. The key registration unit 24a cooperates with the e-mail address management unit 21a and the user database 21b to verify the identification token and confirms that this is the user formally registered to the user registration processing unit 21.

The key registration unit 24a cooperates with the e-mail address management unit 21a and the user database 21b to acquire the e-mail address of the user and register the e-mail address in the key database 24b together with the cipher key and the key disclosure permission information. The key database 24b generates key identification information (key ID) for identifying the information registered and returns the key identification information to the key registration unit 24a. The user who has registered a key is referred to as the key owner of the cipher key.

The identification token transmitted from the key registration client terminal 3A to the key registration processing unit 24 is one generated by the user registration processing unit 21 or the login processing unit 22 here. The key registration client terminal 3A transmits the identification token to indicate that this is the user formally registered to the first key sharing server 2A.

The key registration processing unit 24 may receive a key disclosure period from the key registration client terminal 3A in addition to the identification token, the cipher key, and the key disclosure permission information. Concrete examples of the key disclosure period are a key disclosure start time corresponding to the time at which disclosure of the cipher key starts and a key disclosure end time corresponding to the time at which the disclosure of the key ends. When the key disclosure start time is used, the key disclosure processing unit 25 to be described below does not transmit the cipher key to the key acquisition client terminal 3B before the key disclosure start time. When the key disclosure end time is valid, the key disclosure processing unit 25 does not transmit the cipher key to the key acquisition client terminal 3B after the key disclosure end time.

The key registration unit 24a stores the key owner ID in the key database 24b in addition to the cipher key, the key disclosure permission information, and the e-mail address. The key owner ID is stored to verify the key owner at key disclosure. The key owner ID is information for identifying the key owner in the user database 21b. For example, the user ID of the key owner in the user database 21b can be used as the key owner ID. Alternatively, the e-mail address of the key owner can be used as the key owner ID. This is because, by searching the user database 21b by using the e-mail address of the key owner, the key owner can be identified.

Next, a cipher key will be described. In a case of symmetric key encryption (common key encryption) such as the Advanced Encryption Standard (AES), a key for data encryption and a key for data decryption are identical. In contrast, in a case of public key encryption such as elliptic curve cryptography, a key for data encryption and a key for data decryption are different from each other. In public key encryption, a private key may be used for data encryption while a public key may be used for data decryption. However, the keys may be used inversely. Specifically, a public key may be used for data encryption while a private key may be used for data decryption.

To encrypt a huge volume of data by public key encryption, symmetric key encryption is interposed in general. For example, a symmetric key k is used to encrypt data (encryption target data) D to obtain encrypted data k[D]. The symmetric key k is further encrypted with a public key Kp to create Kp[k]. At this event, a private key Ks can be regarded as a cipher key for data decryption. Here, Ks is a private key paired with the public key Kp. This is because, when the encrypted data k[D] and the symmetric key Kp[k] are obtained, Kp[k] is decrypted with Ks to obtain k, and k[D] is decrypted with k to obtain D. In general, when n (n is a positive integer) cipher keys {ke1, ke2, . . . , ken} are used for data encryption to create encrypted data and the encrypted data is decrypted with N (N is a positive integer) cipher keys {kd1, kd2, . . . , kdN} to return to the original data, {ke1, ke2, . . . , ken} are referred to as cipher keys for data encryption while {kd1, kd2, . . . , kdN} are referred to as cipher keys for data decryption.

A generation source of a key will be described. A key of a symmetric-key encryption is generated by using a random number in general. For example, a 32-byte (=256-bit) random number can be used directly as an AES key. Alternatively, by generating a sufficiently large (for example, 1 kilobyte) random number and applying a one-way function such as Secure Hash Algorithm 256 (SHA-256) to this random number to obtain a 32-byte bit string, the bit string may be used as an AES key. This similarly applies to a case of an asymmetric-key encryption (public key encryption) key. For example, in elliptic curve cryptography, a large random number is generated and used as a private key. Then, a public key corresponding to this private key is computed in a predetermined method. Data being a source for generation of a cipher key is referred to as a generation source of the cipher key.

In the key sharing system 1, a cipher key for data encryption and the generation source of the cipher key for data encryption are considered the same. Similarly, a cipher key for data decryption and the generation source of the cipher key for data decryption are considered the same. A cipher key transmitted/received between the key sharing server 2 and a client terminal 3 may be the cipher key itself or may be the generation source of the cipher key (cipher key generation source information). When the key sharing server 2 receives the generation source of the cipher key instead of the cipher key for data decryption from the client terminal 3, what is stored as the cipher key for data decryption by the key sharing server 2 in the database may be the generation source or may be the cipher key generated on the basis of the generation source. The client terminal 3 generates the cipher key on the basis of the generation source and uses the cipher key for encryption/decryption of data.

The key disclosure permission information transmitted from the key registration client terminal 3A to the key registration processing unit 24 is information defining a disclosure target (key disclosure permissible range) of the cipher key transmitted together with the key disclosure permission information. The key disclosure permission information is “friend”, for example. This is information designating the relationship R between users in the user relationship holding processing unit 23. Alternatively, this may be designation of a group when a list of user groups as that illustrated in FIG. 10 is stored in the user relationship holding processing unit 23.

The key disclosure permission information may be an e-mail address of a corresponding user. A plurality of e-mail addresses can be designated. In this case, the key disclosure permission information is a list of the e-mail addresses. As the key disclosure permission information, both the relationship R between users in the user relationship holding processing unit 23 and the list of e-mail addresses can be designated. An example is also conceivable where the key registration processing unit 24 receives only the list of e-mail addresses as the key disclosure permission information. In this case, the first key sharing server 2A does not include the user relationship holding processing unit 23.

Note that the e-mail address included in the key disclosure permission information does not need to be an e-mail address of a user formally registered in the user registration processing unit 21. At the time of key registration, a key owner can designate an e-mail address of a user not formally registered yet, as a disclosure destination. The first key sharing server 2A discloses the key after the user is formally registered.

The key registration processing unit 24 transmits a key ID to the key registration client terminal 3A. The key ID is an ID for uniquely identifying the cipher key, the key disclosure permission information, the e-mail address of the key owner, or the key owner ID in the key database 24b. The key registration processing unit 24 may transmit the key owner ID in addition to the key ID to the key registration client terminal 3A. The key registration processing unit 24 may transmit the URL for key acquisition in addition to the key ID to the key registration client terminal 3A. The URL for key acquisition is the URL of the key acquisition destination. As will be described below, for key disclosure, the key acquisition client terminal 3B accesses the URL for key acquisition to acquire the key and transmits the key ID.

In the processing in the key registration processing unit 24, the key owner ID is an e-mail address. The URL for key acquisition is assumed to be held by the key registration unit 24a. The key owner is a user who transmits an identification token to the key registration processing unit 24. The formally registered user identified by the identification token in the user database 21b is the key owner. In the example, the e-mail address of the key owner is also used as a key owner ID.

In the processing in the key registration processing unit 24, the web server 21c receives the key disclosure period, and the key disclosure period may be either a key disclosure start time or a key disclosure end time. When the key disclosure start time is not designated, the key registration processing unit 24 assumes that the current time is the key disclosure start time. When the key disclosure end time is not designated, the key registration processing unit 24 assumes that the key disclosure end time is one week after the key disclosure start time, for example. When the key registration processing unit 24 defines the key disclosure start time or the key disclosure end time, it is assumed that appropriate setting is made so that a relationship key disclosure start time ≤key disclosure end time is established. Moreover, also when the key disclosure period is not received, the first key sharing server 2A may uniquely set the key disclosure period in some cases. For example, it is conceivable that one week after reception of a request for key registration is set as a tacit key disclosure end time.

With reference to FIG. 11A and FIG. 11B together, in the key registration processing unit 24, the following detailed processing steps are executed as an example.

[S1 (refer to FIG. 11B)] The web server 21c receives an identification token, a cipher key, key disclosure permission information, and a key disclosure period from the key registration client terminal 3A.
[S2] The web server 21c transmits the identification token, the cipher key, the key disclosure permission information, and the key disclosure period to the key registration unit 24a.
[S3] The key registration unit 24a transmits the identification token to the e-mail address management unit 21a.
[S4] The e-mail address management unit 21a verifies the identification token.
[S5] Whether the identification token is the identification token of a user formally registered in the user database 21b is judged. When it is [no](negative judgment), the procedure is terminated. When it is [yes](positive judgment), the processing advances to processing step S6.
[S6] The e-mail address management unit 21a acquires the e-mail address of the formally registered user (key owner) from the user database 21b.
[S7] The e-mail address management unit 21a transmits the e-mail address of the key owner to the key registration unit 24a.
[S8] The key registration unit 24a registers the cipher key, the key disclosure permission information, the key disclosure period, and the e-mail address of the key owner in the key database 24b.
[S9] The key database 24b generates an ID (key ID) for the registration information and returns the key ID to the key registration unit 24a.
[S10] The key registration unit 24a transmits the key ID, the e-mail address of the key owner, and the URL for key acquisition to the web server 21c.
[S11] The web server 21c transmits the key ID, the e-mail address of the key owner, and the URL for key acquisition to the key registration client terminal 3A.

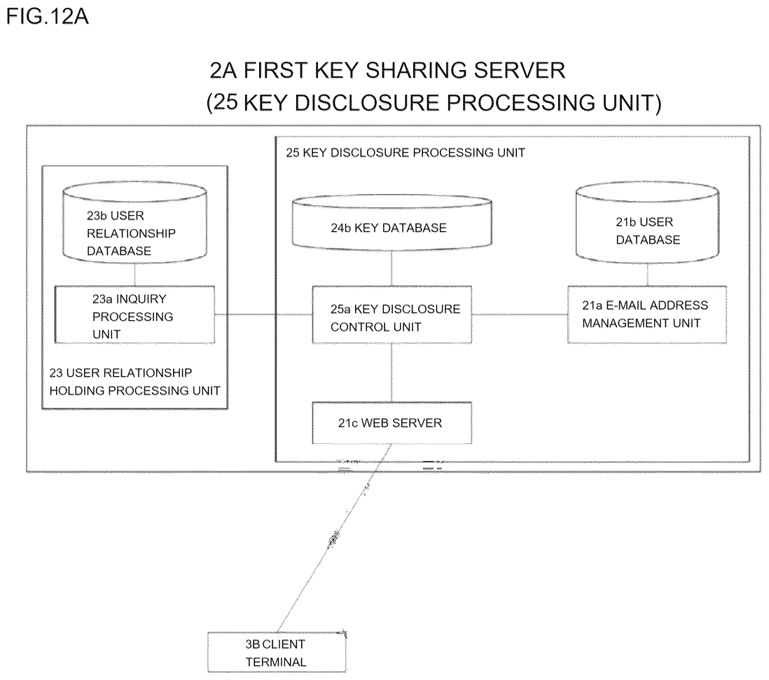

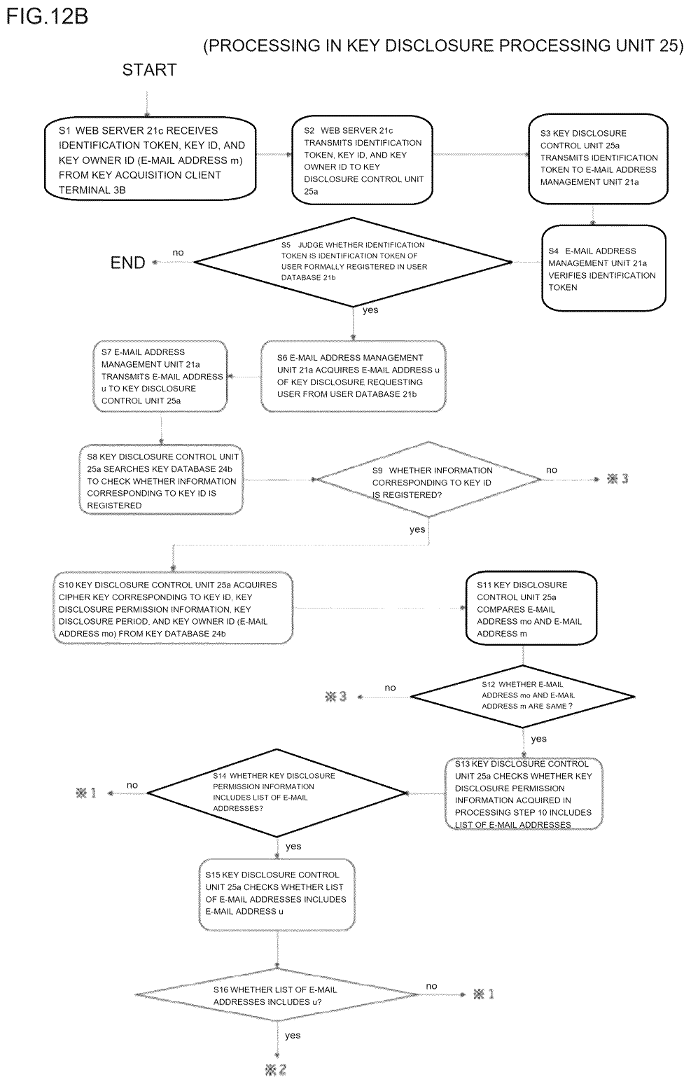

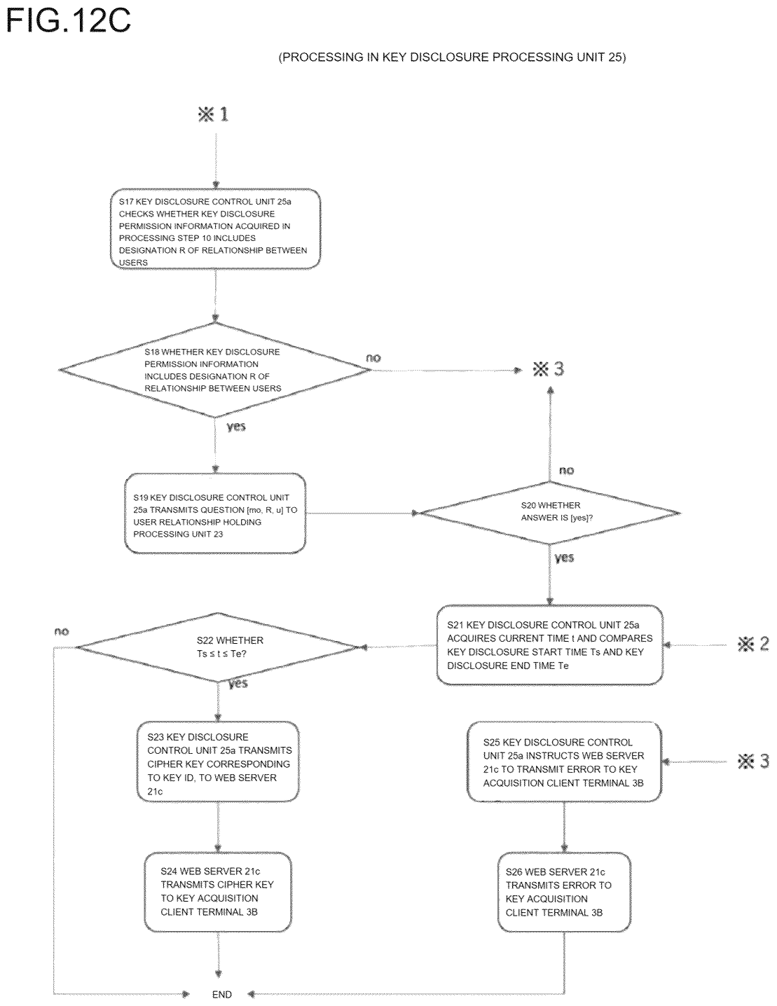

With reference to FIG. 12A, the key disclosure processing unit 25 in the first key sharing server 2A is configurable to include the e-mail address management unit 21a, the user database 21b, the web server 21c, a key disclosure control unit 25a, and the key database 24b, as detailed components. The e-mail address management unit 21a, the user database 21b, the web server 21c, and the key database 24b of the components are shared with other processing units.

In the processing in this key disclosure processing unit 25, the key disclosure control unit 25a receives an identification token, a key ID, and a key owner ID (e-mail address) from the key acquisition client terminal 3B via the web server 21c. A user requesting key disclosure (also referred to as a key disclosure requesting user) transmits the identification token, the key ID, and the key owner ID from the key acquisition client terminal 3B to the key disclosure processing unit 25. The key disclosure control unit 25a confirms that the key disclosure requesting user is a user formally registered in the user registration processing unit 21, by the identification token. The key disclosure control unit 25a acquires the e-mail address of the key disclosure requesting user.

The key disclosure control unit 25a identifies the key, the key disclosure permission information, the key disclosure period, and the key owner ID in the key database 24b by using the key ID. When information corresponding to the key ID is not registered in the key database 24b, the key disclosure control unit 25a terminates the processing and does not return the cipher key to the key acquisition client terminal 3B. For example, a case where the key owner deletes the key corresponds to this.

The key disclosure control unit 25a compares the identified key owner ID and the key owner ID received from the key acquisition client terminal 3B. When these key owner IDs are different from each other, the key disclosure processing unit 25 does not transmit the identified cipher key to the key acquisition client terminal 3B. In this way, it is possible to confirm that the user described in the encrypted data as the data creator (key owner) is certainly the creator of the encrypted data (key owner). If the key owner ID of the encrypted data is forgery, the key disclosure processing unit 25 does not return the cipher key for data decryption to the key acquisition client terminal 3B, and hence encrypted data cannot be decrypted. An example of not performing this confirmation is also conceivable. In this case, the key acquisition client terminal 3B does not transmit the key owner ID to the key disclosure processing unit 25, and the key disclosure processing unit 25 skips the confirmation of the key owner ID.

The key disclosure control unit 25a checks the key disclosure permission information stored in the key database 24b and identified by the key ID. When the key disclosure permission information includes a list of e-mail addresses, the key disclosure control unit 25a checks whether the e-mail address of the key disclosure requesting user is included in the list of e-mail addresses. If the result of the confirmation indicates no, the key disclosure control unit 25a checks whether the key disclosure permission information includes designation of a relationship between users. If the result of this confirmation indicates no, the key disclosure control unit 25a checks whether the key disclosure permission information includes designation of a group. If the result of this confirmation is also no, the key disclosure control unit 25a does not transmit the cipher key identified by the key ID, to the user requesting the key disclosure.

When the key disclosure permission information identified by the key ID in the key database 24b includes designation of a relationship between users, the key disclosure control unit 25a inquires the user relationship holding processing unit 23 of the relationship between users. Assume that the designation of the relationship between users is R. In the user relationship holding processing unit 23 in this example, the key owner is expressed by an e-mail address. Assume that the e-mail address of the key owner is mo. Also assume that the e-mail address of the key disclosure requesting user is u. The key disclosure processing unit 25 transmits a question [mo, R, u] to the user relationship holding processing unit 23. This corresponds to a question “whether u has a relationship of R with mo?” The user relationship holding processing unit 23 finds an answer to the question in the above-described manner and returns the answer to the key disclosure processing unit 25. When the answer obtained from the user relationship holding processing unit 23 is [no], the key disclosure processing unit 25 does not transmit the cipher key identified by the key ID to the user requesting the key disclosure.

When the relationship R between users is designation of a user group, the key disclosure processing unit 25 inquires of the user relationship holding processing unit 23 whether the key disclosure requesting user belongs to the group to which the disclosure is permitted (allowed). Here, assume that the designation of a user group is R={G1, . . . , GN}. Note that G1 to GN denote group names. Assume that the e-mail address of the key owner is mo. Also assume that the e-mail address of the key disclosure requesting user is u. The key disclosure processing unit 25 transmits a question [mo, R, u] to the user relationship holding processing unit 23. This corresponds to a question “whether u and mo belong to the same one of groups of R?” The user relationship holding processing unit 23 finds an answer to the question in the above-described manner and returns the answer to the key disclosure processing unit 25. When the answer obtained from the user relationship holding processing unit 23 is [no], the key disclosure processing unit 25 does not transmit the cipher key identified by the key ID to the user requesting the key disclosure.

A further description will be given. The e-mail address m that the web server 21c in the key disclosure processing unit 25 receives from the key acquisition client terminal 3B is the key owner ID. The key acquisition client terminal 3B reads the key owner ID accompanying the encrypted data, for example, and transmits the key owner ID to the key disclosure processing unit 25.

The key disclosure control unit 25a checks whether the key owner ID (e-mail address m) transmitted from the key acquisition client terminal 3B matches the ID (e-mail address mo) of the owner of the key. When the key owner ID does not match the ID of the owner of the key, the key disclosure control unit 25a transmits error information without transmitting the cipher key to the key acquisition client terminal 3B via the web server 21c.

The key disclosure control unit 25a compares a key disclosure start time Ts and a key disclosure end time Te set for the key, with a current time t, to judge whether the key disclosure is possible. As the current time, a system time of the first key sharing server 2A is acquired and used.

With reference to FIG. 12A, FIG. 12B, and FIG. 12C together, in the key disclosure processing unit 25, the following detailed processing steps are executed as an example.

[S1 (refer to FIG. 12B)] The web server 21c receives an identification token, a key ID, and a key owner ID (e-mail address m) from the key acquisition client terminal 3B.
[S2] The web server 21c transmits the identification token, the key ID, and the key owner ID to the key disclosure control unit 25a.
[S3] The key disclosure control unit 25a transmits the identification token to the e-mail address management unit 21a.
[S4] The e-mail address management unit 21a verifies the identification token.
[S5] Whether the identification token is the identification token of a user formally registered in the user database 21b is judged. When it is [no], the procedure is terminated. When it is [yes](positive judgment), the processing advances to processing step S6.
[S6] The e-mail address management unit 21a acquires the e-mail address u of a key disclosure requesting user from the user database 21b.
[S7] The e-mail address management unit 21a transmits the e-mail address u to the key disclosure control unit 25a.
[S8] The key disclosure control unit 25a checks whether information corresponding to the key ID is registered in the key database 24b.
[S9] When information corresponding to the key ID is not registered ([no]), the processing advances to the processing step S25. When information corresponding to the key ID is registered ([yes]), the processing advances to processing step S10.
[S10] The key disclosure control unit 25a acquires a cipher key, key disclosure permission information, a key disclosure period, and a key owner ID (e-mail address mo) corresponding to the key ID, from the key database 24b.
[S11] The key disclosure control unit 25a compares the e-mail address mo and the e-mail address m.
[S12] When the result of the judgment is [no], the processing advances to processing step S25. When the result of the judgment is [yes], the processing advances to processing step S13.
[S13] The key disclosure control unit 25a checks whether the key disclosure permission information acquired in processing step 10 includes a list of e-mail addresses.
[S14] When the result of the judgment is [no], the processing advances to processing step S17. When the result of the judgment is [yes], the processing advances to processing step S15.
[S15] The key disclosure control unit 25a checks whether the list of e-mail addresses includes the e-mail address u.
[S16] When the result of the judgment is [no], the processing advances to processing step S17. When the result of the judgment is [yes], the processing advances to processing step S21.
[S17 (refer to FIG. 12C)] The key disclosure control unit 25a checks whether the key disclosure permission information acquired in processing step 10 includes designation R of a relationship between users.
[S18] When the result of the judgment is [no], the processing advances to processing step S25. When the result of the judgment is [yes], the processing advances to processing step S19.
[S19] The key disclosure control unit 25a transmits a question [mo, R, u] to the user relationship holding processing unit 23.
[S20] When an answer is [no], the processing advances to processing step S25. When the answer is [yes], the processing advances to processing step S21.
[S21] The key disclosure control unit 25a acquires the current time t and compares the current time t with the key disclosure start time Ts and the key disclosure end time Te.
[S22] When the result of the judgment is [no], the processing is terminated. When the result of the judgment is [yes](t is equal to or later than Ts and equal to or earlier than Te), the processing advances to processing step S23.
[S23] The key disclosure control unit 25a transmits a cipher key corresponding to the key ID to the web server 21c.
[S24] The web server 21c transmits the cipher key to the key acquisition client terminal 3B.
[S25] The key disclosure control unit 25a indicates, to the web server 21c, that the web server 21c transmits an error to the key acquisition client terminal 3B.
[S26] The web server 21c transmits an error to the key acquisition client terminal 3B.

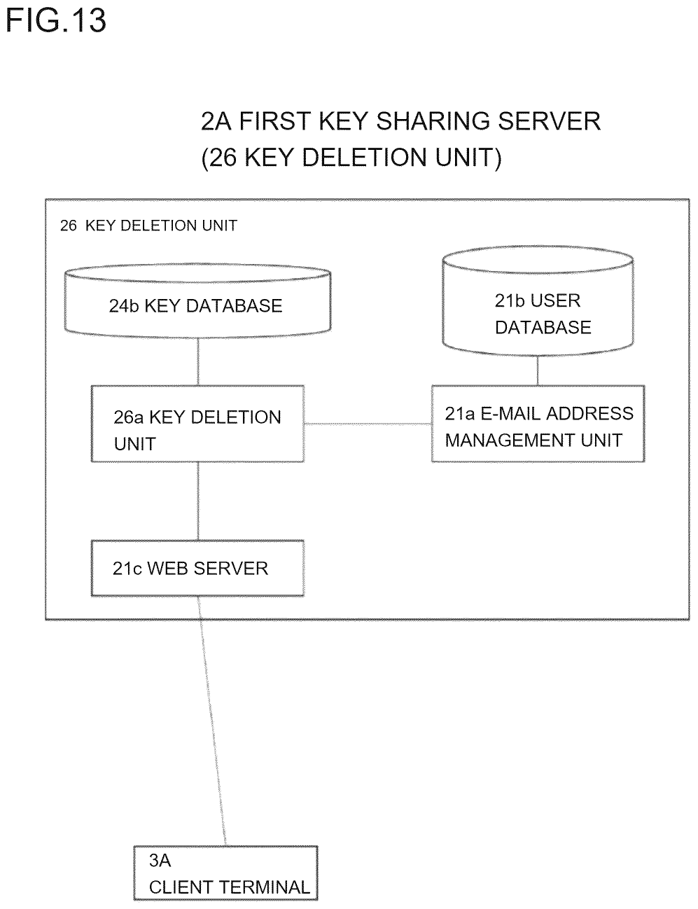

With reference to FIG. 13, the key deletion processing unit 26 in the first key sharing server 2A is configurable to include the e-mail address management unit 21a, the user database 21b, the web server 21c, a key deletion unit 26a, and the key database 24b, as detailed components. The e-mail address management unit 21a, the user database 21b, the web server 21c, and the key database 24b of the components are shared with other processing units.

Main points of processing in this key deletion processing unit 26 are as follows. Specifically, the key deletion unit 26a cooperates with the e-mail address management unit 21a, the user database 21b, the web server 21c, and the key database 24b to thereby acquire the e-mail address of a user requesting key deletion. The key deletion unit 26a acquires the e-mail address of the key owner of a cipher key targeted for the deletion. The key deletion unit 26a compares the above two e-mail addresses. Only when the e-mail addresses match, the key deletion unit 26a deletes the cipher key and related information corresponding to the key ID. In other words, a user who is not the key owner of the cipher key cannot delete the cipher key. Information that the key deletion unit 26a deletes from the key database 24b is the entire information corresponding to the key ID. Concretely, the key deletion unit 26a deletes all of the cipher key, the key disclosure permission information, the key disclosure period, the e-mail address of the key owner, and the like. As a result of the deletion, the cipher key and the like corresponding to the key ID do not exist in the key database 24b.

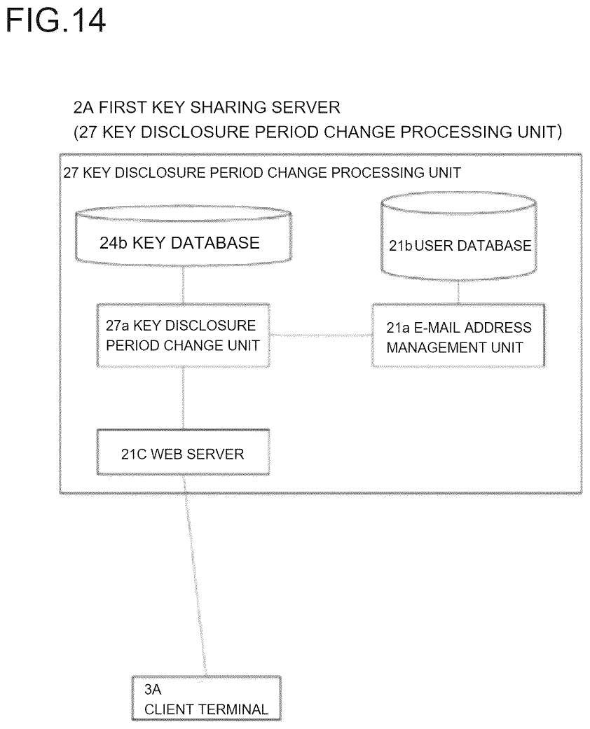

With reference to FIG. 14, the key disclosure period change processing unit 27 in the first key sharing server 2A is configurable to include the e-mail address management unit 21a, the user database 21b, the web server 21c, a key disclosure period change unit 27a, and the key database 24b, as detailed components. The e-mail address management unit 21a, the user database 21b, the web server 21c, and the key database 24b of the components are shared with other processing units.

Main points of processing in this key disclosure period change processing unit 27 are as follows. Specifically, the key disclosure period change unit 27a cooperates with the e-mail address management unit 21a, the user database 21b, the web server 21c, and the key database 24b to thereby acquire the e-mail address of a user requesting change of the key disclosure period. The key disclosure period change unit 27a acquires the e-mail address of the key owner of a cipher key targeted for the key disclosure period change. The key disclosure period change unit 27a compares the above two e-mail addresses. Only when the e-mail addresses match, the key disclosure period change unit 27a updates the key disclosure period corresponding to the key ID. In other words, a user who is not the key owner of the cipher key cannot change the key disclosure period of the cipher key.

### {Details of Second Key Sharing Server}

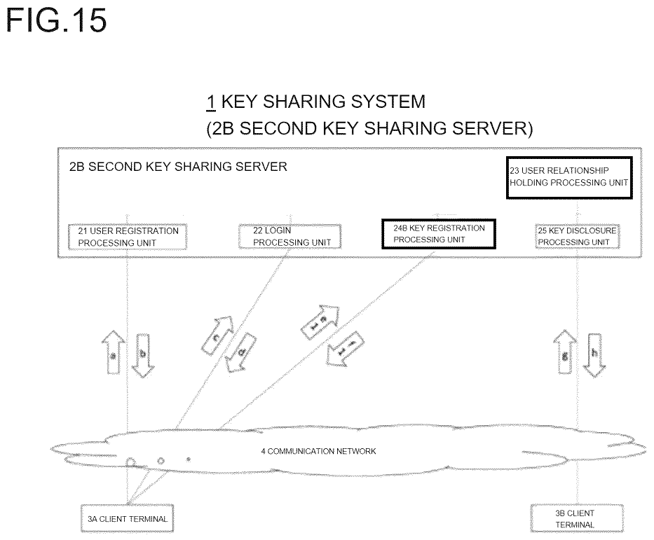

Details of the second key sharing server 2B in the key sharing system 1 will be described with reference to FIG. 1C, FIG. 15, and related drawings together.

With reference to FIG. 15, the second key sharing server 2B includes the user registration processing unit 21, the login processing unit 22, the user relationship holding processing unit 23, a key registration processing unit 24B, and the key disclosure processing unit 25 as functional components. The user registration processing unit 21, the login processing unit 22, the user relationship holding processing unit 23, and the key disclosure processing unit 25 have similar functions to those of the first key sharing server 2A.

Here, the basic feature elements of the second key sharing server 2B are the user registration processing unit 21 (corresponding to the identification token issue unit 104 in FIG. 1A), the key registration processing unit 24B (corresponding to the key registration unit 107 in FIG. 1A), and the key disclosure processing unit 25 (corresponding to the key disclosure unit 110 in FIG. 1A).

In other words, the second key sharing server 2B is a key sharing server applicable to the key sharing system 1 including the key registration client terminal 3A (corresponding to the first client terminal 102 in FIG. 1A) used by the first user and the key acquisition client terminal 3B (corresponding to the second client terminal 103 in FIG. 1A) used by the second user and includes the user registration processing unit 21 (first processing unit) configured to issue an identification token (proof) indicating that a corresponding user is an authenticated user.

The second key sharing server 2B includes the key registration processing unit (second processing unit) 24B configured to receive an identification token issued by the user registration processing unit 21 and corresponding to the first user and key disclosure permission information designating a key disclosure permissible range, from the first client terminal 3A, generate a cipher key for data encryption and a cipher key for data decryption, store the cipher key for data decryption and the key disclosure permission information in a database, and transmit, only when the identification token is confirmed to be a correct identification token (identification token corresponding to the first user) through verification, key identification information (key ID) for identifying the stored cipher key for data decryption and key disclosure permission information in the database and the cipher key for data decryption, to the first client terminal 3A.

Further, the second key sharing server 2B includes the key disclosure processing unit 25 (the third processing unit) configured to receive, from the second client terminal 3B, an identification token issued by the user registration processing unit 21 and corresponding to the second user and the key ID acquired by reading the data output by the first client terminal 3A and transmitted from the key registration processing unit 24B, acquire information of the second user identified by the identification token corresponding to the second user, acquire, from the database, the cipher key for data decryption and the key disclosure permission information identified by the key ID received from the second client terminal 3B, and transmit, only when it is confirmed that the second user is included in the key disclosure permissible range designated by the key disclosure permission information acquired from the database, the cipher key for data decryption identified by the key ID to the second client terminal 3B.

Next, further details of the second key sharing server 2B in the key sharing system 1 will be described with reference to FIG. 1C, FIG. 15, and related drawings together.

With reference to FIG. 15, the user registration processing unit 21, the login processing unit 22, the user relationship holding processing unit 23, the key registration processing unit 24B, and the key disclosure processing unit 25 configuring the second key sharing server 2B share part of the detailed components as described above.

As illustrated in FIG. 15, the second key sharing server 2B transmits/receives the following various data a to d, e1, f1, g, and h to/from the key registration client terminal 3A and the key acquisition client terminal 3B. * indicates optional data and is not used in some examples.
[Data a] at temporary registration: e-mail address, password; at formal registration: token for registration, e-mail address, password
[Data b] at temporary registration: token for registration, URL for registration; at formal registration: identification token
[Data c]e-mail address, password
[Data d] identification token
[Data e1] identification token, key disclosure permission information, *key disclosure period
[Data f1] key ID, cipher key (for data encryption), *key owner ID, *URL for key acquisition
[Data g] identification token, key ID, *key owner ID
[Data h] cipher key (for data decryption)

Here, a user to encrypt data (encryption target data) (corresponding to the data 139 in FIG. 1A) and register a cipher key uses the key registration processing unit 24B, and a user to request disclosure of the cipher key to decrypt the data (encrypted data) uses the key disclosure processing unit 25. These users may be the same user but are separate in general, and hence the key registration client terminal 3A and the key acquisition client terminal 3B are illustrated.

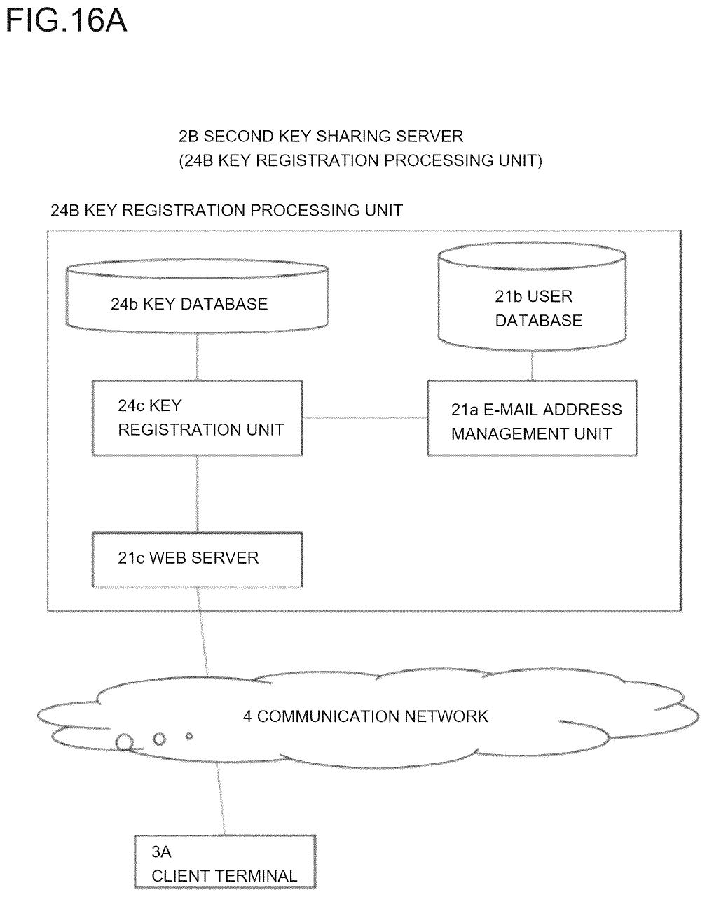

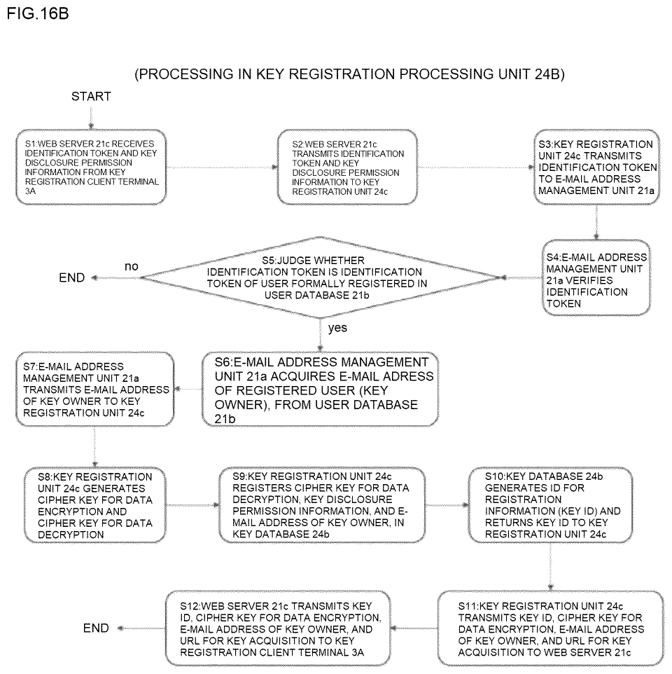

With reference to FIG. 16A, the key registration processing unit 24B in the second key sharing server 2B is configurable to include the e-mail address management unit 21a, the user database 21b, the web server 21c, a key registration unit 24c, and a key database 24b, as detailed components. The e-mail address management unit 21a, the user database 21b, and the web server 21c of the components are shared with other processing units.

As described above, the key registration processing unit 24 in the first key sharing server 2A registers a cipher key for data decryption transmitted from the key registration client terminal 3A used by a user, in the key database 24b (corresponding to the database 121 in FIG. 1A) and returns a key ID. However, the key registration processing unit 24B in the second key sharing server 2B generates a cipher key for data encryption and a cipher key for data decryption by itself, registers the cipher key for data decryption in the key database 24b, and returns the cipher key for data encryption and the key ID of this cipher key in the key database 24b.

In the case of symmetric key encryption, a cipher key for data encryption and a cipher key for data decryption match. However, in the case of public key encryption (asymmetric key encryption), these cipher keys are different from each other. In the case of public key encryption, the key registration processing unit 24B generates a pair of a cipher key for data encryption and a cipher key for data decryption, transmits the cipher key for data encryption to the key registration client terminal 3A, and registers the cipher key for data decryption in the key database 24b.

The key registration unit 24c acquires an e-mail address of a user identified by an identification token. Since the user is a key registrant, the e-mail address is, in other words, the e-mail address of the key owner. In this example, the e-mail address is also used as a key owner ID. In this example, a URL for key acquisition is held by the key registration unit 24c in advance. An example that the URL for key acquisition is not returned to the key registration client terminal 3A is also conceivable.

With reference to FIG. 16A and FIG. 16B together, in the key registration processing unit 24B, the following detailed processing steps are executed as an example.

[S1 (refer to FIG. 16B)] The web server 21c receives an identification token and key disclosure permission information from the key registration client terminal 3A.
[S2] The web server 21c transmits the identification token and the key disclosure permission information to the key registration unit 24c.
[S3] The key registration unit 24c transmits the identification token to the e-mail address management unit 21a.
[S4] The e-mail address management unit 21a verifies the identification token.
[S5] Whether the identification token is the identification token of a user formally registered in the user database 21b is judged. When it is [no], the procedure is terminated. When it is [yes], the processing advances to processing step S6.
[S6] The e-mail address management unit 21a acquires the e-mail address of the formally registered user (key owner) from the user database 21b.
[S7] The e-mail address management unit 21a transmits the e-mail address of the key owner to the key registration unit 24c.
[S8] The key registration unit 24c generates a cipher key for data encryption and a cipher key for data decryption.
[S9] The key registration unit 24c registers the cipher key for data decryption, key disclosure permission information, and the address of the key owner in the key database 24b.
[S10] The key database 24b generates an ID (key ID) for the registration information and returns the key ID to the key registration unit 24c.
[S11] The key registration unit 24c transmits the key ID, the cipher key for data encryption, the e-mail address of the key owner, and the URL for key acquisition to the web server 21c.
[S12] The web server 21c transmits the key ID, the cipher key for data encryption, the e-mail address of the key owner, and the URL for key acquisition to the key registration client terminal 3A.

### {Details of Third Key Sharing Server}

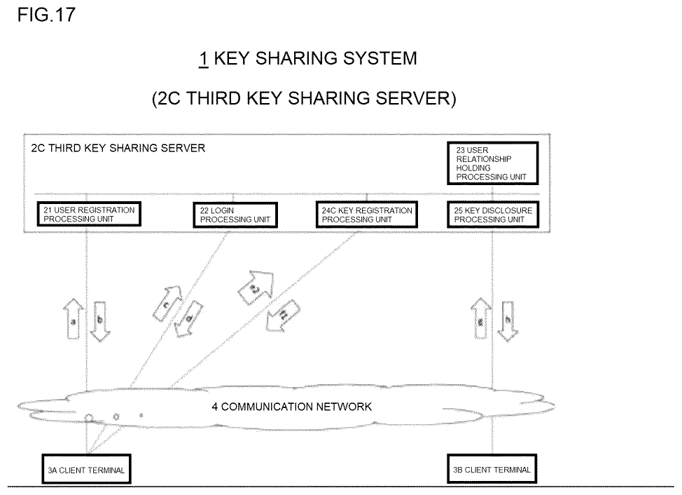

Details of the third key sharing server 2C in the key sharing system 1 will be described with reference to FIG. 1C, FIG. 17, and related drawings together.

With reference to FIG. 17, the third key sharing server 2C includes the user registration processing unit 21, the login processing unit 22, the user relationship holding processing unit 23, a key registration processing unit 24C, and the key disclosure processing unit 25 as functional components. The user registration processing unit 21, the login processing unit 22, the user relationship holding processing unit 23, and the key disclosure processing unit 25 have similar functions to those of the first key sharing server 2A.

Here, the basic feature elements of the third key sharing server 2C are the user registration processing unit 21 (corresponding to the identification token issue unit 104 in FIG. 1A), the key registration processing unit 24C (corresponding to the key registration unit 107 in FIG. 1A), and the key disclosure processing unit 25 (corresponding to the key disclosure unit 110 in FIG. 1A).

In other words, the third key sharing server 2C is a key sharing server applicable to the key sharing system 1 including the key registration client terminal 3A (corresponding to the first client terminal 102 in FIG. 1A) used by the first user and the key acquisition client terminal 3B (corresponding to the second client terminal 103 in FIG. 1A) used by the second user and includes the user registration processing unit 21 (first processing unit) configured to issue an identification token (proof) indicating that a corresponding user is an authenticated user.

The third key sharing server 2C includes the key registration processing unit (second processing unit) 24C configured to receive an identification token issued by the user registration processing unit 21 and corresponding to the first user, key disclosure permission information designating a key disclosure permissible range of a cipher key, and a password from the first client terminal 3A, generate a cipher key for data encryption and a cipher key for data decryption, generate a cipher key (password key) for cipher key wrapping (encryption) on the basis of the received password, wrap (encrypt) the cipher key for data decryption with the password key, store the wrapped cipher key for data decryption and the key disclosure permission information in a database, and transmit, only when the identification token is confirmed to be a correct identification token (identification token corresponding to the first user) through verification, key identification information (key ID) for identifying the stored cipher key for data decryption and key disclosure permission information in the database and the cipher key for data decryption, to the first client terminal 3A.

Further, the second key sharing server 2C includes the key disclosure processing unit 25 (third processing unit) configured to receive, from the second client terminal 3B, an identification token issued by the user registration processing unit 21 and corresponding to the second user and the key ID acquired by reading the data output by the first client terminal 3A and transmitted from the key registration processing unit 24C, acquire information of the second user identified by the identification token corresponding to the second user, acquire, from the database, the wrapped cipher key for data decryption and the key disclosure permission information identified by the key ID received from the second client terminal 3B, and transmit, only when it is confirmed that the second user is included in the key disclosure permissible range designated by the key disclosure permission information acquired from the database, the wrapped cipher key for data decryption identified by the key ID to the second client terminal 3B.

Next, further details of the third key sharing server 2C in the key sharing system 1 will be described with reference to FIG. 1C, FIG. 17, and related drawings together.

With reference to FIG. 17, the user registration processing unit 21, the login processing unit 22, the user relationship holding processing unit 23, the key registration processing unit 24B, and the key disclosure processing unit 25 configuring the third key sharing server 2C share part of the detailed components as described above.

As illustrated in FIG. 17, the third key sharing server 2C transmits/receives the following various data a to d, e2, f1, g, and h to/from the key registration client terminal 3A and the key acquisition client terminal 3B. * indicates optional data and is not used in some examples.
[Data a] at temporary registration: e-mail address, password; at formal registration: token for registration, e-mail address, password
[Data b] at temporary registration: token for registration, URL for registration; at formal registration: identification token
[Data c]e-mail address, password
[Data d] identification token
[Data e2] identification token, key disclosure permission information, password
[Data f1] key ID, cipher key (for data encryption), *key owner ID, *URL for key acquisition
[Data g] identification token, key ID, *key owner ID
[Data h] cipher key (for data decryption)

Here, a user to encrypt data (encryption target data) (corresponding to the data 139 in FIG. 1A) and register a cipher key uses the key registration processing unit 24C, and a user to request disclosure of the cipher key to decrypt the data (encrypted data) uses the key disclosure processing unit 25. These users may be the same user but are separate in general, and hence the key registration client terminal 3A and the key acquisition client terminal 3B are illustrated.

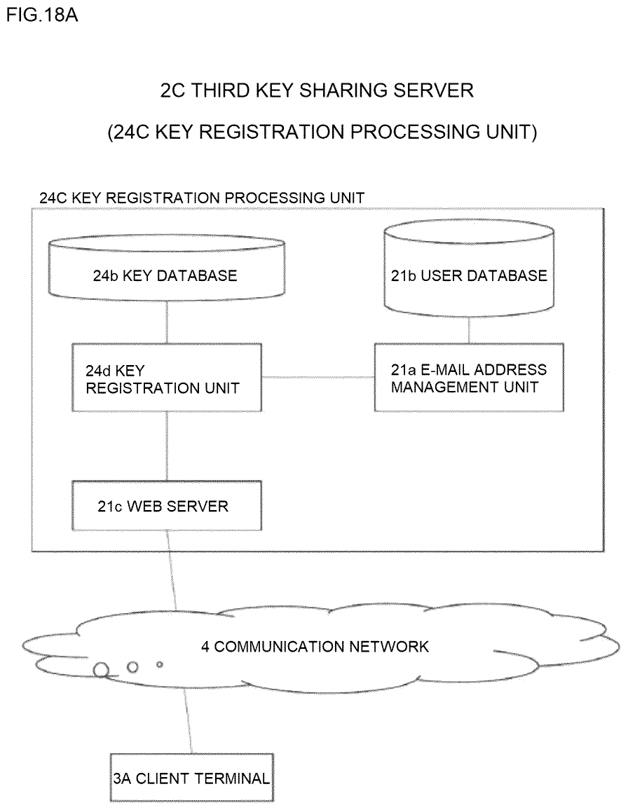

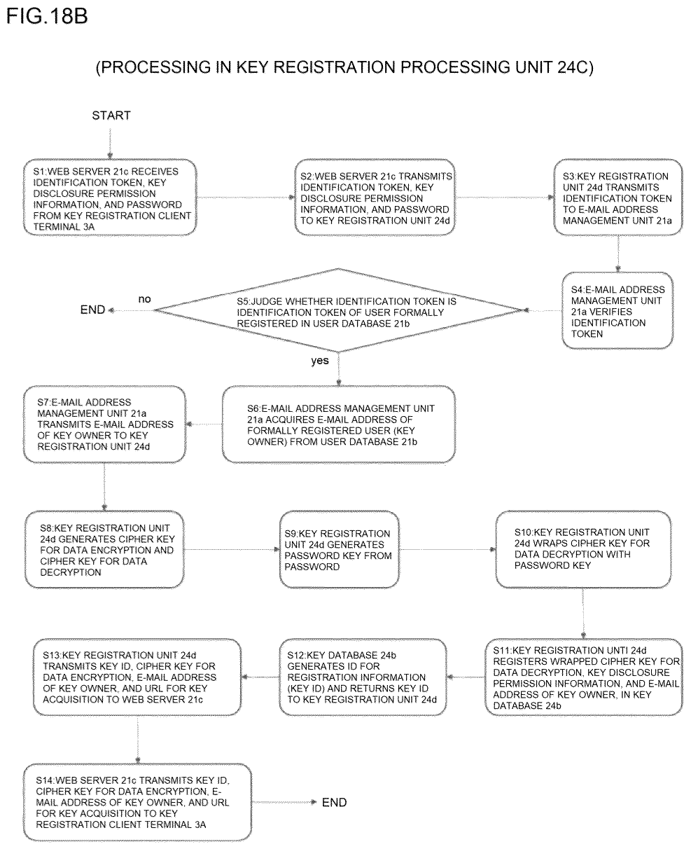

Note that the processing in the key disclosure processing unit 25 of the third key sharing server 2C is similar to those of the key disclosure processing unit 25 in the first key sharing server 2A and the second key sharing server 2B, but a cipher key for data decryption registered in the key database 24b illustrated in FIG. 18A is a cipher key for data decryption wrapped with a password key. Hence, the cipher key for data decryption transmitted to the key acquisition client terminal 3B in the data h above is a cipher key wrapped with the password key.

With reference to FIG. 18A, the key registration processing unit 24C in the third key sharing server 2C is configurable to include the e-mail address management unit 21a, the user database 21b, the web server 21c, a key registration unit 24d, and the key database 24b, as detailed components. The e-mail address management unit 21a, the user database 21b, and the web server 21c of the components are shared with other processing units.

As described above, the key registration processing unit 24 in the first key sharing server 2A registers a cipher key for data decryption transmitted from the key registration client terminal 3A used by a user, in the key database 24b (corresponding to the database 121 in FIG. 1A) and returns a key ID. However, the key registration processing unit 24C in the third key sharing server 2C generates a cipher key for data encryption and a cipher key for data decryption by itself, registers a wrapped cipher key for data decryption in the key database 24b (as will be described below), and returns the cipher key for data encryption and the key ID of the cipher key for data encryption in the key database 24b to the key registration client terminal 3A.

The key registration unit 24d in this key registration processing unit 24C receives a password (corresponding to the password 133 in FIG. 1A) from the key registration client terminal 3A via the web server 21c. This password is a password that the user to register the cipher key and the user to acquire the cipher key additionally share. The key registration unit 24d creates a cipher key for cipher key wrapping, i.e., a password key, on the basis of the received password. Wrapping a cipher key means encrypting a cipher key with another cipher key for confidentiality.

The key registration unit 24d uses the password key to wrap (encrypt) the cipher key for data decryption and registers the wrapped cipher key for data decryption in the key database 24b. The key registration unit 24d returns a key ID for identifying the registered cipher key (wrapped cipher key for data decryption above) in the key database 24b, to the key registration client terminal 3A together with the cipher key for data encryption.

With reference to FIG. 18A and FIG. 18B together, in the key registration processing unit 24C, the following detailed processing steps are executed as an example.

[S1 (refer to FIG. 18B)] The web server 21c receives an identification token, key disclosure permission information, and a password from the key registration client terminal 3A.
[S2] The web server 21c transmits the identification token, the key disclosure permission information, and the password to the key registration unit 24d.
[S3] The key registration unit 24c transmits the identification token to the e-mail address management unit 21a.
[S4] The e-mail address management unit 21a verifies the identification token.
[S5] Whether the identification token is the identification token of a user formally registered in the user database 21b is judged. When it is [no], the procedure is terminated. When it is [yes], the processing advances to processing step S6.
[S6] The e-mail address management unit 21a acquires the e-mail address of the formally registered user (key owner) from the user database 21b.
[S7] The e-mail address management unit 21a transmits the e-mail address of the key owner to the key registration unit 24d.
[S8] The key registration unit 24d generates a cipher key for data encryption and a cipher key for data decryption.
[S9] The key registration unit 24d generates a password key from the password.
[S10] The key registration unit 24d wraps the cipher key for data decryption with the password key.
[S11] The key registration unit 24d registers the wrapped cipher key for data decryption, the key disclosure permission information, and the e-mail address of the key owner in the key database 24b.
[S12] The key database 24b generates an ID (key ID) for the registration information and returns the key ID to the key registration unit 24c.
[S13] The key registration unit 24d transmits the key ID, the cipher key for data encryption, the e-mail address of the key owner, and the URL for key acquisition to the web server 21c.
[S14] The web server 21c transmits the key ID, the cipher key for data encryption, the e-mail address of the key owner, and the URL for key acquisition to the key registration client terminal 3A.

### {Details of First Key Registration Client Terminal}

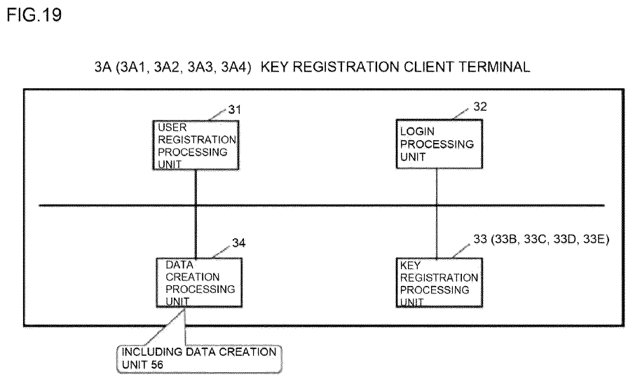

Details of the first key registration client terminal 3A1 in the key sharing system 1 will be described with reference to FIG. 1C, FIG. 19, and related drawings together.

With reference to FIG. 19, the key registration client terminal 3A as the first key registration client terminal 3A1, includes the user registration processing unit 31, the login processing unit 32, a key registration processing unit 33B, and the data creation processing unit 34 as functional components. Here, the data creation processing unit 34 includes a data creation unit 56 (this similarly applies to other embodiments (examples)).

The first key registration client terminal 3A1 further includes a key deletion processing unit 37, a key disclosure period change processing unit 38, a key disclosure permission information change processing unit 39, or the like according to each embodiment (example).

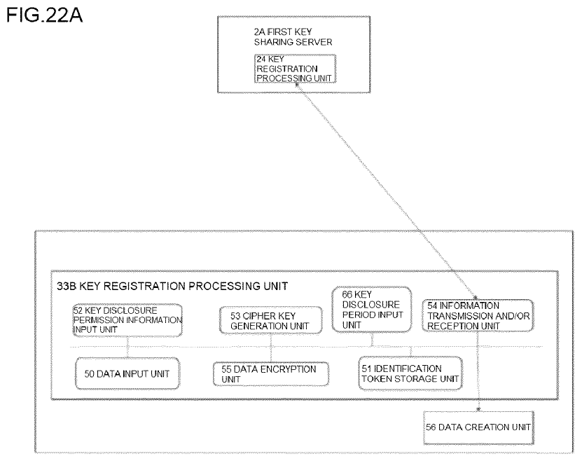

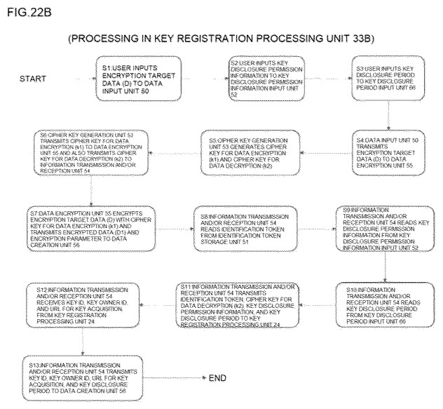

The basic feature elements of the first key registration client terminal 3A1 include an identification token storage unit 51, a key disclosure permission information input unit 52, a cipher key generation unit 53, an information transmission and/or reception unit 54 (network 104 access unit), a data encryption unit 55, and a data creation unit 56 (refer to FIG. 22A).

In other words, the first key registration client terminal 3A1 is a client terminal having a key registration function applicable to the key sharing system 1 including a server and includes the identification token storage unit 51 configured to store an identification token (proof) indicating that a corresponding user is an authenticated user and the key disclosure permission information input unit 52 configured to receive an input of key disclosure permission information designating the disclosure permissible range of a corresponding cipher key.

The first key registration client terminal 3A1 includes the cipher key generation unit 53 configured to generate a cipher key for data encryption and a cipher key for data decryption and the information transmission and/or reception unit (network access unit) 54 configured to transmit the identification token stored in the identification token storage unit 51, the cipher key for data decryption generated by the cipher key generation unit 53, and the key disclosure permission information 134 input to the key disclosure permission information input unit 52, to the key sharing server 2 (2A) as transmission information, and receive key identification information (key ID) corresponding to the transmission information from the key sharing server 2 (2A).

The first key registration client terminal 3A1 further includes the data encryption unit 55 configured to use, in response to an input of encryption target data, the cipher key for data encryption generated by the cipher key generation unit 53 to encrypt the encryption target data, and output encrypted data encrypted, and the data creation unit 56 configured to output, in response to an input of the key ID received by the information transmission and/or reception unit 54 from the key sharing server 2 (2A) and the encrypted data output by the data encryption unit 55, data including the key ID and the encrypted data.

The first key registration client terminal 3A1 can adopt any of the following aspects. Note that [Aspect 12] to [Aspect 14] are also applicable to a second key registration client terminal 3A2, a third key registration client terminal 3A3, and a fourth key registration client terminal 3A4 to be described below.

[Aspect 11] The first key registration client terminal 3A1 further includes a password input unit 62 configured to receive an input of a password, a password key generation unit 63 configured to generate a password key (cipher key) on the basis of the password input to the password input unit 62, and a cipher key wrap unit 64 configured to encrypt the cipher key for data decryption generated by the cipher key generation unit 53, with the password key generated by the password key generation unit 63 and output the cipher key for data decryption wrapped (encrypted) with the password key.

The information transmission and/or reception unit 54 transmits the identification token stored by the identification token storage unit 51, the cipher key for data decryption encrypted with the password output by the cipher key wrap unit 64, and the key disclosure permission information input to the key disclosure permission information input unit 52, to the key sharing server 2 (2A) as transmission information, and receives the key ID corresponding to the transmission information from the key sharing server 2 (2A).

[Aspect 12] In the first key registration client terminal 3A1, the key disclosure permission information includes at least one of a relationship between users registered to the key sharing server 2 (2A) in advance, designation of a user group registered to the key sharing server 2 (2A) in advance, and a list of e-mail addresses. Regarding the list of e-mail addresses, the client terminal 3A1 may transmit the list of e-mail addresses as the key disclosure permission information.
[Aspect 13] The first key registration client terminal 3A1 further includes a key disclosure period input unit 66 configured to receive an input of a key disclosure start time or a key disclosure end time as a key disclosure period, from a user.

The information transmission and/or reception unit 54 transmits the key disclosure period input to the key disclosure period input unit 66, to the key sharing server 2(2A).

[Aspect 14] In the first key registration client terminal 3A1, the data creation unit 56 outputs data including at least one of an encryption parameter, a key owner ID, a URL for key acquisition, a key disclosure period, and a data creation time and date.

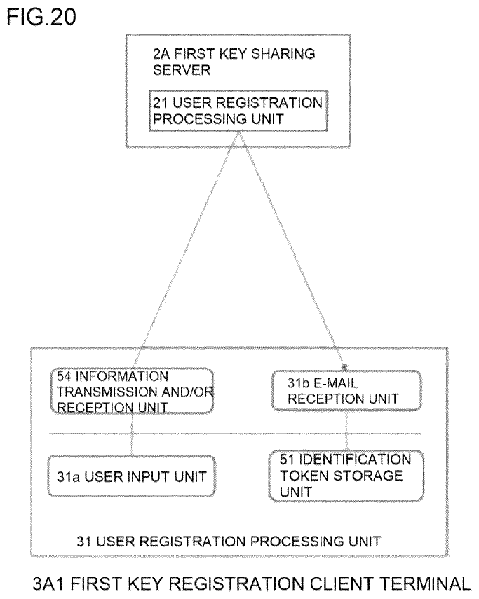

With reference to FIG. 20, the user registration processing unit 31 in the first key registration client terminal 3A1 is configurable to include a user input unit 31a, an e-mail reception unit 31b, the identification token storage unit 51, and the information transmission and/or reception unit (network access unit) 54 as detailed components. These components include those shared with other processing units.

The processing in this user registration processing unit 31 is considered to be similar to what is performed in general at the time of account registration in various Internet services such as Facebook and can be easily understood by those skilled in the art. Hence, only main points will be described here.

In the user registration processing unit 31, the user input unit 31a, the e-mail reception unit 31b, the identification token storage unit 51, and the information transmission and/or reception unit 54 cooperate to communicate with the user registration processing unit 21 in the first key sharing server 2A and temporarily register an e-mail address used by a user and a password. In the user registration processing unit 31, a registration token received with the e-mail address is used to formally register the e-mail address in the first key sharing server 2A. Consequently, in the user registration processing unit 31, the identification token generated by the user registration processing unit 21 in the first key sharing server 2A is received and stored in the identification token storage unit 51.

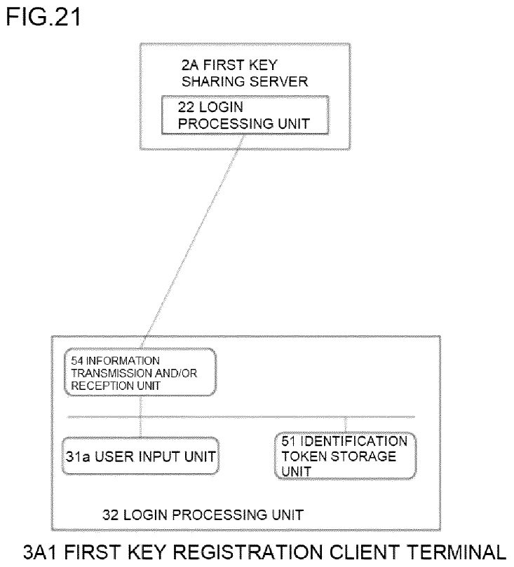

With reference to FIG. 21, the login processing unit 32 in the first key registration client terminal 3A1 is configurable to include the user input unit 31a, the identification token storage unit 51, and the information transmission and/or reception unit (network access unit) 54 as detailed components. These components are shared with the user registration processing unit 31.

The processing in this login processing unit 32 is considered to be similar to what is performed in general at login in various Internet services such as Facebook and can be easily understood by those skilled in the art. Hence, only main points will be described here.

In the login processing unit 32, the user input unit 31a, the identification token storage unit 51, and the information transmission and/or reception unit 54 cooperate to communicate with the login processing unit 22 in the first key sharing server 2A, receive the identification token of a formally registered user, and store the identification token in the identification token storage unit 51.

With reference to FIG. 22A, the key registration processing unit 33B in the first key registration client terminal 3A1 is configurable to include the data input unit 50, the identification token storage unit 51, the key disclosure permission information input unit 52, the cipher key generation unit 53, the information transmission and/or reception unit (network access unit) 54, the data encryption unit 55, and the key disclosure period input unit 66 as detailed components. This key registration processing unit 33B operates with the data creation unit 56 configuring the data creation processing unit 34 (refer to FIG. 19). The key registration processing unit 33B in the first key registration client terminal 3A1 communicates with the key registration processing unit 24 in the first key sharing server 2A.

In this key registration processing unit 33B, the data input unit 50, the identification token storage unit 51, the key disclosure permission information input unit 52, the cipher key generation unit 53, the information transmission and/or reception unit 54, the data encryption unit 55, and the key disclosure period input unit 66 cooperate to execute main points of the following processing. Specifically, the key disclosure permission information input by a user is, for example, designation of a relationship between users such as “family”. Alternatively, the key disclosure permission information is designation of a group held by the user relationship holding processing unit 23 of the key sharing server 2A. As the key disclosure permission information, a key disclosure target user can be designated by a list of e-mail addresses.

Encrypted data (D1) is a result obtained by encrypting encryption target data (D) with cipher key (k1) for data encryption. Note that, at the time of reading an identification token, user registration to the key sharing server 2A using the user registration processing unit 31 or login to the key sharing server 2A using the login processing unit 32 are assumed to be completed. As a result, a valid identification token transmitted from the key sharing server 2A is stored in the identification token storage unit 51.

In this example, a cipher key of asymmetric key encryption is assumed. The cipher key generation unit 53 generates a pair of a cipher key k1 for data encryption and a cipher key k2 for data decryption. k1 may correspond to a public key while k2 may correspond to a private key, or vice versa. The cipher key generation unit 53 transmits the cipher key k1 for data encryption to the data encryption unit 55 and the cipher key k2 for data decryption to the information transmission and/or reception unit 54. The cipher key k2 for data decryption is transmitted to the key registration processing unit 24 of the first key sharing server 2A. In a case of adopting symmetric key encryption, the cipher key k1 for data encryption and a cipher key k2 for data decryption are identical.

Examples of the encryption parameter are various parameters for encryption to be shared with the decryption side at the time of encryption. For example, nonce (random number) and an initial vector (IV) in Counter mode correspond to these. When the encryption parameter is shared with the decryption side in some method in advance, there is no need to explicitly notify the decryption side of the encryption parameter. Hence, the data encryption unit 55 does not transmit the encryption parameter with no need of notification, to the data creation unit 56. In this example, the key registration processing unit 33B transmits the following six kinds of data, i.e., a key ID, a key owner ID (e-mail address), a URL for key acquisition, a key disclosure period, encrypted data D1, and an encryption parameter to the data creation unit 56.

With reference to FIG. 22A and FIG. 22B together, in the key registration processing unit 33B, the following detailed processing steps are executed as an example.

[S1 (refer to FIG. 22B)]A user inputs encryption target data (D) to the data input unit 50.
[S2] The user inputs key disclosure permission information to the key disclosure permission information input unit 52.
[S3] The user inputs a key disclosure period to the key disclosure period input unit 66.
[S4] The data input unit 50 transmits the encryption target data (D) to the data encryption unit 55.
[S5] The cipher key generation unit 53 generates a cipher key for data encryption (k1) and a cipher key for data decryption (k2).
[S6] The cipher key generation unit 53 transmits the cipher key for data encryption (k1) to the data encryption unit 55 and the cipher key for data decryption (k2) to the information transmission and/or reception unit 54.
[S7] The data encryption unit 55 encrypts the encryption target data (D) with the cipher key for data encryption (k1) and transmits the encrypted data (D1) and an encryption parameter to the data creation unit 56. The encryption parameter here is nonce described in paragraph [0159], for example.
[S8] The information transmission and/or reception unit 54 reads an identification token from the identification token storage unit 51.
[S9] The information transmission and/or reception unit 54 reads key disclosure permission information from the key disclosure permission information input unit 52.
[S10] The information transmission and/or reception unit 54 reads a key disclosure period from the key disclosure period input unit 66.
[S11] The information transmission and/or reception unit 54 transmits the identification token, the cipher key for data decryption (k2), the key disclosure permission information, and the key disclosure period to the key registration processing unit 24.
[S12] The information transmission and/or reception unit 54 receives the key ID, the key owner ID, and the URL for key acquisition from the key registration processing unit 24.
[S13] The information transmission and/or reception unit 54 transmits the key ID, the key owner ID, the URL for key acquisition, and the key disclosure period to the data creation unit 56.

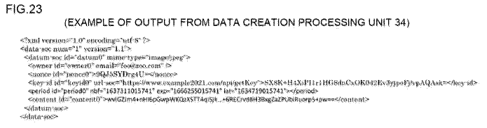

The data creation unit 56 configuring the data creation processing unit 34 operating with the key registration processing unit 33B receives the above six kinds of data (key ID, key owner ID (e-mail address), URL for key acquisition, key disclosure period, encrypted data D1, and encryption parameter) from the key registration processing unit 33B and format the data as illustrated in FIG. 23 to write the data into a file.

In the example illustrated in FIG. 23, the file is output in an xml format. The <data-soc> element is a parent element of the entire file. The attribute num of the element indicates that one piece of encrypted data is included in the element. The <datum-soc> element is an element including the encrypted data. The <datum-soc> element includes five child elements: <owner>, <nonce>, <key-id>, <period>, and <content>. In <owner>, the key owner ID is described. In this example, it is described in the e-mail attribute of the <owner> element that an e-mail address “foo@zoo.com” is the key owner ID.

<nonce> is a random number being one of encryption parameters. Here, the value of the random number is encoded in base64 and described. In <key-id>, the key ID received by the information transmission and/or reception unit 54 of the key registration processing unit 33B from the key registration processing unit 24 of the first key sharing server 2A is described. In the example in FIG. 23, the value of the key ID encoded in base64 is described as an internal text in the <key-id> element. In the url-soc attribute of the <key-id> element, a URL for key acquisition “https://www.example 2021.com/api/getKey” is described.

In the <period> element, a key disclosure period is described. The nbf attribute and the exp attribute of the <period> element are in Universal Coordinated Time (UTC) in milliseconds and indicate a key disclosure start time and a key disclosure end time, respectively. Note that nbf stands for “not before”, and exp stands for “expiration”. The iat attribute of the <period> element indicates a data creation time and is expressed in UTC in milliseconds similarly to nbf and exp. The value of the iat attribute indicates the current time acquired by the data creation unit 56. Note that iat stands for “issued at”.

The internal text of the <key> element is the wrapped cipher key for data decryption encoded in base64. This wrapped cipher key for data decryption is what is received by the data creation unit 56 from the cipher key wrap unit 64 in paragraph [0163][S13].

The internal text of the <content> element is the encrypted data D1 encoded in base 64. Data in a format including a key ID, a key owner ID, a URL for key acquisition, a key disclosure period, encrypted data D1, and an encryption parameter as that illustrated in FIG. 23 is sometimes described as encrypted data below. However, this encrypted data does not necessarily include a key owner ID, a URL for key acquisition, and an encryption parameter.

The data output by the data creation unit 56 is not necessarily limited to a file. For example, xml data as in FIG. 23 or html data may be posted to a message board or a personal blog on the Internet. Alternatively, data may be made public using a cloud storage. The above-described encrypted data is available to anyone, but who can decrypt the encrypted data is only a registered user who can obtain a corresponding decryption key (cipher key for data decryption) from the first key sharing server 2A. The registered user is, for example, a user with an e-mail address designated in key disclosure permission information by the user who has registered the key. Alternatively, the registered user is a user registered by the user who has registered the key, as “good friend” in the user relationship holding processing unit 23. (This corresponds to a case where the key disclosure permission information indicates “good friend”,)

### {Details of Second Key Registration Client Terminal}

Details of the second key registration client terminal 3A2 in the key sharing system 1 will be described with reference to FIG. 1C, FIG. 19, and related drawings together.

With reference to FIG. 19, the key registration client terminal 3A as the second key registration client terminal 3A2, includes the user registration processing unit 31, the login processing unit 32, a key registration processing unit 33C, and the data creation processing unit 34 as functional components.

The second key registration client terminal 3A2 further includes the key deletion processing unit 37, the key disclosure period change processing unit 38, the key disclosure permission information change processing unit 39, or the like according to each embodiment (example).

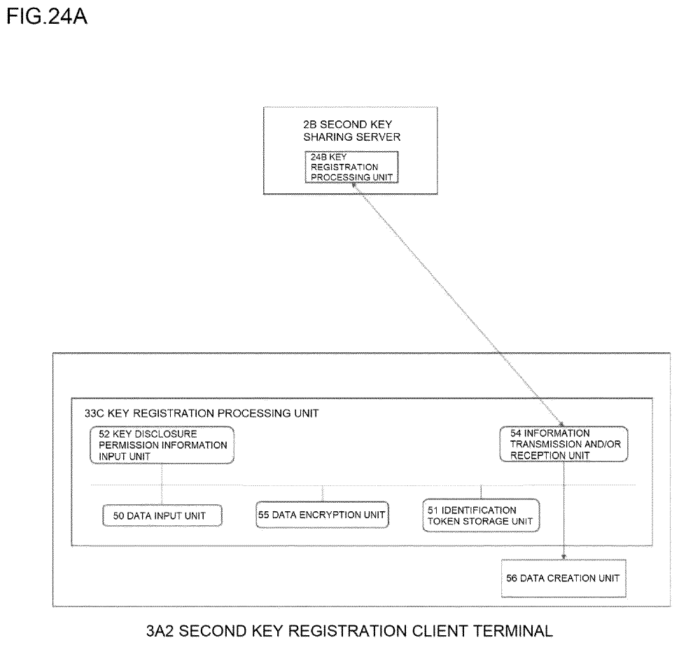

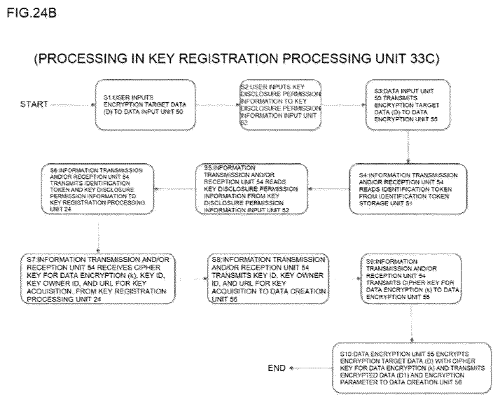

The basic feature elements of the second key registration client terminal 3A2 include the identification token storage unit 51, the key disclosure permission information input unit 52, the information transmission and/or reception unit (network access unit) 54, the data encryption unit 55, and the data creation unit 56 (refer to FIG. 24A).

The second key registration client terminal 3A2 does not include the cipher key generation unit 53 in the first key registration client terminal 3A1.

In other words, the second key registration client terminal 3A2 is a client terminal having a key registration function applicable to the key sharing system 1 including a server and includes the identification token storage unit 51 configured to store an identification token (proof) indicating that a corresponding user is an authenticated user and the key disclosure permission information input unit 52 configured to receive an input of key disclosure permission information designating a key disclosure permissible range.

The second key registration client terminal 3A2 includes the information transmission and/or reception unit (network access unit) 54 configured to transmit the identification token stored in the identification token storage unit 51 and the key disclosure permission information input to the key disclosure permission information input unit 52 to the key sharing server 2 (2B) as transmission information and receive a cipher key for data encryption corresponding to the transmission information and the key identification information (key ID) of the cipher key from the key sharing server 2.

The second key registration client terminal 3A2 further includes the data encryption unit 55 (corresponding to the data encryption unit 114 in FIG. 1A) configured to use, in response to an input of encryption target data, the cipher key for data encryption received by the information transmission and/or reception unit from the key sharing server 2 (2B) to encrypt the encryption target data, and output encrypted data encrypted, and the data creation unit 56 (corresponding to the data creation unit 115 in FIG. 1A) configured to output, in response to an input of the key ID received by the information transmission and/or reception unit 54 from the key sharing server 2 (2B) and the encrypted data output by the data encryption unit 55, data including the key ID and the encrypted data.

The second key registration client terminal 3A2 can adopt any of the following aspects.

[Aspect 21] The second key registration client terminal 3A2 further includes the password input unit 62 configured to receive an input of a password,
the information transmission and/or reception unit 54 transmits the identification token stored in the identification token storage unit 51, the key disclosure permission information input to the key disclosure permission information input unit 52, and the password input to the password input unit 62, to the key sharing server 2 (2B) as transmission information, and receives the cipher key for data encryption corresponding to the transmission information and the key ID of the cipher key from the key sharing server 2 (2B).

[Aspect 22] The second key registration client terminal 3A2 further includes
the password input unit 62 configured to receive an input of a password,
the password key generation unit 63 configured to generate a password key (cipher key) on the basis of the input password, and
the cipher key wrap unit 64 configured to encrypt the input cipher key for data encryption with the password key generated by the password key generation unit 63 and output the cipher key for data decryption wrapped (encrypted) with the password key, and
the information transmission and/or reception unit 54 transmits the identification token 132 stored by the identification token storage unit 51 and the key disclosure permission information input to the key disclosure permission information input unit 52 to the key sharing server 2 (2B) as transmission information, receives the cipher key for data encryption and the cipher key for data decryption corresponding to the transmission information and the key ID of the cipher key from the key sharing server 2 (2B), and transmits the cipher key for data decryption wrapped with the password key output in response to the input of the cipher key for data decryption to the cipher key wrap unit 64 and the key ID, to the key sharing server 2 (2B).

With reference to FIG. 24A, the key registration processing unit 33C in the second key registration client terminal 3A2 is configurable to include the data input unit 50, the identification token storage unit 51, the key disclosure permission information input unit 52, the information transmission and/or reception unit (network access unit) 54, and the data encryption unit 55 as detailed components. These components include those shared with other processing units. This key registration processing unit 33C operates with the data creation unit 56 configuring the data creation processing unit 34 (refer to FIG. 19).

The key registration processing unit 33C in the second key registration client terminal 3A2 communicates with the key registration processing unit 24B in the second key sharing server 2B.

With reference to FIG. 24A and FIG. 24B together, in the key registration processing unit 33C, the data input unit 50, the identification token storage unit 51, the key disclosure permission information input unit 52, the information transmission and/or reception unit 54, and the data encryption unit 55 cooperate to execute the following detailed processing steps as an example.

[S1 (refer to FIG. 24B)]A user inputs encryption target data (D) to the data input unit 50.
[S2] The user inputs key disclosure permission information to the key disclosure permission information input unit 52.
[S3] The data input unit 50 transmits the encryption target data (D) to the data encryption unit 55.
[S4] The information transmission and/or reception unit 54 reads an identification token from the identification token storage unit 51.
[S5] The information transmission and/or reception unit 54 reads key disclosure permission information from the key disclosure permission information input unit 52.
[S6] The information transmission and/or reception unit 54 transmits the identification token and the key disclosure permission information to the key registration processing unit 24.
[S7] The information transmission and/or reception unit 54 receives a cipher key for data encryption (k), a key ID, a key owner ID, and a URL for key acquisition, from the key registration processing unit 24.
[S8] The information transmission and/or reception unit 54 transmits the key ID, the key owner ID, and the URL for key acquisition to the data creation unit 56.
[S9] The information transmission and/or reception unit 54 transmits the cipher key for data encryption (k) to the data encryption unit 55.
[S10] The data encryption unit 55 encrypts the encryption target data (D) with the cipher key for data encryption (k) and transmits the encrypted data (D1) and an encryption parameter to the data creation unit 56.

In the second key registration client terminal 3A2 described above, the kind of data output by the data creation unit 56 is similar to that of the first key registration client terminal 3A1.

### {Details of Third Key Registration Client Terminal}

Details of the third key registration client terminal 3A3 in the key sharing system 1 will be described with reference to FIG. 1C, FIG. 19, and related drawings together.

With reference to FIG. 19, the key registration client terminal 3A as the third key registration client terminal 3A3, includes the user registration processing unit 31, the login processing unit 32, a key registration processing unit 33D, and the data creation processing unit 34 as functional components.

The third key registration client terminal 3A3 further includes the key deletion processing unit 37, the key disclosure period change processing unit 38, the key disclosure permission information change processing unit 39, or the like according to each embodiment (example).

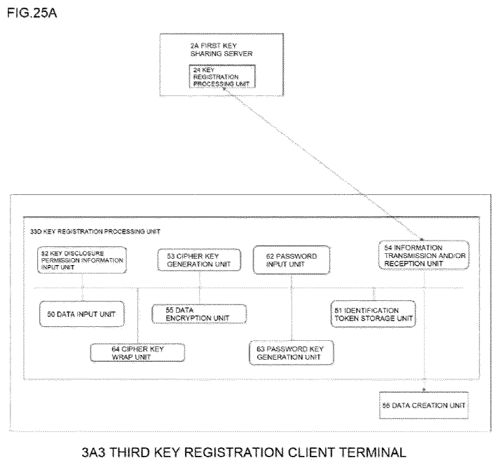

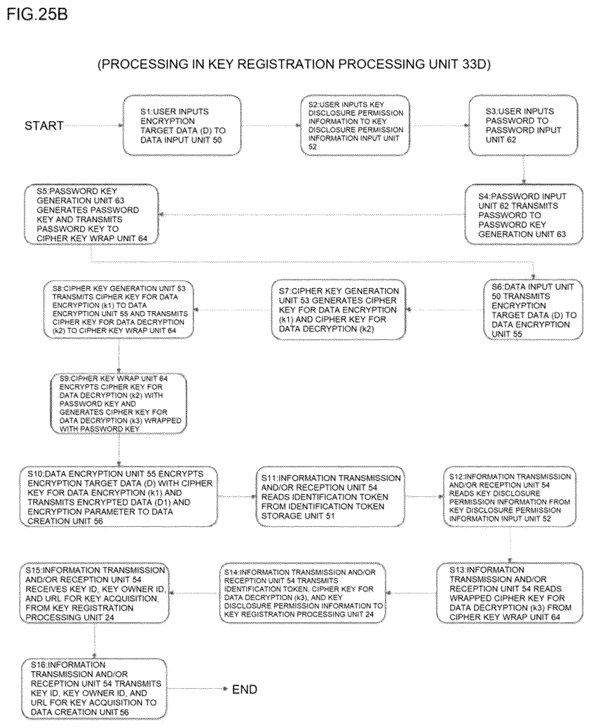

With reference to FIG. 25A, the basic feature elements of the third key registration client terminal 3A3 include the identification token storage unit 51, the key disclosure permission information input unit 52, the cipher key generation unit 53, the information transmission and/or reception unit (network access unit) 54, the data encryption unit 55, and the data creation unit 56.

The third key registration client terminal 3A3 further includes the password input unit 62, the password key generation unit 63, and the cipher key wrap unit 64, in contrast to the first key registration client terminal 3A1.

Specifically, the third key registration client terminal 3A3 further includes, in the first key registration client terminal 3A1, the password input unit 62 configured to receive an input of a password, the password key generation unit 63 configured to generate a password key (cipher key) on the basis of the password input to the password input unit 62, and the cipher key wrap unit 63 configured to encrypt the cipher key for data decryption generated by the cipher key generation unit 53, with the password key generated by the password key generation unit 63 and output the cipher key for data decryption wrapped (encrypted) with the password key.

In this configuration, the information transmission and/or reception unit 54 transmits the identification token stored by the identification token storage unit 51, the cipher key for data decryption wrapped with the password output by the cipher key wrap unit 64, and the key disclosure permission information input to the key disclosure permission information input unit 52, to the key sharing server 2 (2A) as transmission information, and receives the key ID corresponding to the transmission information from the key sharing server 2 (2A) ([refer to Aspect 11}).

Here, the password input to the password input unit 62 by the user using the third key registration client terminal 3A3 is a password shared with a receiver of the encrypted data D1 and is necessary to decrypt the encrypted data D1 additionally. Note that, in general, to create a password key based on a password, some key derivation functions are used. One example of the functions is Password-Based Key Derivation Function 2 (PBKDF2).

With reference to FIG. 25A, the key registration processing unit 33D in the third key registration client terminal 3A3 is configurable to include the data input unit 50, the identification token storage unit 51, the key disclosure permission information input unit 52, the cipher key generation unit 53, the information transmission and/or reception unit (network access unit) 54, the data encryption unit 55, the password input unit 62, the password key generation unit 63, and the cipher key wrap unit 64 as detailed components. These components include those shared with other processing units. This key registration processing unit 33D operates with the data creation unit 56 configuring the data creation processing unit 34 (refer to FIG. 19).

The key registration processing unit 33D in the third key registration client terminal 3A3 communicates with the key registration processing unit 24 in the first key sharing server 2A.

With reference to FIG. 25A and FIG. 25B together, in the key registration processing unit 33D, the data input unit 50, the identification token storage unit 51, the key disclosure permission information input unit 52, the cipher key generation unit 53, the information transmission and/or reception unit 54, the data encryption unit 55, the password input unit 62, the password key generation unit 63, and the cipher key wrap unit 64 cooperate to execute main points of the following detailed processing steps.

[S1 (refer to FIG. 25B)]A user inputs encryption target data (D) to the data input unit 50.
[S2] The user inputs key disclosure permission information to the key disclosure permission information input unit 52.
[S3] The user inputs a password to the password input unit 62.
[S4] The password input unit 62 transmits the password to the password key generation unit 63.
[S5] The password key generation unit 63 generates a password key and transmits the password key to the cipher key wrap unit 64.
Specifically, [S6] the data input unit 50 transmits the encryption target data (D) to the data encryption unit 55.
[S7] The cipher key generation unit 3 generates a cipher key for data encryption (k1) and a cipher key for data decryption (k2).
[S8] The cipher key generation unit 53 transmits the cipher key for data encryption (k1) to the data encryption unit 55 and the cipher key for data decryption (k2) to the cipher key wrap unit 64.
[S9] The cipher key wrap unit 64 encrypts the cipher key for data decryption (k2) with the password key to generate a cipher key for data decryption (k3) wrapped with the password key.
[S10] The data encryption unit 55 encrypts the encryption target data (D) with the cipher key for data encryption (k1) and transmits encrypted data (D1) and an encryption parameter to the data creation unit 56.
[S11] The information transmission and/or reception unit 54 reads an identification token from the identification token storage unit 51.
[S12] The information transmission and/or reception unit 54 reads the key disclosure permission information from the key disclosure permission information input unit 52.
[S13] The information transmission and/or reception unit 54 reads the wrapped cipher key for data decryption (k3) from the cipher key wrap unit 64.
[S14] The information transmission and/or reception unit 54 transmits the identification token, the cipher key for data decryption (k3), and the key disclosure permission information to the key registration processing unit 24.
[S15] The information transmission and/or reception unit 54 receives a key ID, a key owner ID, and a URL for key acquisition from the key registration processing unit 24.
[S16] The information transmission and/or reception unit 54 transmits the key ID, the key owner ID, and the URL for key acquisition to the data creation unit 56.

In the third key registration client terminal 3A3 described above, the kind of data output by the data creation unit 56 is similar to that of the first key registration client terminal 3A1.

### {Details of Fourth Key Registration Client Terminal}

Details of the fourth key registration client terminal 3A4 in the key sharing system 1 will be described with reference to FIG. 1C, FIG. 19, and related drawings together.

With reference to FIG. 19, the key registration client terminal 3A as the fourth key registration client terminal 3A4, includes the user registration processing unit 31, the login processing unit 32, a key registration processing unit 33E, and the data creation processing unit 34 as functional components.

The fourth key registration client terminal 3A4 further includes the key deletion processing unit 37, the key disclosure period change processing unit 38, the key disclosure permission information change processing unit 39, or the like according to each embodiment (example).

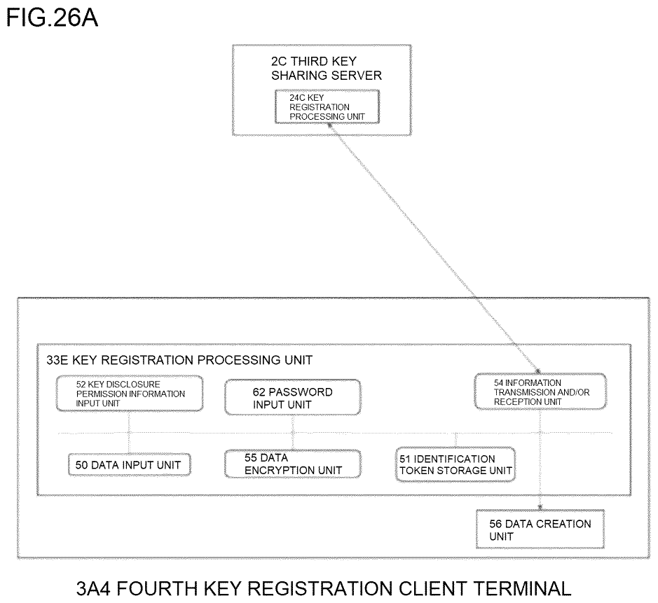

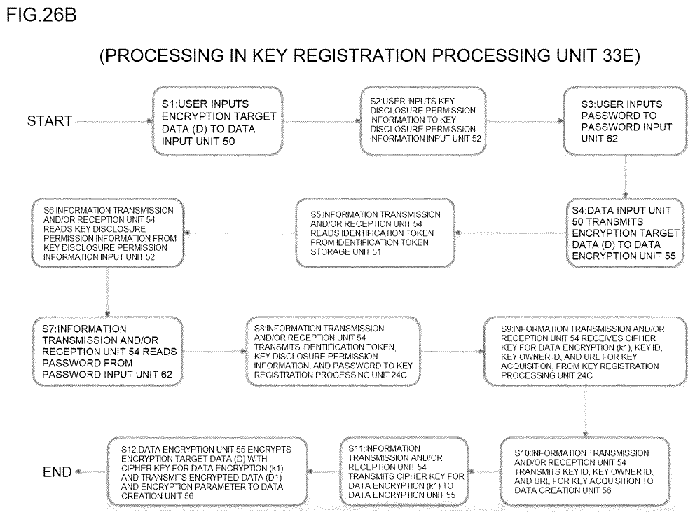

The basic feature elements of the fourth key registration client terminal 3A4 include the identification token storage unit 51, the key disclosure permission information input unit 52, the information transmission and/or reception unit (network access unit) 54, the data encryption unit 55, and the data creation unit 56 (refer to FIG. 26A).

Specifically, the fourth key registration client terminal 3A3 further includes, in the second key registration client terminal 3A2, the password input unit 62 configured to receive an input of a password.

In this configuration, the information transmission and/or reception unit 54 transmits a corresponding identification token stored in the identification token storage unit 51, the key disclosure permission information input to the key disclosure permission information input unit 52, the password input to the password input unit 62, to the key sharing server 2 (2C) as transmission information and receives the cipher key for data encryption corresponding to the transmission information and the key ID of the cipher key to the key sharing server 2 (2C) ([refer to Aspect 12]).

With reference to FIG. 26A, the key registration processing unit 33E in the fourth key registration client terminal 3A4 is configurable to include the data input unit 50, the identification token storage unit 51, the key disclosure permission information input unit 52, the information transmission and/or reception unit 54, the data encryption unit 55, and the password input unit 62 as detailed components. These components include those shared with other processing units. This key registration processing unit 33E operates with the data creation unit 56 configuring the data creation processing unit 34 (refer to FIG. 19).

The key registration processing unit 33E in the fourth key registration client terminal 3A4 communicates with the key registration processing unit 24C in the third key sharing server 2C.

With reference to FIG. 26A and FIG. 26B together, in the key registration processing unit 33E, the data input unit 50, the identification token storage unit 51, the key disclosure permission information input unit 52, the information transmission and/or reception unit 54, the data encryption unit 55, and the password input unit 62 cooperate to execute points of the following detailed processing steps.

[S1 (refer to FIG. 26B)]A user inputs encryption target data (D) to the data input unit 50.
[S2] The user inputs key disclosure permission information to the key disclosure permission information input unit 52.
[S3] The user inputs a password to the password input unit 62.
[S4] The data input unit 50 transmits the encryption target data (D) to the data encryption unit 55.
[S5] The information transmission and/or reception unit 54 reads an identification token from the identification token storage unit 51.
[S6] The information transmission and/or reception unit 54 reads key disclosure permission information from the key disclosure permission information input unit 52.
[S7] The information transmission and/or reception unit 54 reads the password from the password input unit 62.
[S8] The information transmission and/or reception unit 54 transmits the identification token, the key disclosure permission information, and the password to the key registration processing unit 24C.
[S9] The information transmission and/or reception unit 54 receives a cipher key for data encryption (k1), a key ID, a key owner ID, and a URL for key acquisition, from the key registration processing unit 24C.
[S10] The information transmission and/or reception unit 54 transmits the key ID, the key owner ID, and the URL for key acquisition to the data creation unit 115.
[S11] The information transmission and/or reception unit 54 transmits a cipher key for data encryption (k1) to the data encryption unit 114.
[S12] The data encryption unit 55 encrypts the encryption target data (D) with the cipher key for data encryption (k1) and transmits the encrypted data (D1) and an encryption parameter to the data creation unit 56.

In the fourth key registration client terminal 3A4 described above, the kind of data output by the data creation unit 56 is similar to that of the first key registration client terminal 3A1.

### {Details of First Key Acquisition Client Terminal}

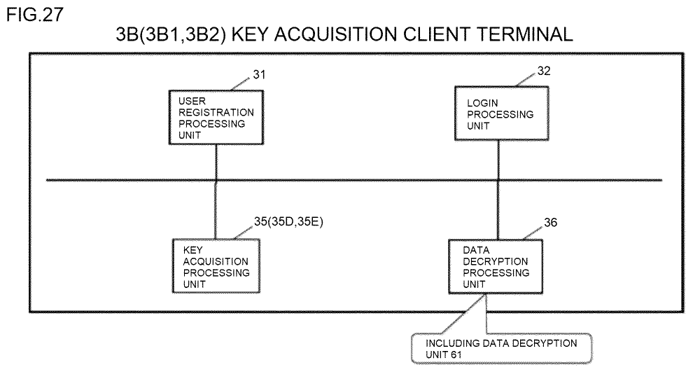

Details of a first key acquisition client terminal 3B1 in the key sharing system 1 will be described with reference to FIG. 1C, FIG. 27, and related drawings together.

With reference to FIG. 27, the key acquisition client terminal 3B as the first key acquisition client terminal 3B1, includes the user registration processing unit 31, the login processing unit 32, a key acquisition processing unit 35D, and the data decryption processing unit 36 as functional components. Here, the data decryption processing unit 36 includes a data decryption unit 61 (this similarly applies to other embodiments (examples)).

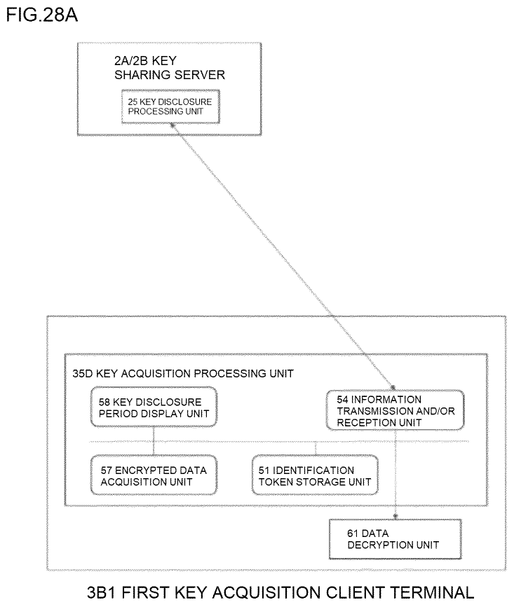

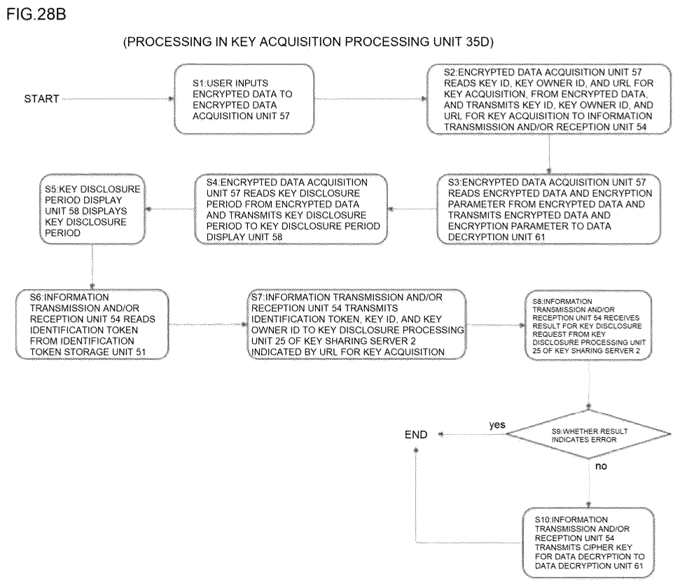

The basic feature elements of the first key acquisition client terminal 3B1 include the identification token storage unit 51, the information transmission and/or reception unit (network access unit) 54, the encrypted data acquisition unit 57, and the data decryption unit 61 (refer to FIG. 28A).

In other words, the first key acquisition client terminal 3B1 is a client terminal having a key acquisition function of reading data output by the client terminal 3A having a key registration function and includes the identification token storage unit 51 configured to store an identification token (proof) indicating that a corresponding user is an authenticated user and the encrypted data acquisition unit 57 configured to acquire key identification information (key ID) and encrypted data from the read data.

The first key acquisition client terminal 3B1 includes the information transmission and/or reception unit 54 configured to transmit the identification token stored in the identification token storage unit 51 and the key ID acquired by the encrypted data acquisition unit 57 to the key sharing server 2 (2A/2B) as transmission information and receive a key corresponding to the transmission information from the key sharing server 2 (2A/2B).

The first key acquisition client terminal 3B1 Further includes the data decryption unit 61 configured to receive the encrypted data acquired by the encrypted data acquisition unit 57 and the cipher key for data decryption received by the information transmission and/or reception unit 54 and decrypt the encrypted data by using the cipher key for data decryption.

The first key acquisition client terminal 3B1 can adopt any of the following aspects. Note that [Aspect 32] to [Aspect 35] are also applicable to a second key acquisition client terminal 3B2 to be described below.

[Aspect 32] In the first key acquisition client terminal 3B1, the encrypted data acquisition unit 57 acquires, when read data includes an encryption parameter, the encryption parameter from the read data, and
the data decryption unit 61 uses the encryption parameter acquired by the encrypted data acquisition unit 57 to decrypt encrypted data.
   [Aspect 33] In the first key acquisition client terminal 3B1, the encrypted data acquisition unit 57 acquires, when input data includes a key owner ID, the key owner ID from the input data, and
the information transmission and/or reception unit 54 transmits the key owner ID acquired by the encrypted data acquisition unit 57 to the key sharing server 2 (2A/2B).
   [Aspect 34] In the first key acquisition client terminal 3B1, the encrypted data acquisition unit 57 reads, when input data includes a URL for key acquisition, the URL for key acquisition from the input data, and
the information transmission and/or reception unit 54 accesses the URL for key acquisition read by the encrypted data acquisition unit 57 to communicate with the key sharing server 2 (2A/2B).
   [Aspect 35] In the first key acquisition client terminal 3B1, the encrypted data acquisition unit 57 reads, when input data includes a key disclosure period or a data creation time and date, the key disclosure period or the data creation time and date from the input data, and performs processing to display the key disclosure period or the data creation time and date to a corresponding user.

The user registration processing unit 31 and the login processing unit 32 in the first key acquisition client terminal 3B1 include similar components to those of the first key registration client terminal 3A1 and the like described above and function similarly, and can hence be easily understood by those skilled in the art. Hence, descriptions of the user registration processing unit 31 and the login processing unit 32 are omitted here.

With reference to FIG. 28A, the key acquisition processing unit 35D in the first key acquisition client terminal 3B1 is configurable to include the identification token storage unit 51, the information transmission and/or reception unit 54, the encrypted data acquisition unit 57, and the key disclosure period display unit 58 as detailed components. These components include those shared with other processing units. This key acquisition processing unit 35D operates with the data decryption unit 61 configuring the data decryption processing unit 36 (refer to FIG. 27).

The key acquisition processing unit 35D in the first key acquisition client terminal 3B1 communicates with the key disclosure processing unit 25 in the first key sharing server 2A or the second key sharing server 2B.

With reference to FIG. 28A and FIG. 28B together, in the key acquisition processing unit 35D, the identification token storage unit 51, the information transmission and/or reception unit 54, the encrypted data acquisition unit 57, and the key disclosure period display unit 58 cooperate to execute processing steps S1 to S10 illustrated in FIG. 28B as an example.

In processing step S1, when a key disclosure request is needed, a user inputs encrypted data (six kinds of data illustrated in FIG. 23) acquired in advance to the encrypted data acquisition unit 57.

It is assumed that, before this processing step S1, in the first key acquisition client terminal 3B1, the key acquisition processing unit 35D reads data output by the key registration client terminal 3A and holds the data in advance.

In processing step S2, the encrypted data acquisition unit 57 reads a key ID, a key owner ID, and a URL for key acquisition from encrypted data and transmits the key ID, the key owner ID, and the URL for key acquisition to the information transmission and/or reception unit 54. Here, the key owner ID is an e-mail address in a case of the encrypted data illustrated in FIG. 23.

In processing step S3, the encrypted data acquisition unit 57 reads encrypted data D1 and an encryption parameter from the encrypted data and transmits the encrypted data D1 and the encryption parameter to the data decryption unit 61.

In processing step S4, the encrypted data acquisition unit 57 reads the key disclosure period from the encrypted data and transmits the key disclosure period to the key disclosure period display unit 58.

In processing step S5, the key disclosure period display unit 58 displays the key disclosure period. This is, for example, a display as follows.
Key disclosure start time and date (time): 2021/11/19 17:36:55
Key disclosure end time and date (time): 2022/10/20 17:36:55
Data creation time and date (time): 2021/10/20 17:36:55

When an error (result) is returned from a key sharing server and no cipher key for data decryption is obtained in a subsequent step (processing step S8), the user using the first key acquisition client terminal 3B1 views this display of the key disclosure period to thereby be able to understand that the key disclosure end time and date has passed, for example. Note that, for example, when there is a rule “the key disclosure end time is one week after the data creation time”, the acquisition processing unit 35D can display the key disclosure end time even when the key disclosure end time is not described in the encrypted data, as long as the data creation time and date is described.

In processing step S6, the information transmission and/or reception unit 54 reads a corresponding identification token from the identification token storage unit 51. It is assumed that, before processing step S6, user registration to the key sharing server by the user registration processing unit 31 or login to the key sharing server by the login processing unit 32 is completed. As a result of the user registration or the login, the identification token transmitted from the key sharing server 2 is stored in the identification token storage unit 51.

In processing step S7, the information transmission and/or reception unit 54 transmits the identification token, the key ID, and the key owner ID to the key disclosure processing unit 25 of the key sharing server 2 indicated by the URL for key acquisition.

In processing step S8, the information transmission and/or reception unit 54 receives a result for the key disclosure request from the key disclosure processing unit 25 of the key sharing server 2.

When a judgment result is not an error in processing step S9, a corresponding cipher key for data decryption is transmitted from the key disclosure processing unit 25.

In processing step S10, the information transmission and/or reception unit 54 transmits the cipher key for data decryption to the data decryption processing unit 36 (data decryption unit 61).

Note that the encrypted data input to the encrypted data acquisition unit 57 by the user does not include the URL for key acquisition in some cases. In these cases, the key acquisition processing unit 35D accesses a key acquisition destination held in advance. Alternatively, the key acquisition processing unit 35D may access a URL held in advance to acquire a key acquisition destination URL.

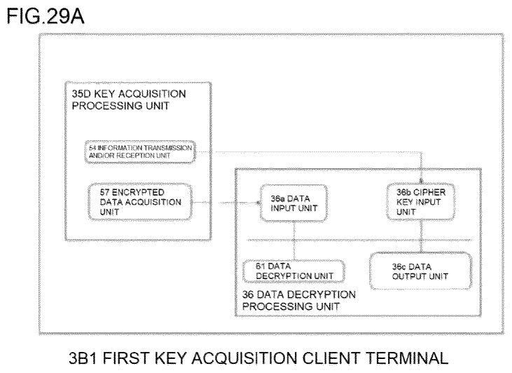

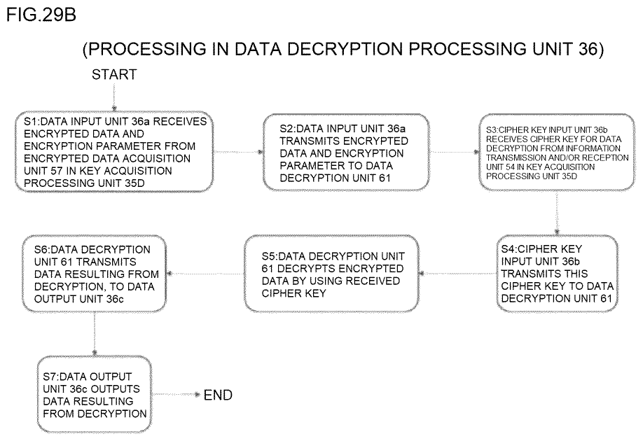

With reference to FIG. 29A, the data decryption processing unit 36 in the first key acquisition client terminal 3B1 is configurable to include a data input unit 36a, a cipher key input unit 36b, a data output unit 36c, and the data decryption unit 61 as detailed components. This data decryption processing unit 36 operates with the key acquisition processing unit 35D.

With reference to FIG. 29A and FIG. 29B together, in the data decryption processing unit 36, the data input unit 36a, the cipher key input unit 36b, the data output unit 36c, and the data decryption unit 61 cooperate to execute processing steps S1 to S7 illustrated in FIG. 29B as an example.

In processing step S1 illustrated in FIG. 29B, the data input unit 36a receives encrypted data D1 and an encryption parameter from the encrypted data acquisition unit 57 in the key acquisition processing unit 35D.

In processing step S2, the data input unit 36a transmits the encrypted data D1 and the encrypted parameter to the data decryption unit 61.

The cipher key input unit 36b receives a cipher key (cipher key for data decryption) from the information transmission and/or reception unit 54 in the key acquisition processing unit 35D in processing step S3 and transmits this cipher key to the data decryption unit 61 in processing step S4.

In processing step S5, the data decryption unit 61 decrypts the encrypted data D1 with the received cipher key. In this decryption, the encryption parameter is used.

To supplement a function of the encryption parameter in the data decryption unit 61, nonce in Counter mode is XORed with a counter value, for example, to generate a counter block for encryption/decryption. The nonce in Counter mode is a parameter that changes every encryption to change a result of encryption of the same plain text every encryption. Similarly, an initial vector (IV) is a value XORed before encryption of the first plain block in CBC mode, for example. By changing the IV every encryption, an encrypted text corresponding to the same plain text changes every encryption. In decryption in CBC mode, a decryption result of the first block is XORed with the IV to obtain the first plain text block.

In processing step S6, the data decryption unit 61 transmits data of the decryption result to the data output unit 36c.

In processing step S7, the data output unit 36c outputs the data of the decryption result. The data output by the data output unit 36c is a text, an image (still image and/or video), or the like, according to the format of original data. In the first key acquisition client terminal 3B1, the data output by the data output unit 36c is displayed in an appropriate form.

### {Details of Second Key Acquisition Client Terminal}

Details of a second key acquisition client terminal 3B2 in the key sharing system 1 will be described with reference to FIG. 1C, FIG. 27, and related drawings together.

With reference to FIG. 27, the key acquisition client terminal 3B as the second key acquisition client terminal 3B2, includes the user registration processing unit 31, the login processing unit 32, a key acquisition processing unit 35E, and the data decryption processing unit 36 as functional components.

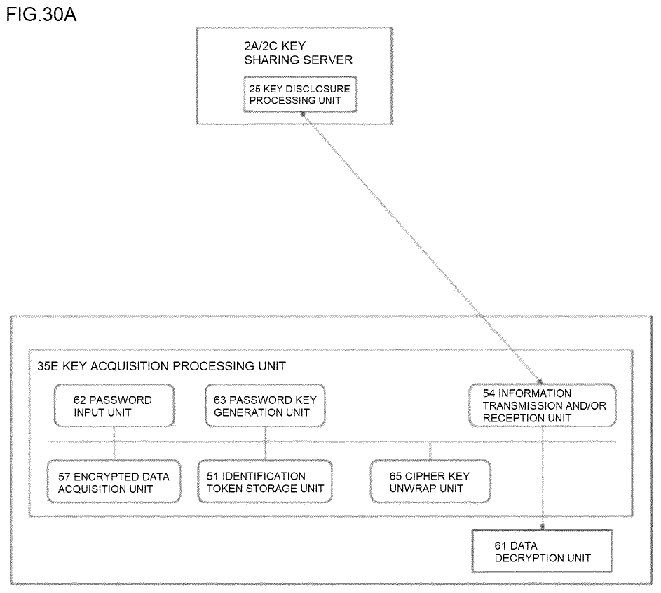

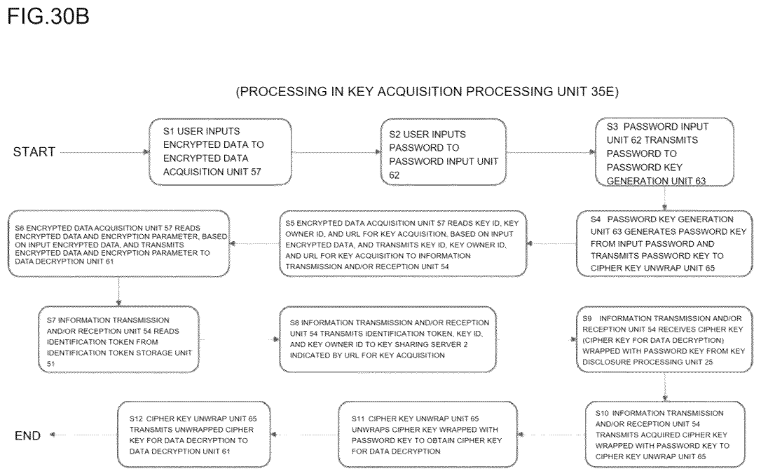

The basic feature elements of the second key acquisition client terminal 3B2 include the identification token storage unit 51, the information transmission and/or reception unit (network access unit) 54, the encrypted data acquisition unit 57, and the data decryption unit 61 (refer to FIG. 30A).

The second key acquisition client terminal 3B2 further includes the password input unit 62, the password key generation unit 63, and a cipher key unwrap unit 65, in contrast to the first key acquisition client terminal 3B 1.

Specifically, the second key registration client terminal 3B2 further includes, in the first key registration client terminal 3B1, the password input unit 62 configured to receive an input of a password, the password key generation unit 63 configured to generate a password key on the basis of the password input to the password input unit 62, and the cipher key unwrap unit 65 configured to unwrap (decrypt) the cipher key for data decryption received from the information transmission and/or reception unit 54, with the password key generated by the password key generation unit 63 and output the unwrapped cipher key for data decryption.

In this configuration, the data decryption unit 61 uses the cipher key for data decryption unwrapped by the cipher key unwrap unit 65 to decrypt the encrypted data acquired by the encrypted data acquisition unit 57 (refer to [Aspect 31]).

With reference to FIG. 30A, the key acquisition processing unit 35E in the second key acquisition client terminal 3B2 is configurable to include the identification token storage unit 51, the information transmission and/or reception unit 54, the encrypted data acquisition unit 57, the password input unit 62, the password key generation unit 63, and the cipher key unwrap unit 65 as detailed components. This key acquisition processing unit 35E operates with the data decryption unit 61 configuring the data decryption processing unit 36 (refer to FIG. 27).

The key acquisition processing unit 35E in the second key acquisition client terminal 3B2 communicates with the key disclosure processing unit 25 in the first key sharing server 2A or the third key sharing server 2C.

With reference to FIG. 30A and FIG. 30B together, in the key acquisition processing unit 35E, the identification token storage unit 51, the information transmission and/or reception unit 54, the encrypted data acquisition unit 57, the password input unit 62, the password key generation unit 63, and the encryption unwrap unit 65 cooperate to execute processing steps S1 to S12 illustrated in FIG. 30B as an example.

In processing step S1, when a key disclosure request is needed, a user inputs encrypted data (six kinds of data illustrated in FIG. 23) acquired in advance to the encrypted data acquisition unit 57.

It is assumed that, before this processing step S1, in the second key acquisition client terminal 3B2, the key acquisition processing unit 35E reads data output by the key registration client terminal 3A and holds the data in advance.

In processing step S2, the user inputs a password to the password input unit 62. This password is a password shared with the creator of the input encrypted data additionally. The encrypted data is created by the third key registration client terminal 3A3 or the fourth key registration client terminal 3A4. The password must be identical to the password input to the third key registration client terminal 3A3 or the fourth key registration client terminal 3A4 by the creator of the encrypted data at the time of creation of the encrypted data.

In processing step S3, the password input unit 62 transmits the password to the password key generation unit 63.

In processing step S4, the password key generation unit 63 generates a password key from the input password and transmits this password key to the cipher key unwrap unit 65.

In processing step S5, the encrypted data acquisition unit 57 reads a key ID, a key owner ID, and a URL for key acquisition on the basis of the input encrypted data and transmits the key ID, key owner ID, and the URL for key acquisition to the information transmission and/or reception unit 54.

In processing step S6, the encrypted data acquisition unit 57 reads encrypted data D1 and an encryption parameter on the basis of the input encrypted data and transmits the encrypted data D1 and the encryption parameter to the data decryption unit 61.

In processing step 7, the information transmission and/or reception unit 54 reads a corresponding identification token from the identification token storage unit 51.

In processing step S8, the information transmission and/or reception unit 54 transmits the identification token, the key ID, and the key owner ID to the key sharing server 2 (first key sharing server 2A or third key sharing server 2C) indicated by the URL for key acquisition.

In processing step S8, the information transmission and/or reception unit 54 transmits the identification token and the key ID to the key sharing server.

In processing step S9, the information transmission and/or reception unit 54 receives a cipher key (cipher key for data decryption) wrapped (encrypted) with the password key from the key disclosure processing unit 25 of the key sharing server 2 (2A/2C). This cipher key for data decryption is a cipher key registered to the first key sharing server 2A by the third key registration client terminal 3A3 or a cipher key registered to the third key sharing server 2C by the fourth key registration client terminal 3A4.

In processing step S10, the information transmission and/or reception unit 54 transmits the acquired cipher key wrapped (encrypted) with the password key to the cipher key unwrap unit 65.

In processing step 11, the cipher key unwrap unit 65 unwraps (decrypts) the cipher key wrapped (encrypted) with the password key, to obtain the cipher key for data decryption.

In processing step 12, the cipher key unwrap unit 65 transmits the unwrapped cipher key for data decryption to the data decryption unit 61 in the data decryption processing unit 36 (refer to FIG. 27).

The data decryption unit 61 decrypts encrypted data D1 in the input encrypted data, with the acquired cipher key for data decryption and reproduces the text, the image (still image and/or video), or the like from the decrypted data.

### Modified Examples in One Embodiment

To the key sharing system 1 of the one embodiment described above, the modified examples to be described below can be adopted.

(1) In the key sharing system 1 of the one embodiment described above, it is possible, for example, to adopt a configuration that the key sharing server 2 (2A/2B/2C) further includes the key deletion processing unit 26, the key disclosure period change processing unit 27, and the key disclosure permission information change processing unit 28 and the key registration client terminal 3A further includes the key deletion processing unit 37, the key disclosure period change processing unit 38, and the key disclosure permission information change processing unit 39.

This configuration enables deletion of a cipher key registered to the key sharing server 2 by a user, change of the disclosure period of the cipher key registered to the key sharing server 2 by the user, and change of the key disclosure permission information of the cipher key registered to the key sharing server 2 by the user.

(2) In the key sharing system 1 of the one embodiment described above, key disclosure by the key sharing server 2 (2A/2B/2C) can be associated with viewing of advertisement and charging. For example, the key sharing server 2 provides a key to a user requesting key disclosure after confirming that the user has viewed an advertisement video. Alternatively, the key sharing server 2 provides a key to a user requesting key disclosure after confirming that the user has paid a service charge.

(3) In the key sharing system 1 of the one embodiment described above, an identification token indicates an authenticated user. For a user with an e-mail address being authenticated, the key sharing server 2 may request registration of another e-mail address, a phone number, or the like held by the user to perform two-element authentication or multi-element authentication. In this case, a smartphone may be registered as the second element for identity verification.

(4) In the key sharing system 1 of the one embodiment described above, to increase security of key disclosure, it is possible to adopt a configuration to perform reconfirmation of an e-mail address by using one-time password between the key sharing server 2 (2A/2B/2C) and the key acquisition client terminal 3B at the time of key disclosure.

(5) A cipher key for data encryption and a cipher key for data decryption in the key sharing system 1 of the one embodiment described above is replaceable with cipher key generation source information corresponding to source data for generating a cipher key.

(6) A modified example of the second key registration client terminal 3A2 in the key sharing system 1 of the one embodiment described above will be described. This modified example further includes the password input unit 62, the password key generation unit 63, and the cipher key wrap unit 64. A password input to the password input unit 62 is transmitted to the password key generation unit 63, and a password key generated by the password key generation unit 63 is transmitted to the cipher key wrap unit 64. The information transmission and/or reception unit 54 also receives a cipher key for data decryption in addition to a cipher key for data encryption, from the key sharing server 2. In a case of symmetric key encryption, these cipher keys match.

The information transmission and/or reception unit 54 transmits the cipher key for data decryption received from the key sharing server 2, to the cipher key wrap unit 64. The cipher key wrap unit 64 encrypts (wraps) the cipher key for data decryption with the encryption password key and transmits the encrypted (wrapped) cipher key for data decryption to the information transmission and/or reception unit 54. The information transmission and/or reception unit 54 transmits the wrapped cipher key for data decryption to the key sharing server 2 together with a corresponding identification token stored in the identification token storage unit 51. Key identification information of the cipher key for data decryption is received from the key sharing server 2 at the time of reception of the cipher key for data encryption and the cipher key for data decryption by the information transmission and/or reception unit 54 from the key sharing server 2 or in response to transmission of the wrapped cipher key for data decryption from the information transmission and/or reception unit 54 to the key sharing server 2.

(7) A modified example of the second key sharing server 2B that communicates with the second key registration client terminal 3A2 of modified example (6) described above will be described. A second processing unit of the modified example transmits a cipher key for data decryption in addition to a cipher key for data encryption to the above client terminal. In this transmission, the key identification information of the cipher key does not necessarily need to be transmitted. The second processing unit further receives the cipher key for data decryption wrapped with a password key from the above key registration client terminal together with an identification token. The wrapped cipher key for data decryption received is stored in a database in association with key disclosure permission information received by the second processing unit from the key registration client terminal. The second processing unit transmits to the key registration client terminal at the time of transmitting the cipher key for data decryption to the key registration client terminal or in response to reception of the wrapped cipher key for data decryption from the key registration client terminal.

A third processing unit of the second key registration client terminal of this modified example transmits, for key identification information received from the second key acquisition client terminal, the wrapped cipher key for data decryption associated with the key identification information.

(8) A modified example of the first key registration client terminal 3A1 in the key sharing system 1 of the one embodiment described above will be described. This modified example further includes the password input unit 62. The information transmission and/or reception unit 54 transmits a password input to the password input unit 62, to the key sharing server 2 in addition to an identification token, a cipher key for data decryption, and key disclosure permission information, and acquires key identification information.

(9) A modified example of the first key sharing server 2A that communicates with the first key registration client terminal 3A1 of modified example (8) described above will be described. A second processing unit receives a password in addition to an identification token, a cipher key for data decryption, and key disclosure permission information. The second processing unit generates a password key from the password and uses the password key to encrypt (wrap) the received cipher key for data decryption. The second processing unit stores the wrapped cipher key for data decryption and the key disclosure permission information in a database, and transmits key identification information for identifying the wrapped cipher key for data decryption and the key disclosure permission information in the database, to this first key registration client terminal 3A1.

### Effects of One Embodiment and Modified Examples

In the key sharing system 1 of any of the one embodiment and modified examples described above, by using an identification token, key disclosure permission information, key identification information, and a plurality of kinds of keys in combination, a key sharing processing technique for more securely sharing encrypted data obtained by encrypting encryption target data is provided.

With this, problems of existing techniques can be solved.

### Other Modified Examples

Each of the processes in any of the one embodiment and modified examples described above may be provided as a program executable in a computer and may be provided via a non-transitory computer readable recording medium such as a CD-ROM or a flexible disc and further a communication line.

The processes in any of the one embodiment and modified examples described above may be implemented in combination by selecting a plurality of any ones of or all of the processes.

### REFERENCE SIGNS LIST

100 Key sharing system
101 Key sharing server
102 First client terminal
103 Second client terminal
104 Identification token issue unit
105 Password provision unit
106 Verification unit
107 Key registration unit
108 Cipher key generation unit
109 Cipher key first processing unit
110 Key disclosure unit
111 First identification token storage unit
112 Key disclosure permission information input unit
113 First information transmission and/or reception unit
114 Data encryption unit
115 Data creation unit
116 Second identification token storage unit
117 Encrypted data acquisition unit
118 Second information transmission and/or reception unit
119 Cipher key second processing unit
120 Data decryption unit
121 Database
122 Record
131, 132 Identification token
133 Password
134 Key disclosure permission information
135 Key identification information
136 Cipher key for data encryption after first processing
137 Cipher key for data decryption after first processing
138 Encrypted data
139 Data
140 Cipher key for data decryption after second processing
1 Key sharing system
2 Key sharing server
2A First key sharing server
2B Second key sharing server
2C Third key sharing server
3 Client terminal
3A Key registration client terminal
3B Key acquisition client terminal
3A1 First key registration client terminal
3A2 Second key registration client terminal
3A3 Third key registration client terminal
3A4 Fourth key registration client terminal
3B1 First key acquisition client terminal
3B2 Second key acquisition client terminal
4 Communication network

1. A key sharing system including one or more key sharing servers, one or more first client terminals each having functions of key registration and data output, and one or more second client terminals each having a function of reading data output by the first client terminal, the key sharing system comprising:
an identification token issue unit configured to issue an identification token indicating “authenticated” to the first client terminal and the second client terminal;
a cipher key generation unit configured to generate a pair of a cipher key for data encryption and a cipher key for data decryption;
a cipher key first processing unit configured to perform or not perform certain processing on each of the cipher key for data encryption and the cipher key for data decryption generated by the cipher key generation unit, to thereby generate a cipher key for data encryption after first processing and a cipher key for data decryption after first processing, respectively;
a verification unit configured to verify an identification token transmitted from the first client terminal;
a key registration unit configured to cause the cipher key generation unit and the cipher key first processing unit to operate only when the verification unit confirms that the identification token is correct, to store key disclosure permission information designating a disclosure permissible range of the cipher key for data decryption after first processing transmitted from the first client terminal and the cipher key for data decryption after first processing generated by the cipher key first processing unit, in a record in a database included in a corresponding one of the key sharing servers and also transmit key identification information for identifying the record and the cipher key for data encryption after first processing generated by the cipher key first processing unit, to the first client terminal; and
a key disclosure unit configured to acquire the key identification information and the identification token included in key inquiry information from the second client terminal, acquire the encryption for data decryption after first processing and the key disclosure permission information from a record in the database included in one of the key sharing servers, the record corresponding to the key identification information acquired, acquire information of a user corresponding to the identification token acquired, and transmit, only when the user is confirmed to be included in the disclosure permissible range indicated by the key disclosure permission information acquired, the cipher key for data decryption after first processing acquired, to the second client terminal.

2. The key sharing system according to claim 1, wherein the cipher key first processing unit is configured to generate the cipher key for data encryption after first processing and the cipher key for data decryption after first processing by using the cipher key for data encryption and the cipher key for data decryption generated by the cipher key generation unit without change.

3. The key sharing system according to claim 2, wherein the first client terminal includes
a first identification token storage unit configured to store the identification token issued by the identification token issue unit,
a key disclosure permission information input unit configured to input the key disclosure permission information,
a first information transmission and/or reception unit configured to transmit the identification token stored by the first identification token storage unit and the key disclosure permission information input to the key disclosure permission information input unit, respectively to the verification unit and the key registration unit, and receive the key identification information replied by the key registration unit in response to the transmission,
a data encryption unit configured to, in response to an input of encryption target data, use the cipher key for data encryption after first processing output by the cipher key first processing unit to encrypt the encryption target data, and output encrypted data obtained as a result of the encryption, and
a data creation unit configured to output the data including the password identification information received by the first information transmission and/or reception unit and the encrypted data output by the data encryption unit.

4. The key sharing system according to claim 2, wherein the second client terminal includes
a second identification token storage unit configured to store the identification token issued by the identification token issue unit,
an encrypted data acquisition unit configured to acquire the key identification information and the encrypted data from the data read,
a second information transmission and/or reception unit configured to transmit, as the key inquiry information, the key identification information acquired by the encrypted data acquisition unit and the identification token stored by the second identification token storage unit, to the key disclosure unit, and receive the cipher key for data decryption after first processing replied by the key disclosure unit in response to the transmission,
a cipher key second processing unit configured to generate a cipher key for data decryption after second processing by using the cipher key for data decryption after first processing received by the second information transmission and/or reception unit, without change, and
a data decryption unit configured to use the cipher key for data decryption after second processing generated by the cipher key second processing unit, to execute decryption processing on the encrypted data acquired by the encrypted data acquisition unit.

5. The key sharing system according to claim 1, further comprising
a password provision unit configured to provide the password to the cipher key first processing unit, wherein
the cipher key first processing unit is configured to perform first processing on at least one of the cipher key for data decryption and the cipher key for data encryption generated by the cipher key generation unit, based on the password received from the password provision unit, to thereby generate the cipher key for data decryption after first processing and the cipher key for data encryption after first processing by using a cipher key for data decryption and a cipher key for data encryption subjected to or not subjected to the first processing.

6. The key sharing system according to claim 5, wherein the first client terminal includes
a first identification token storage unit configured to store the identification token issued by the identification token issue unit,
a key disclosure permission information input unit configured to input the key disclosure permission information,
a password provision unit configured to provide a password to the cipher key first processing unit,
a first information transmission and/or reception unit configured to transmit the identification token stored by the first identification token storage unit and the key disclosure permission information input to the key disclosure permission information input unit, respectively to the verification unit and the key registration unit, and receive the key identification information replied by the key registration unit in response to the transmission,
a data encryption unit configured to use, in response to an input of encryption target data, the cipher key for data encryption after first processing output by the cipher key first processing unit to encrypt the encryption target data, and output encrypted data obtained as a result of the encryption, and
a data creation unit configured to output the data including the password identification information received by the first information transmission and/or reception unit and the encrypted data output by the data encryption unit.

7. The key sharing system according to claim 5, wherein the second client terminal includes
a second identification token storage unit configured to store the identification token issued by the identification token issue unit,
an encrypted data acquisition unit configured to acquire the key identification information and the encrypted data from the data read,
a second information transmission and/or reception unit configured to transmit, as the key inquiry information, the key identification information acquired by the encrypted data acquisition unit and the identification token stored by the second identification token storage unit, to the key disclosure unit, and receive the cipher key for data decryption after first processing replied by the key disclosure unit in response to the transmission,
a password input unit configured to ask a user to input a password,
a cipher key second processing unit configured to perform or not to perform second processing on the cipher key for data decryption after first processing received by the second information transmission and/or reception unit, based on the password input to the password input unit, to thereby generate a cipher key for data decryption after second processing, and
a data decryption unit configured to use the cipher key for data decryption after second processing generated by the cipher key second processing unit, to execute decryption processing on the encrypted data acquired by the encrypted data acquisition unit.

8. The key sharing system according to claim 5, further comprising
in the first client terminal, a password provision unit configured to provide the password to the cipher key first processing unit, wherein
the cipher key generation unit and the cipher key first processing unit are included in the first client terminal, and
the first client terminal is configured to transmit the cipher key for data decryption after first processing generated by the cipher key first processing unit, to a server including the key registration unit.

9. The password sharing system according to claim 1, further comprising
in a server, a password provision unit configured to provide the password to the cipher key first processing unit, wherein
the cipher key generation unit and the cipher key first processing unit are included in the first client terminal,
the server including the password provision unit is configured to transmit the password provided by the password provision unit, to the first client terminal including the cipher key first processing unit, and
the first client terminal including the cipher key first processing unit is configured to transmit the cipher key for data decryption after first processing generated by the cipher key first processing unit, to a server including the key registration unit.

10. The key sharing system according to claim 5, further comprising
in the first client terminal, a password provision unit configured to provide the password to the cipher key first processing unit, wherein
the cipher key generation unit is included in the first client terminal,
the cipher key first processing unit is included in a server,
the first client terminal is configured to transmit the password provided by the password provision unit, to the server including the cipher key first processing unit, and transmit the cipher key for data decryption or the cipher key for data encryption generated by the cipher key generation unit, to the server including the cipher key first processing unit, and
the server including the cipher key first processing unit is configured to transmit the cipher key for data decryption after first processing or the cipher key for data encryption after first processing generated by the cipher key first processing unit, to a corresponding one of a server including the key registration unit and the first client terminal.

11. The password sharing system according to claim 1, further comprising
in a server, a password provision unit configured to provide the password to the cipher key first processing unit, wherein
the cipher key generation unit is included in the first client terminal,
the cipher key first processing unit is included together in the server or in a server different from the server in a distributed manner,
the first client terminal is configured to transmit the cipher key for data decryption or the cipher key for data encryption generated by the cipher key generation unit, to the server including the cipher key first processing unit,
the server including the password provision unit is configured to transmit the password provided by the password provision unit, to the server including the cipher key first processing unit, and
the server including the cipher key first processing unit is configured to transmit the cipher key for data decryption after first processing or the cipher key for data encryption after first processing generated by the cipher key first processing unit, to a corresponding one of a server including the key registration unit and the first client terminal.

12. The key sharing system according to claim 1, further comprising
in the first client terminal, a password provision unit configured to provide the password to the cipher key first processing unit, wherein
the cipher key generation unit and the cipher key first processing unit are included together in one server or in one or more servers in a distributed manner,
the first client terminal is configured to transmit the password provided by the password provision unit, to the server including the cipher key first processing unit,
the server including the cipher key generation unit is configured to transmit the cipher key for data decryption or the cipher key for data encryption generated by the cipher key generation unit, to the server including the cipher key first processing unit, and
the server including the cipher key first processing unit is configured to transmit the cipher key for data decryption after first processing or the cipher key for data encryption after first processing generated by the cipher key first processing unit, to a corresponding one of a server including the key registration unit and the first client terminal.

13. The key sharing system according to claim 1, further comprising
in the first client terminal, a password provision unit configured to provide the password to the cipher key first processing unit, wherein
the cipher key first processing unit is included in the first client terminal,
the cipher key generation unit is included in a server,
the server including the cipher key generation unit is configured to transmit the cipher key for data encryption or the cipher key for data decryption generated by the cipher key generation unit, to the first client terminal including the cipher key first processing unit, and
the first client terminal including the cipher key first processing unit is configured to transmit the cipher key for data decryption after first processing generated by the cipher key first processing unit, to a server including the key registration unit.

14. The password sharing system according to claim 1, further comprising
in a server, a password provision unit configured to provide the password to the cipher key first processing unit, wherein
the cipher key generation unit is included together in the server or in a server different from the server in a distributed manner,
the cipher key first processing unit is included in the first client terminal,
the server including the password provision unit is configured to transmit the password provided by the password provision unit, to the first client terminal including the cipher key first processing unit,
the server including the cipher key generation unit is configured to transmit the cipher key for data encryption or the cipher key for data decryption generated by the cipher key generation unit, to the first client terminal including the cipher key first processing unit, and
the first client terminal including the cipher key first processing unit is configured to transmit the cipher key for data decryption after first processing generated by the cipher key first processing unit, to a server including the key registration unit.

15. The password sharing system according to claim 1, further comprising
in a server, a password provision unit configured to provide the password to the cipher key first processing unit, wherein
the cipher key generation unit and the cipher key first processing unit are included together in the server or in one or more servers different from the server together or in a distributed manner,
the server including the password provision unit is configured to transmit the password provided by the password provision unit, to the server including the cipher key first processing unit,
the server including the cipher key generation unit is configured to transmit the cipher key for data encryption or the cipher key for data decryption generated by the cipher key generation unit, to the server including the cipher key first processing unit, and
the server including the cipher key first processing unit is configured to transmit the cipher key for data decryption after first processing or the cipher key for data encryption after first processing generated by the cipher key first processing unit, respectively to a server including the key registration unit or the first client terminal.

16. The key sharing system according to claim 5, wherein
the cipher key first processing unit is configured to execute wrapping for encrypting the cipher key for data decryption generated by the cipher key generation unit by using a password key generated based on the password received from the first client terminal, to generate the cipher key for data decryption after first processing and output the cipher key for data decryption after first processing to the key registration unit and to output the cipher key for data encryption after first processing by using the cipher key for data encryption generated by the cipher key generation unit, without change, to the first client terminal,
the first client terminal is configured to encrypt encryption target data with the cipher key for data encryption after first processing output by the cipher key first processing unit to generate encrypted data and transmit the encrypted data together with the key identification information to the second client terminal,
the second client terminal further includes a password input unit configured to ask a user to input a password, and
the second client terminal is configured to execute unwrapping for restoring the cipher key for data decryption that is original by using a password key generated based on the password input to the password input unit, from the cipher key for data decryption after first processing received from the key disclosure unit in response to transmission of the key inquiry information including the key identification information received from the first client terminal, to decrypt the encrypted data received from the first client terminal, by using the cipher key for data decryption that is original and output as a result of the unwrapping.

17. The key sharing system according to claim 5, wherein
the cipher key first processing unit is configured to execute processing for transforming the cipher key for data encryption generated by the cipher key generation unit by using a password key generated based on the password received from the first client terminal, to generate the cipher key for data encryption after first processing and output the cipher key for data encryption after first processing to the first client terminal and to output the cipher key for data decryption after first processing by using the cipher key for data decryption generated by the cipher key generation unit, without change, to the key registration unit,
the first client terminal is configured to encrypt encryption target data with the cipher key for data encryption after first processing output by the cipher key first processing unit to generate encrypted data and transmit the encrypted data together with the key identification information to the second client terminal,
the second client terminal further includes a password input unit configured to ask a user to input a password, and
the second client terminal is configured to execute transformation for transforming the cipher key for data decryption after first processing received from the key disclosure unit, in response to transmission of the key inquiry information including the key identification information received from the first client terminal, by using a password key generated based on the password input to the password input unit, to decrypt the encrypted data received from the first client terminal, by using the cipher key for data decryption that is transformed and output as a result of the transformation.

18. The key sharing system according to claim 1, wherein the verification unit, the key registration unit, and the key disclosure unit are included in the key sharing server.

19-23. (canceled)

24. The key sharing system according to claim 1, wherein the key disclosure unit is configured to
receive a first key owner identifier together with the identification token and the key identification information from the second client terminal,
acquire a second key owner identifier together with the cipher key for data decryption after first processing, from a record in the database, the record corresponding to the key identification information acquired, and
transmit, only when the first key owner identifier and the second key owner identifier match, the cipher key for data decryption after first processing acquired, to the second client terminal.

25. The key sharing system according to claim 1, wherein at least one of the cipher key for data encryption after first processing and the cipher key for data decryption after first processing is substitutable with cipher key generation source information corresponding to data serving as a source for generating a cipher key.

26-36. (canceled)

37. The key sharing system according to claim 8, wherein the password provision unit is configured to generate the password as a character string input through an input unit by a user operating the first client terminal, and provide the password.

38. A key sharing method applied to a key sharing system including one or more key sharing servers, one or more first client terminals each having functions of key registration and data output, and one or more second client terminals each having a function of reading data output by the first client terminal, the key sharing method executing:
identification token issue processing for issuing an identification token indicating “authenticated” to the first client terminal and the second client terminal;
cipher key generation processing for generating a pair of a cipher key for data encryption and a cipher key for data decryption;
cipher key first processing for performing or not performing certain processing on each of the cipher key for data encryption and the cipher key for data decryption generated in the cipher key generation processing, to thereby generate a cipher key for data encryption after first processing and a cipher key for data decryption after first processing, and causing the cipher key for data encryption after first processing to be input to the first client terminal;
verification processing for verifying an identification token transmitted from the first client terminal;
key registration processing for causing the cipher key generation unit and the cipher key first processing unit to operate only when the verification processing confirms that the identification token is correct, to store key disclosure permission information designating a disclosure permissible range of the cipher key for data decryption after first processing transmitted from the first client terminal and the cipher key for data decryption after first processing generated by the cipher key first processing, in a record in a database included in a corresponding one of the key sharing servers, and also transmit key identification information for identifying the record and the cipher key for data encryption after first processing generated by the cipher key first processing unit, to the first client terminal; and
key disclosure processing for acquiring the key identification information and the identification token included in key inquiry information from the second client terminal, acquiring the cipher key for data decryption after first processing and the key disclosure permission information from a record in the database included in one of the key sharing servers, the record corresponding to the key identification information acquired, acquiring information of a user corresponding to the identification token acquired, and transmitting, only when the user is confirmed to be included in the disclosure permissible range indicated by the key disclosure permission information acquired, the cipher key for data decryption after first processing acquired, to the second client terminal.

39-44. (canceled)

45. A program for causing one or more computers in a key sharing system including one or more key sharing servers, one or more first client terminals each having functions of key registration and data output, and one or more second client terminals each having a function of reading data output by the first client terminal, to execute all of or in a divided manner:
identification token issue processing for issuing an identification token indicating “authenticated” to the first client terminal and the second client terminal;
cipher key generation processing for generating a pair of a cipher key for data encryption and a cipher key for data decryption;
cipher key first processing for performing or not performing certain processing on each of the cipher key for data encryption and the cipher key for data decryption generated in the cipher key generation processing, to thereby generate a cipher key for data encryption after first processing and a cipher key for data decryption after first processing, respectively, and causing the cipher key for data encryption after first processing to be input to the first client terminal;
verification processing for verifying an identification token transmitted from the first client terminal;
key registration processing for causing the cipher key generation unit and the cipher key first processing unit to operate only when the verification processing confirms that the identification token is correct, to store key disclosure permission information designating a disclosure permissible range of the cipher key for data decryption after first processing transmitted from the first client terminal and the cipher key for data decryption after first processing generated by the cipher key first processing, in a record in a database included in a corresponding one of the key sharing servers and also transmit key identification information for identifying the record and the cipher key for data encryption after first processing generated by the cipher key first processing unit, to the first client terminal; and
key disclosure processing for acquiring the key identification information and the identification token included in key inquiry information from the second client terminal, acquiring the cipher key for data decryption after first processing and the key disclosure permission information from a record in the database included in one of the key sharing servers, the record corresponding to the key identification information acquired, acquiring information of a user corresponding to the identification token acquired, and transmitting, only when the user is confirmed to be included in the disclosure permissible range indicated by the key disclosure permission information acquired, the cipher key for data decryption after first processing acquired, to the second client terminal.

46-54. (canceled)
